(19) United States
(12) Patent Application Publication
(10) Pub. No.: US 2008/0146759 A1
(43) Pub. Date: Jun. 19, 2008

(54) Sulfur-Containing Compound, Method for Producing Same, Sulfur-Containing Polymer, and Optical Material

(76) Inventors: Yoriyuki Takashima, Chiba (JP); Hiroyuki Tamura, Chiba (JP); Takaaki Hikosaka, Chiba (JP); Masaaki Takehana, Chiba (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/578,374

(22) PCT Filed: Apr. 15, 2005
(86) PCT No.: PCT/JP05/07212

§ 371 Date: Aug. 22, 2007

(30) Foreign Application Priority Data
Apr. 14, 2004 (JP) 2004-119379
Aug. 17, 2004 (JP) 2004-237513

(51) Int. Cl. C08F 12/30

(52) U.S. Cl. 526/289; 528/360

(57) ABSTRACT

The present invention provides a polythiocarbonate resin containing a repeating unit represented by the following general formula (1), having high transparency, refractive index, and Abbe number and excellent heat resistance and impact resistance, and an optical material using the polythiocarbonate resin.

Further, the present invention provides a sulfur-containing compound having an Abbe number of 40 or more, a high refractive index, a high Abbe number, excellent transparency, excellent heat resistance, and the like, obtained by reacting a dithiol compound represented by the following general formula (II) and a diene compound represented by the following general formula (III), and thus containing a repeating unit formed of a structural unit derived from a residue of the dithiol compound and a structural unit derived from a residue of the diene compound. Still further, the present invention provides a method of producing the sulfur-containing compound, a sulfur-containing polymer including the sulfur-containing compound as a constitutional component, and an optical material containing the sulfur-containing polymer.

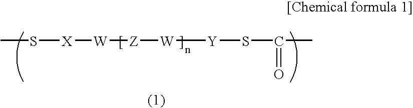

HS-G¹-SH (II)

G^{2″} (III)

### TECHNICAL FIELD

The present invention relates to a sulfur-containing compound, to a method of producing the same, to a sulfur-containing polymer, and to an optical material.

To be specific, the present invention 1 relates to a polythiocarbonate resin and to an optical material using the same, and more specifically, to a polythiocarbonate resin having high transparency, refractive index, and Abbe number and excellent heat resistance and impact resistance, and to an optical material using the same.

Further, the present invention 2 relates to a sulfur-containing compound containing a dithiol compound as a constitutional component, having a high refractive index, a high Abbe number, excellent transparency, excellent heat resistance, and the like and providing a sulfur-containing polymer, to a method of producing the same, to a sulfur-containing polymer containing at least one sulfur-containing compound as a constitutional component and having the above-mentioned preferred properties, and to an optical material containing the sulfur-containing polymer.

### BACKGROUND ART

A plastic spectacle lens is lightweight than a glass lens, and thus a demand therefor has increased.

Conventionally, various heat-curable resins have been used as plastics for a spectacle lens for simultaneously attaining a high refractive index and low dispersibility.

However, those heat-curable resins must be produced through gradual polymerization in a mold over a period of about 24 hours and have a problem in productivity.

Further, those heat-curable resins have a problem in that impact resistance degrades in the case where an antireflection film prepared by laminating a cured film and an inorganic evaporated film is applied thereon.

For solving those problems, there is proposed a lens produced through injection molding by using a thermoplastic resin.

A resin formed of an alicyclic hydrocarbon or the like is known as a material used for production of a lens, and a low dispersion (high Abbe number) resin is reported.

However, such resins each uniformly have a low refractive index of 1.55 or less and have a problem in that a central or peripheral part of a lens becomes thick.

Further, such resins each have a problem in impact resistance compared with that of other thermoplastic resins, and sometimes require a primer layer for sufficiently satisfying standards of Food and Drug Administration (FDA).

Meanwhile, an attempt of applying a bisphenol A aromatic polycarbonate resin for a spectacle lens has been made, and in particular, the bisphenol A aromatic polycarbonate resin is used for a main plastic lens product in the United States.

A polycarbonate resin has favorable physical properties for a spectacle lens such as excellent impact resistance and a relatively high refractive index of about 1.58. At the same time, the polycarbonate resin has an Abbe number of about 30, which is lower than that of another lens having a refractive index of about 1.60. It has been noted that increased power of a lens may cause color blurring and the like.

Further, there are known an aliphatic polycarbonate resin and an aliphatic-aromatic copolymer polycarbonate resin as lens materials, and some of those resins are known to have a high refractive index and a high Abbe number (Patent Document 1, Patent Document 2, Patent Document 3, Patent Document 4, Patent Document 5, and Patent Document 6).

However, most of those resins cannot be synthesized through normal interfacial polycondensation because an aliphatic alcohol is used as a material, and are synthesized by a melt polymerization method or a method using phosgene and pyridine.

The melt polymerization method has difficulties in removal of a monomer or catalyst and requires heating to high temperatures in a reaction. Thus, a problem such as coloring or decomposition may be caused, and the method cannot be applied to optical materials.

Further, the method using phosgene and pyridine requires use of a large amount of highly toxic pyridine and is not preferred for industrial production.

The method has difficulties in removal of pyridine, and thus a problem of odor of residual pyridine may be caused and heat decomposition may be accelerated in an application involving fabrication.

A dithiol compound is known as a lens material and a monomer which may be subjected to interfacial polycondensation.

However, examples of a polythiocarbonate resin and analogues thereof synthesized from a known dithiol compound only include a resin derived from an aromatic dithiol, a resin derived from a chain aliphatic dithiol, and a resin derived from a monocyclic dithiol (Patent Document 7 and Nonpatent Document 1).

A poly(di)thiocarbonate resin synthesized from an aromatic dithiol has a lower Abbe number than that of a polythiourethane resin lens having a refractive index of about 1.60, similar to an aromatic polythiocarbonate resin.

A chain aliphatic poly(di)thiocarbonate resin or a monocyclic dithiocarbonate resin may have a similar Abbe number to that of a polythiourethane resin having a refractive index of about 1.60, but has a low refractive index, a problem in heat resistance, and a problem in that the resin can be used limitedly, for example, for an application at low temperatures.

Conventionally, there are known: a polythiol compound having a 1,4-dithiane ring, which is an alicyclic sulfide; a polymer obtained through a reaction of the polythiol compound, and at least one compound selected from a compound having two or more vinyl groups in a molecule, a compound having two or more iso(thio)cyanate groups in a molecule, and a compound having one or more vinyl groups and one or more iso(thio)cyanate groups in a molecule; and an optical material using the polymer (Patent Document 8 and Nonpatent Document 2).

However, the optical material using the polythiol compound as a raw material has a high refractive index but not necessarily sufficient Abbe number, heat resistance, and the like.
Patent Document 1: Japanese Patent Application Laid-Open No. 2000-136242
Patent Document 2: Japanese Patent Application Laid-Open No. 2002-371179
Patent Document 3: Japanese Patent Application Laid-Open No. H01 (1999)-223119
Patent Document 4: Japanese Patent Application Laid-Open No. S64 (1989)-066234
Patent Document 5: Japanese Patent Application Laid-Open No. 2003-020331
Patent Document 6: Japanese Patent Application Laid-Open No. 2003-012785
Patent Document 7: Japanese Patent Application Laid-Open No. 2002-201277
Patent Document 8: Japanese Patent Application Laid-Open No. H03 (1991)-236386
Nonpatent Document 1: Polymer (1994), 35(7), 1564
Nonpatent Document 2: p. 1791-1799 vol. 68, Journal of Applied Polymer Science (1998)

### DISCLOSURE OF THE INVENTION

The present invention has been made in view of solving the above-mentioned problems.

An object of the present invention 1 is to provide: a polythiocarbonate resin having a high refractive index and a high Abbe number than those of a lens formed of a bisphenol A polycarbonate resin and having excellent heat resistance and impact resistance than those of an aliphatic polycarbonate resin, an aliphatic polythiocarbonate resin, a monocyclic polythiocarbonate resin, or a cycloolefin-based resin; and an optical material using the same.

Note that in the present invention, a structure described as the thiocarbonate resin refers to a structure in which two sulfur atoms are bonded to a carbonyl group or in which a sulfur atom and an oxygen atom are bonded to a carbonyl group.

Further, an object of the present invention 2 is to provide: a sulfur-containing compound as a reaction product of a dithiol compound and a diene compound having a high refractive index, a high Abbe number, excellent transparency, excellent heat resistance, and the like and providing a sulfur-containing polymer; a method of producing the same; a sulfur-containing polymer containing at least one sulfur-containing compound as a constitutional component and having the above-mentioned preferred properties; and an optical material containing the polymer.

The inventors of the present invention have conducted intensive studies for developing a polythiocarbonate resin having the above-mentioned preferred properties, and have found that the object may be attained by using a polythiocarbonate resin containing at least a specific repeating unit and prepared by using at least an aliphatic dithiol having a condensed alicyclic structure as a raw material for synthesis of the polythiocarbonate resin for reducing an aromatic component as a cause of degrading an Abbe number and for preventing degradation of heat resistance.

Further, the inventors of the present invention have conducted intensive studies for solving the above-mentioned problems, and have found that: a sulfur-containing compound as a reaction product of a specific dithiol compound and a specific diene compound containing a repeating unit formed of a structural unit derived from a residue of the dithiol compound and a structural unit derived from a residue of the diene compound attains the object as a raw material for a sulfur-containing polymer; and a sulfur-containing polymer containing at least one sulfur-containing compound as a constitutional component and an optical material containing the sulfur-containing polymer each serve as a material having a high refractive index, a high Abbe number, excellent transparency, excellent heat resistance, and the like.

The present invention has been completed based on the above-mentioned findings.

To be specific, the present invention provides the followings.

(1) A polythiocarbonate resin, including at least a repeating unit represented by the following general formula (1):

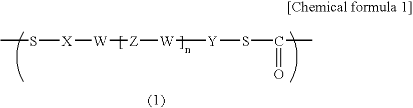

where: X and Y each independently represent —(CH₂)ₘ₁— or —(CH₂)ₘ₂-Q-(CH₂)ₘ₃— (where Q independently represents an oxygen atom or a sulfur atom; and m1 to m3 each independently represent an integer of 0 to 4); n represents a number of 0 to 6; W represents a divalent group represented by the general formula (2a) or (2b):

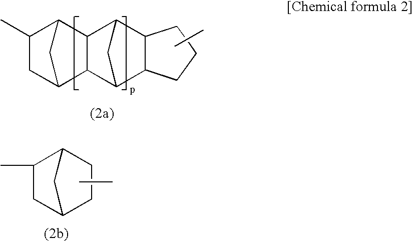

where: p represents an integer of 0 to 4; a bonding position of a five-membered ring in the formula is arbitrary and may arbitrarily have an endo- or exo-configuration; Z represents a single bond, —[(CH₂)ᵣ₁-Q]ᵣ₃-(CH₂)ᵣ₂— (where: Q independently represents an oxygen atom or a sulfur atom; r1 and r2 each independently represent an integer of 0 to 6; and r3 represents a number of 0 to 6), —O—, >C═O, or a divalent group represented by any one of the following general formulae (3) to (6); Z may be bonded to one W at two or more positions and may have a different structure by the repeating unit:

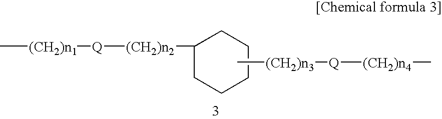

where: Q each independently represents an oxygen atom or a sulfur atom; and n1 to n4 each independently represent an integer of 0 to 4,

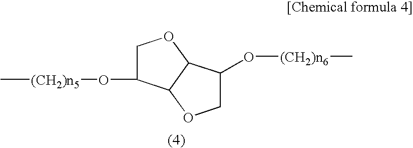

where n5 and n6 each independently represent an integer of 0 to 4,

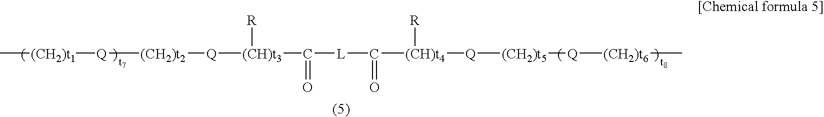

where: Q each independently represents an oxygen atom or a sulfur atom; L represents —O—(CH₂)ᵤ₁—O—, (where u1 represents an integer of 1 to 9), —O—[(CHR)ᵤ₃—O]ᵤ₂—, (where R independently represents a hydrogen atom or a methyl group; u2 represents a number of 0 to 6; u3 represents an integer of 1 to 5), or -Q-(CH₂)ₙ₇—W—(CH₂)ₙ₈-Q-, (where n7 and n8 represent an integer of 0 to 4); t1 to t6 each independently represent an integer of 0 to 4; and t7 and t8 each independently represent an integer of 0 or 1, [Chemical Formula 6]

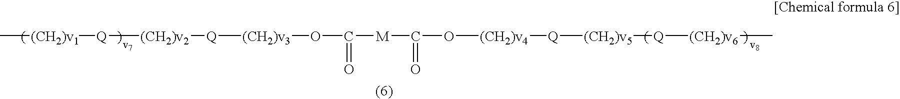

where: Q each independently represents an oxygen atom or a sulfur atom; M represents a single bond, an alkylene group having 1 to 6 carbon atoms, or a cycloalkylene group having 4 to 12 carbon atoms; v1 to v6 each independently represent an integer of 0 to 4; and v7 and v8 each independently represent an integer of 0 or 1.

(2) A polythiocarbonate resin according to above item (1), including a repeating unit represented by the following general formula (7):

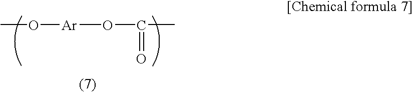

where Ar represents an aromatic bifunctional group.

(3) A polythiocarbonate resin according to the above item (2), in which Ar includes a group represented by the following general formula (8) or (9):

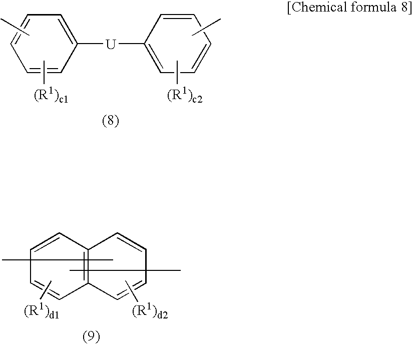

where: R¹ each independently represents a hydrogen atom, a halogen atom, an alkyl group having 1 to 10 carbon atoms which may have a substituent, an aryl group having 6 to 12 carbon atoms which may have a substituent, a cycloalkyl group having 3 to 12 atoms which may have a substituent, an alkyloxy group having 1 to 6 carbon atoms which may have a substituent, or an aryloxy group having 6 to 12 carbon atoms which may have a substituent; c1 and c2 each independently represent an integer of 0 to 4; d1 and d2 each independently represent an integer of 0 to 3; U represents a single bond, —O—, —S—, —SO—, —SO₂—, —CO—, —CR³R⁴— (where, R³ and R⁴ each independently represent a hydrogen atom, an alkyl group having 1 to 10 carbon atoms which may have a substituent, a cycloalkyl group having 3 to 12 carbon atoms which may have a substituent, or an aryl group having 6 to 12 carbon atoms which may have a substituent), an arylene group having 6 to 12 carbon atoms which may have a substituent, an cycloalkylidene group having 5 to 11 carbon atoms which may have a substituent, an α,ω-alkylene group having 2 to 12 carbon atoms which may have a substituent, a 9,9-fluorenylidene group which may have a substituent, a divalent residue of tricyclodecane which may have a substituent, a divalent residue of bicycloheptane which may have a substituent, a divalent group derived from natural terpenes represented by any one of the following general formulae (10) to (12):

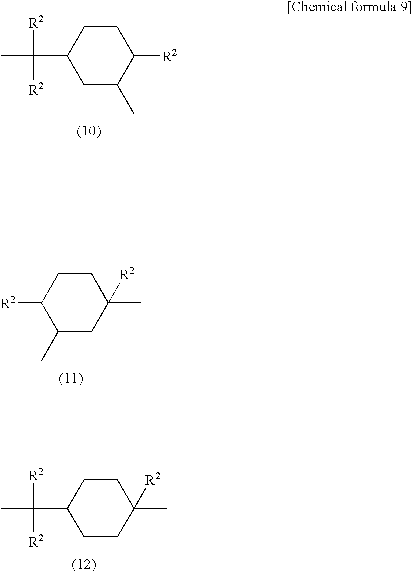

, or an alkylidene arylene alkylidene group having 8 to 16 carbon atoms and represented by the following general formula (13):

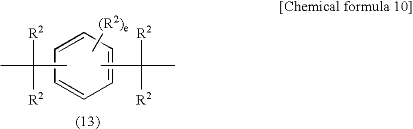

where: R² each independently represents a hydrogen atom, a halogen atom, an alkyl group having 1 to 10 carbon atoms which may have a substituent, an aryl group having 6 to 12 carbon atoms which may have a substituent, a cycloalkyl group having 3 to 12 carbon atoms which may have a substituent, an alkyloxy group having 1 to 6 carbon atoms which may have a substituent, or an aryloxy group having 6 to 12 carbon atoms which may have a substituent; and e represents an integer of 0 to 4.

(4) An optical material, including the polythiocarbonate resin according to any one of the above items (1) to (3).

(5) A sulfur-containing compound as a reaction product of a dithiol compound represented by the following general formula (II) and a diene compound represented by the following general formula (III), including a repeating unit formed of a structural unit derived from a residue of the dithiol compound and a structural unit derived from a residue of the diene compound, which has an Abbe number (ν_{D}) of 40 or more:

HS—G¹-SH (II)

G^{2″} (III)

where: G¹ represents an aliphatic or alicyclic hydrocarbon group which may contain a sulfur and/or oxygen atom, or an aromatic group or condensed polycyclic aromatic group which may be substituted; and G^{2″} represents an aliphatic or alicyclic hydrocarbon compound having two or more carbon-carbon double bonds which may contain at least one atom selected from the group consisting of oxygen, nitrogen, sulfur, and silicon, or an aromatic group or condensed polycyclic aromatic hydrocarbon compound which may be substituted.

(6) A sulfur-containing compound according to the above item (5), in which the dithiol compound represented by the general formula (II) includes an alicyclic hydrocarbon group G¹ which may contain a sulfur and/or oxygen atom.

(7) A sulfur-containing compound according to the above item (5), in which the dithiol compound represented by the general formula (II) includes an alicyclic hydrocarbon group G¹ having 6 to 35 carbon atoms and a cyclohexane group which may contain a sulfur and/or oxygen atom.

(8) A sulfur-containing compound according to the above item (5), in which the dithiol compound represented by the general formula (II) includes an alicyclic hydrocarbon group G¹ having 7 to 35 carbon atoms and a norbornane group which may contain a sulfur and/or oxygen atom.

(9) A sulfur-containing compound according to the above item (5), in which the dithiol compound represented by the general formula (II) includes an alicyclic hydrocarbon group G¹ having 10 to 35 carbon atoms and an adamantane group.

(10) A sulfur-containing compound according to the above item (5), in which the dithiol compound represented by the general formula (II) includes at least one compound selected from the group consisting of HSCH₂CH₂SH, HSCH₂CH₂CH₂SH, HSCH₂CH₂CH₂CH₂SH, HSCH₂CH₂CH₂CH₂CH₂SH, HSCH₂CH₂CH₂CH₂CH₂CH₂SH, HSCH₂CH₂OCH₂CH₂SH, and HSCH₂CH₂SCH₂CH₂SH.

(11) A sulfur-containing compound according to the above item (5), in which the dithiol compound represented by the general formula (II) includes at least one compound selected from the following dithiol compounds.

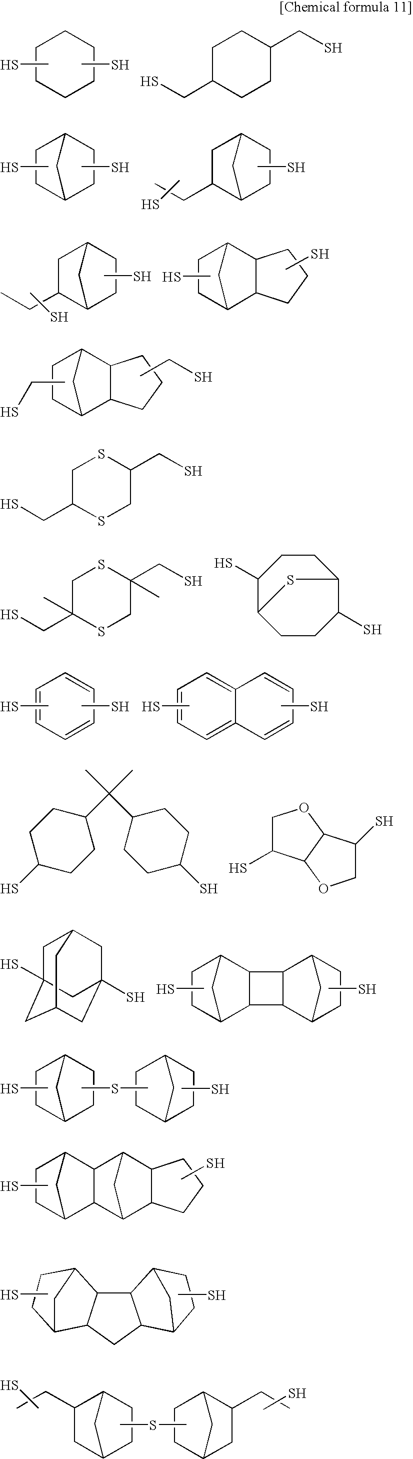

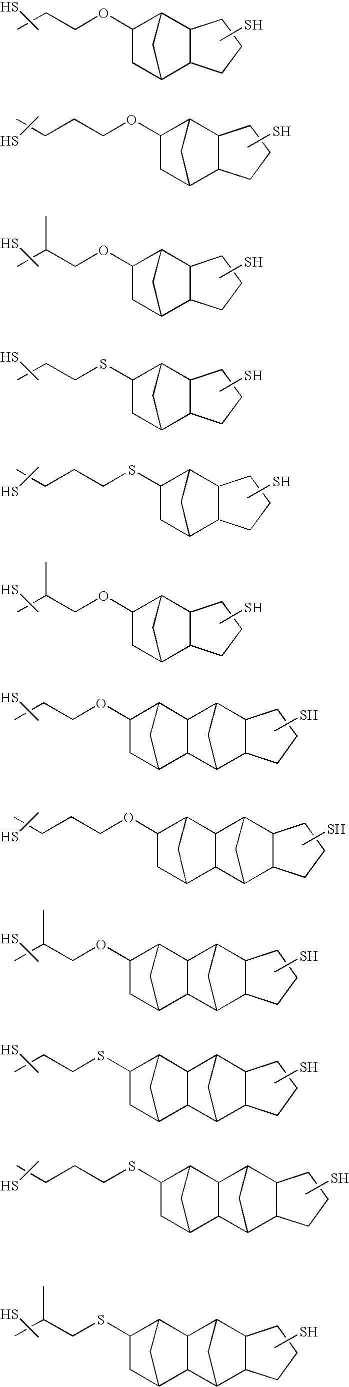

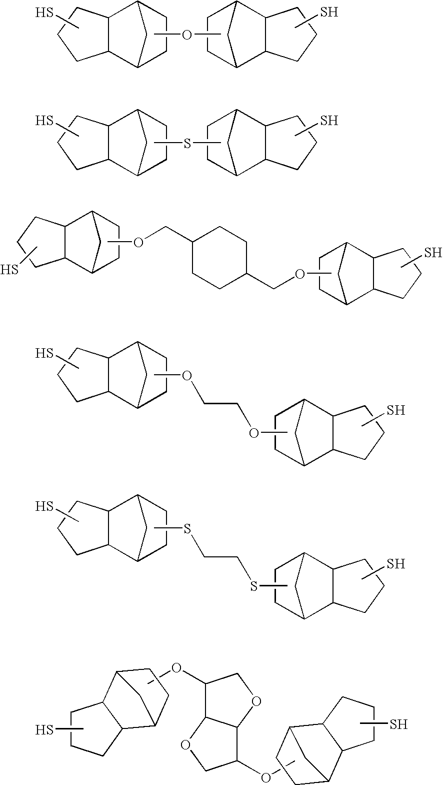

(12) A sulfur-containing compound according to the above item (5), in which a molar ratio of the structural unit derived from a residue of the dithiol compound to the structural unit derived from a residue of the diene compound in the repeating unit is 1:0.5 to 0.5:1.

(13) A sulfur-containing compound according to the above item (5), in which G² includes at least one compound selected from the group consisting of: an aliphatic or alicyclic hydrocarbon compound having two or more carbon-carbon double bonds and an acrylate group which may contain at least one atom selected from the group consisting of oxygen, nitrogen, sulfur, and silicon; an aliphatic or alicyclic hydrocarbon compound having a methacrylate group which may contain at least one atom selected from the group consisting of oxygen, nitrogen, sulfur, and silicon; an aliphatic or alicyclic hydrocarbon compound having an allyl group which may contain at least one atom selected from the group consisting of oxygen, nitrogen, sulfur, and silicon; and an aliphatic or alicyclic hydrocarbon compound having a vinyl group which may contain at least one atom selected from the group consisting of oxygen, nitrogen, sulfur, and silicon.

(14) A sulfur-containing compound according to the above item (5), in which G^{2″} includes at least one compound selected from the group consisting of a norbornadiene compound, ethylidene norbornene, vinyl norbornene, a dicyclopentadiene compound, and a tricyclopentadiene compound.

(15) A sulfur-containing compound according to the above item (5), in which G² includes at least one compound selected from the following diene compounds.

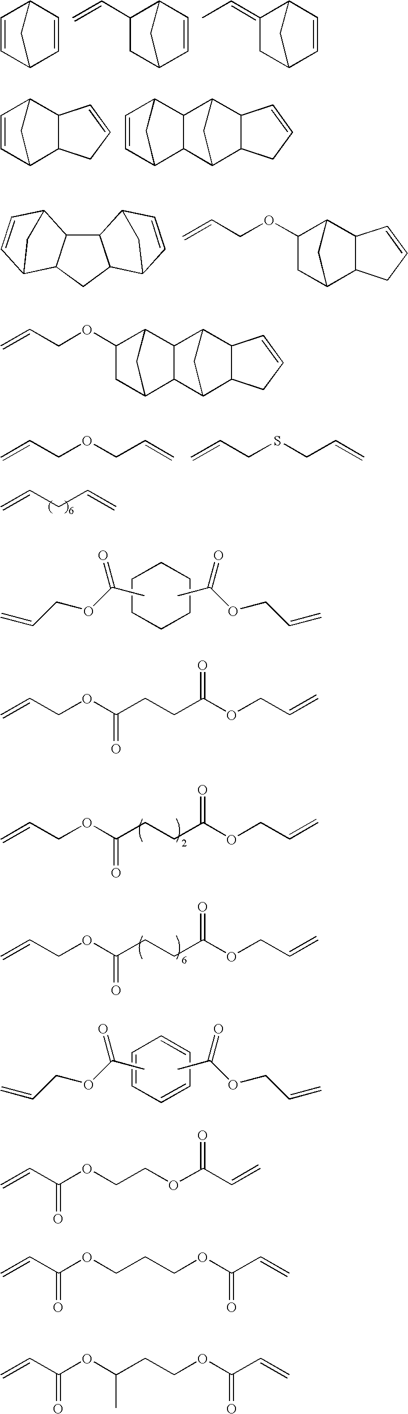

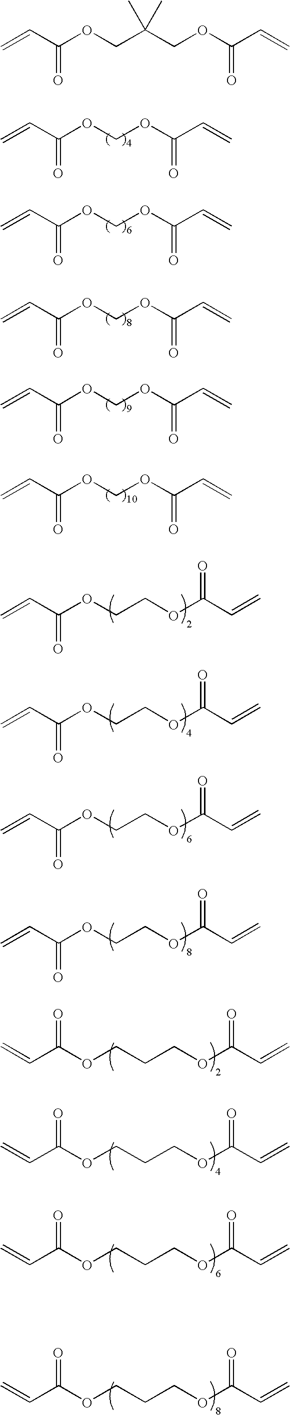

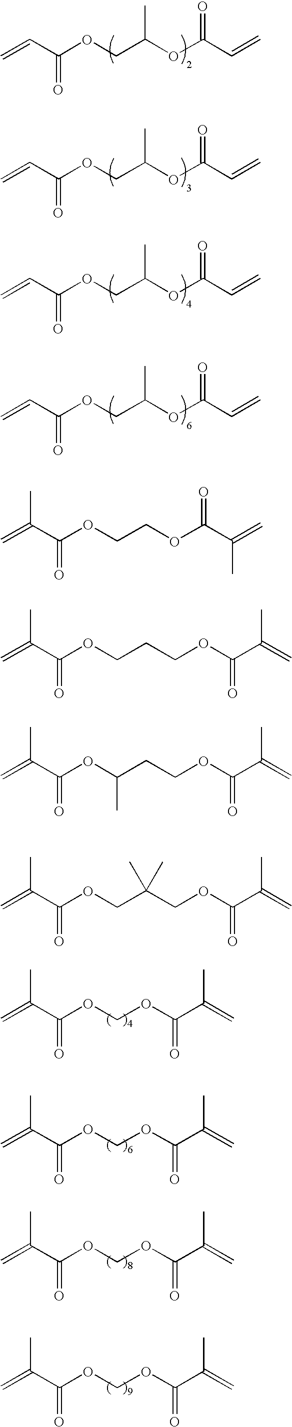

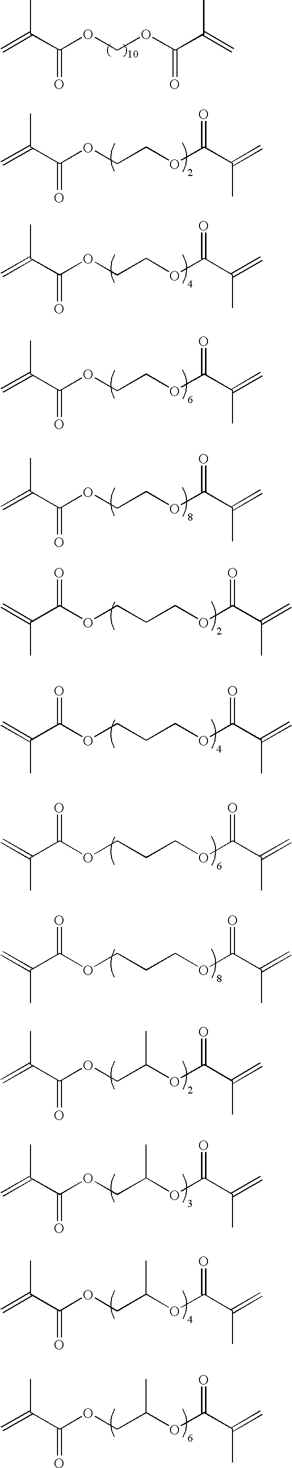

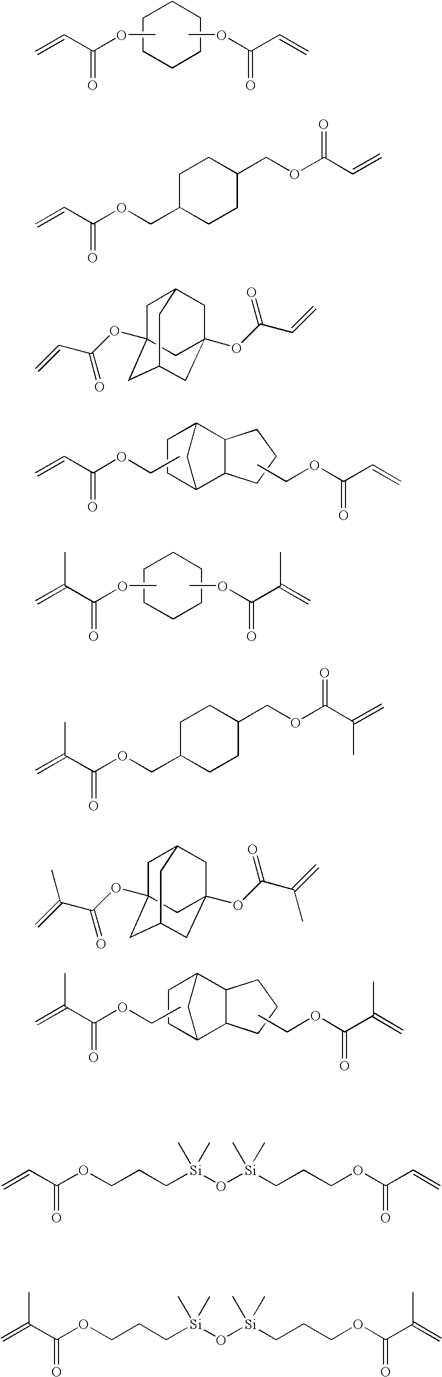

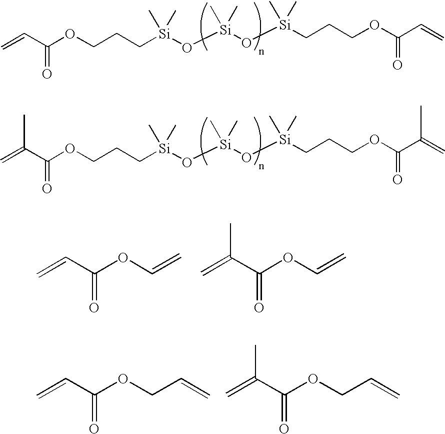

(16) A sulfur-containing compound according to the above item (5), in which the reaction product of the dithiol compound represented by the general formula (II) and the diene compound represented by the general formula (III) includes a thiocooligomer having a structure represented by the following general formula (I):

X—(S-G¹-S-G²)ₙ-S-G¹-S—X′ (I)

where: X and X′ each independently represent —H or -G^{2′}; G¹ represents an aliphatic or alicyclic hydrocarbon group which may contain a sulfur and/or oxygen atom, or an aromatic group or condensed polycyclic aromatic group which may be substituted; G² and G² each represent a reactive group derived from G²; G^{2′} represents a group in which two carbon-carbon double bonds of G^{2″} reacted; G^{2′} represents a group in which one carbon-carbon double bond of G^{2″} reacted; G^{2″} represents an aliphatic or alicyclic hydrocarbon compound which has two or more carbon-carbon double bonds and which may contain at least one atom selected from the group consisting of oxygen, nitrogen, sulfur, and silicon, or an aromatic or condensed polycyclic aromatic compound which may be substituted; and n represents an integer of 1 to 200.

(17) A sulfur-containing compound according to the above item (16), in which n represents an integer of 1 to 20.

(18) A sulfur-containing compound according to the above item (5), including the dithiol compound represented by the general formula (II).

(19) A method of producing the sulfur-containing compound according to the above item (5), characterized by including reacting the dithiol compound represented by the general formula (II) and the diene compound represented by the general formula (III).

(20) A method of producing the sulfur-containing compound according to the above item (19), in which a molar ratio of the dithiol compound to the diene compound is 1:0.5 to 0.5:1.

(21) A sulfur-containing polymer, including as a constitutional component at least one compound selected from the sulfur-containing compounds according to the above item (5).

(22) A sulfur-containing polymer according to the above item (21), which is a polymer product of at least one compound selected from the sulfur-containing compounds according to the above item (5), and at least one compound selected from the group consisting of a polyisocyanate compound, a polyisothiocyanate compound, and an isothiocyanate compound having an isocyanate group.

(23) A sulfur-containing polymer according to the above item (21), which is a polythiocarbonate obtained by reacting at least one compound selected from the sulfur-containing compounds according to the above item (5), and a polycarbonate oligomer having a dihydric phenol or a functional group capable of reacting with the sulfur-containing compound on its terminal.

(24) An optical material, including the sulfur-containing polymer according to any one of the above items (21) to (23).

The polythiocarbonate resin of the present invention 1 can be polymerized by a known method such as an interfacial polymerization method and has high transparency, a high refractive index, a high Abbe number, excellent heat resistance, and excellent impact resistance.

The polythiocarbonate resin of the present invention having such properties is preferably used as an optical material for a lens, a prism, a fiber, an optical disc substrate, a filter, an optical waveguide, a light guide plate, or the like.

The present invention 2 can provide: a sulfur-containing compound as a reaction product of a dithiol compound and a diene compound having a high refractive index, a high Abbe number, excellent transparency, excellent heat resistance, and the like and providing a sulfur-containing polymer; a method of producing the same; a sulfur-containing polymer containing at least one sulfur-containing compound as a constitutional component and having a high refractive index, a high Abbe number, excellent transparency, excellent heat resistance, and the like; and an optical material containing the polymer.

The sulfur-containing compound is useful as a raw material for a polycarbonate resin, a raw material for a polyurethane resin, an epoxy curing agent, an adhesive, a paint curing agent, a vulcanizing agent for a synthetic resin, or a raw material used in various applications such as an intermediate of a methacrylate resin, an acrylate resin, or an epoxy resin, in addition to a raw material for the sulfur-containing polymer.

In particular, the sulfur-containing polymer can suitably be used for various optical components such as: a plastic optical lens typified by a spectacle lens having a high refractive index and a high Abbe number, a vision corrective lens, a camera lens, or a pickup lens; an optical disc substrate for information recording; a plastic substrate for a liquid crystal cell; a prism; an optical fiber; an optical waveguide; a flat panel display; an electrical circuit; a resin for an optical circuit; a sealing agent; an adhesive; an optical film; an LED sealing material; and a LED lens material.

### BEST MODE FOR CARRYING OUT THE INVENTION

First, the present invention 1 will be described in detail.

A polythiocarbonate resin of the present invention 1 is a resin containing at least a repeating unit represented by the general formula (1).

The polythiocarbonate resin of the present invention has a viscosity average molecular weight in a preferred range of 7,000 or more, preferably 10,000 to 100,000, more preferably 12,000 to 50,000, and most preferably 14,000 to 30,000 from viewpoints of a balance between mechanical strength and formability, and the like.

In the polythiocarbonate resin of the present invention, a content of an aliphatic dithiol component in the repeating unit represented by the general formula (1) is 1 mass % or more, preferably 5 to 80 mass %, more preferably 10 to 70 mass %, and most preferably 15 to 60 mass %.

Hereinafter, the general formula (1) will be described.

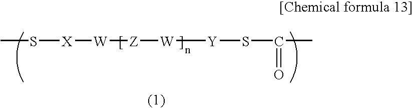

In the general formula (1): X and Y each independently represent —(CH₂)ₘ₁— or —(CH₂)ₘ₂-Q-(CH₂)ₘ₃—; Q independently represents an oxygen atom or a sulfur atom; m1 to m3 each independently represent an integer of 0 to 4; and n represents a number of 0 to 6.

In the general formula (1), W represents a divalent group represented by the general formula (2a) or (2b).

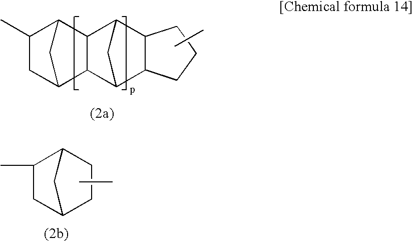

In the formula: a bonding position of a five-membered ring in the formula is arbitrary and may arbitrarily have an endo- or exo-configuration; and p represents an integer of 0 to 4.

W may represent a divalent group represented by the general formula (2c) when p is 1.

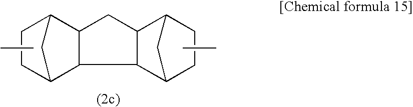

In the general formula (1): Z represents a single bond, [(CH₂)ᵣ₁-Q]ᵣ₃—(CH₂)ᵣ₂—, —O—, or >C═O; r1 and r2 each independently represent an integer of 0 to 6; and r3 represents a number of 0 to 6.

Alternatively, Z represents a divalent group represented by any one of the following general formulae (3) to (6).

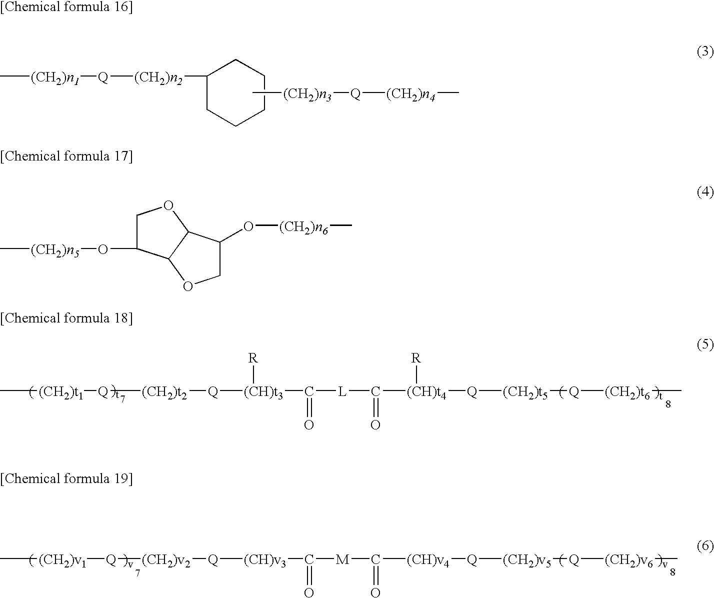

In the general formulae (3) to (6): Q independently represents an oxygen atom or a sulfur atom; L represents —O—(CH₂)ᵤ₁—O—, —O—[(CHR)ᵤ₃—O]ᵤ₂— (where R independently represents a hydrogen atom or a methyl group), or -Q-(CH₂)ₙ₇—W—(CH₂)ₙ₈-Q-.

M represents a single bond, an alkylene group having 1 to 6 carbon atoms, or a cycloalkylene group having 4 to 12 carbon atoms.

n1 to n6 and n7 and n8 each independently represent an integer of 0 to 4.

u1 represents an integer of 1 to 9. u2 represents a number of 0 to 6. u3 represents an integer of 1 to 5.

t1 to t6 each independently represent an integer of 0 to 4, and t7 and t8 each independently represent an integer of 0 or 1.

v1 to v6 each independently represent an integer of 0 to 4, and v7 and v8 each independently represent an integer of 0 or 1.

The polythiocarbonate resin of the present invention preferably contains a repeating unit represented by the following general formula (7).

A content of the repeating unit represented by the general formula (7) is 0 to 99 mass %, preferably 20 to 95 mass %, more preferably 30 to 90 mass %, and most preferably 40 to 85 mass % with respect to a total amount of the polythiocarbonate resin.

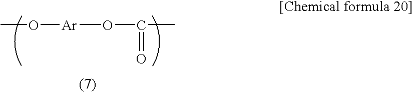

In the general formula (7), Ar represents an aromatic bifunctional group.

In the general formula (7), Ar represents a group represented by the following general formula (8) or (9).

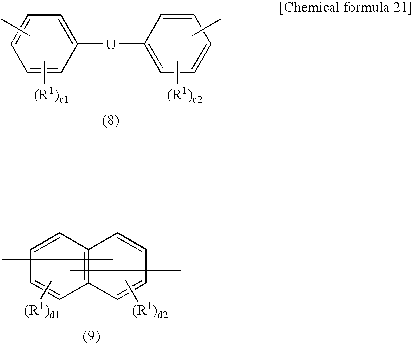

where: R¹ each independently represents a hydrogen atom, a halogen atom, an alkyl group having 1 to 10 carbon atoms which may have a substituent, an aryl group having 6 to 12 carbon atoms which may have a substituent, a cycloalkyl group having 3 to 12 atoms which may have a substituent, an alkyloxy group having 1 to 6 carbon atoms which may have a substituent, or an aryloxy group having 6 to 12 carbon atoms which may have a substituent; c1 and c2 each independently represent an integer of 0 to 4 (preferably 0 or 1); d1 and d2 each independently represent an integer of 0 to 3 (preferably 0 or 1);

U represents a single bond, —O—, —S—, —SO—, —SO₂—, —CO—, —CR³R⁴— (where R³ and R⁴ each independently represent a hydrogen atom, an alkyl group having 1 to 10 carbon atoms which may have a substituent, a cycloalkyl group having 3 to 12 carbon atoms which may have a substituent, or an aryl group having 6 to 12 carbon atoms which may have a substituent); an arylene group having 6 to 12 carbon atoms which may have a substituent, an cycloalkylidene group having 5 to 11 carbon atoms which may have a substituent; an α,ω-alkylene group having 2 to 12 carbon atoms which may have a substituent; a 9,9-fluorenylidene group which may have a substituent; a divalent residue of tricyclodecane which may have a substituent; a divalent residue of bicycloheptane which may have a substituent; a divalent group derived from natural terpenes represented by any one of the following general formulae (10) to (12):

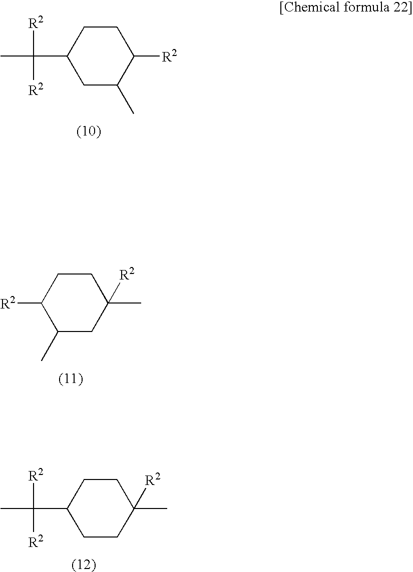

; or an alkylidene arylene alkylidene group having 8 to 16 carbon atoms and represented by the following general formula (13):

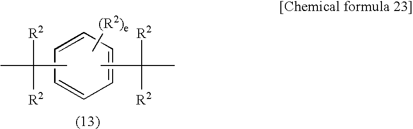

where: R² each independently represents a hydrogen atom, a halogen atom, an alkyl group having 1 to 10 carbon atoms which may have a substituent, an aryl group having 6 to 12 carbon atoms which may have a substituent, a cycloalkyl group having 3 to 12 carbon atoms which may have a substituent, an alkyloxy group having 1 to 6 carbon atoms which may have a substituent, or an aryloxy group having 6 to 12 carbon atoms which may have a substituent; and e represents an integer of 0 to 4, preferably 0 to 2.

Examples of the halogen atom represented by R¹ include a fluorine atom, a chlorine atom, a bromine atom, and an iodine atom.

Examples of the alkyl group represented by R¹ include a methyl group, an ethyl group, a propyl group, an isopropyl group, a butyl group, a sec-butyl group, a tert-butyl group, a pentyl group, a hexyl group, a heptyl group, an octyl group, a trichloromethyl group, and a trifluoromethyl group.

Examples of the aryl group represented by R¹ include a phenyl group, a 2-methylphenyl group, a 3-methylphenyl group, a 4-methylphenyl group, a 4-ethylphenyl group, a biphenyl group, a dichlorophenyl group, a naphthyl group, and a methylnaphthyl group.

Further, examples of the arylene group include bivalent groups of those examples.

Examples of the cycloalkyl group represented by R¹ include a cyclopropyl group, a cyclobutyl group, a cyclopentyl group, a cyclohexyl group, a cyclodecyl group, and a cyclododecyl group.

Examples of the alkyloxy group represented by R¹ include a methoxy group, an ethoxy group, a propoxy group, an isopropoxy group, a butoxy group, an isobutoxy group, a sec-butoxy group, a tert-butoxy group, various kinds of pentyloxy groups, and various kinds of hexyloxy groups.

Examples of the aryloxy group represented by R¹ include a phenoxy group, a tolyloxy group, and a naphthyloxy group.

Specific examples of the alkyl group, the cycloalkyl group, and the aryl group each represented by R³ and R⁴ include the same groups as those represented by R¹.

Specific examples of the arylene group represented by U include bivalent groups of the aryl groups represented by R¹.

Specific examples of the cycloalkylidene group represented by U include bivalent groups of the cycloalkyl groups represented by R¹.

Examples of the α,ω)-alkylene group represented by U include an ethylene group, an n-propylene group, an n-butylene group, an n-pentylene group, an n-hexylene group, an n-heptylene group, and an n-octylene group.

Examples of the bivalent residue of tricyclodecane represented by U include a bivalent residue of tricyclo[5.2.1.0^{2.6.}]decane, a 1,3-adamantylene group, and a 2,2-adamantylene group.

Examples of the bivalent residue of bicycloheptane represented by U include a bivalent residue of bicyclo[4.1.0]heptane.

Specific examples of the halogen atom, the alkyl group, the aryl group, the cycloalkyl group, the alkyloxy group, and the aryloxy group each represented by R² include the same groups as those represented by R¹.

Further, Ar in the general formula (7) is preferably any group selected from the following groups.

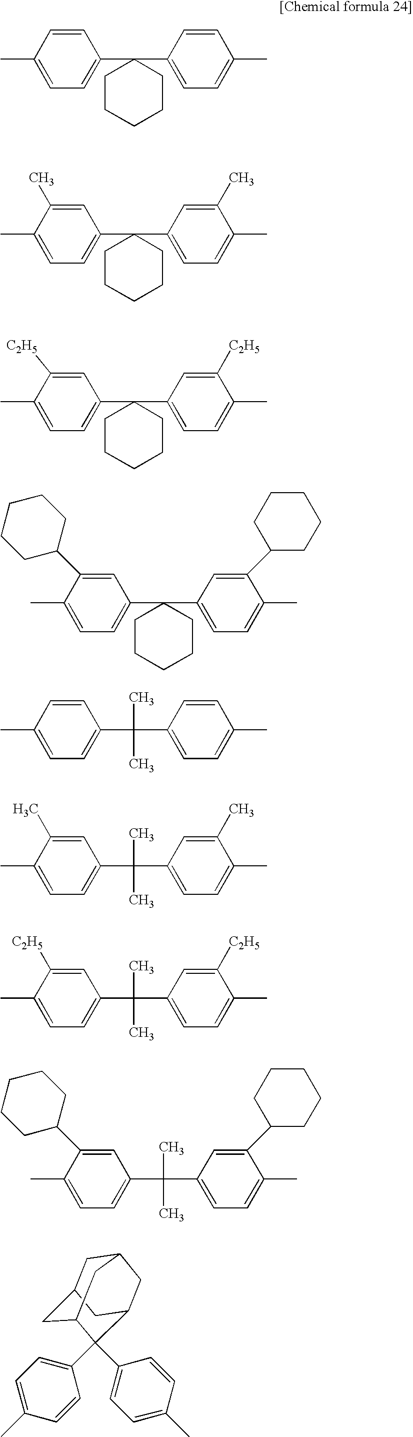

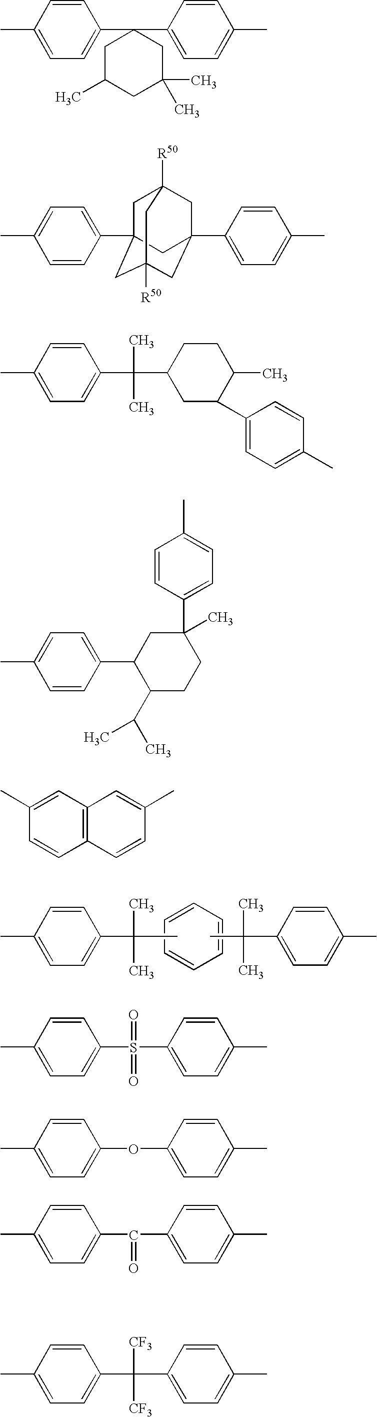

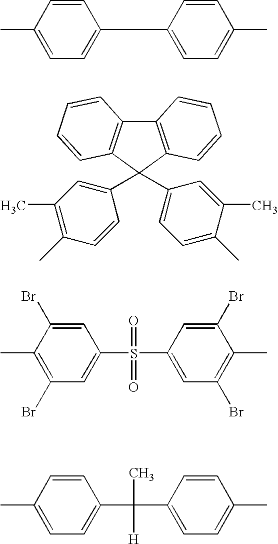

where R⁵⁰ represents a hydrogen atom or a methyl group.

Examples of substituents for the respective groups include: a halogen atom such as boron, chlorine, or iodine; a mercapto group; a hydroxide group; a cyano group; an amino group; an alkyl group such as a methyl group, an ethyl group, an n-propyl group, or an isopropyl group; an S-containing alkyl group having at least one alkyl group substituted by a sulfur atom; an O-containing alkyl group having at least one alkyl group substituted by an oxygen atom; and an N-containing alkyl group having at least one alkyl group substituted by a nitrogen group.

The polythiocarbonate resin of the present invention preferably has a reduced viscosity (ηsp/C) of 0.2 dl/g or more at 20° C. as a solution at a concentration of 0.5 g/dl containing methylene chloride as a solvent.

A reduced viscosity of 0.2 dl/g or less may provide a resin having degraded mechanical strength, which is easily cracked.

The reduced viscosity is more preferably 0.2 to 5.0 dl/g, particularly preferably 0.27 to 2.0 dl/g, and most preferably 0.37 to 0.7 dl/g.

A reduced viscosity of more than 5.0 dl/g may degrade formability.

A method of producing the polythiocarbonate resin of the present invention is not particularly limited, and the polythiocarbonate resin may be produced by using a monomer required for forming the polythiocarbonate resin of the present invention in accordance with a known method (such as an interfacial polycondensation method using phosgene and an alkaline solution, a method using phosgene and pyridine, or a method involving ester exchange).

For example, the polythiocarbonate resin of the present invention may be produced by a method to be described below.

That is, the polythiocarbonate resin of the present invention may be produced by a dithiol compound (A) having at least a condensed alicyclic ring structure alone, or reacting a component (A) and a bisphenol compound (B) with a carbonic acid ester formative compound.

A ratio of the components (A) and (B) to be used is appropriately selected, to thereby adjust a ratio of copolymerization.

In the present invention, it is important that impurities in a polythiocarbonate resin to be obtained be in a certain amount or less, and thus an interfacial polycondensation method using phosgene and an alkaline solution is preferably employed from this viewpoint.

The polythiocarbonate resin of the present invention may be synthesized by using at least a dithiol compound having a condensed alicyclic ring structure and represented by the general formula HS—X—W-(Z-W)ₙ—Y—SH (where X, Y, Z, W, and n represent the same as those described above) as a raw material and as the component (A).

Examples of the dithiol compound represented by the general formula as the component (A) include the following compounds.

### [Chemical

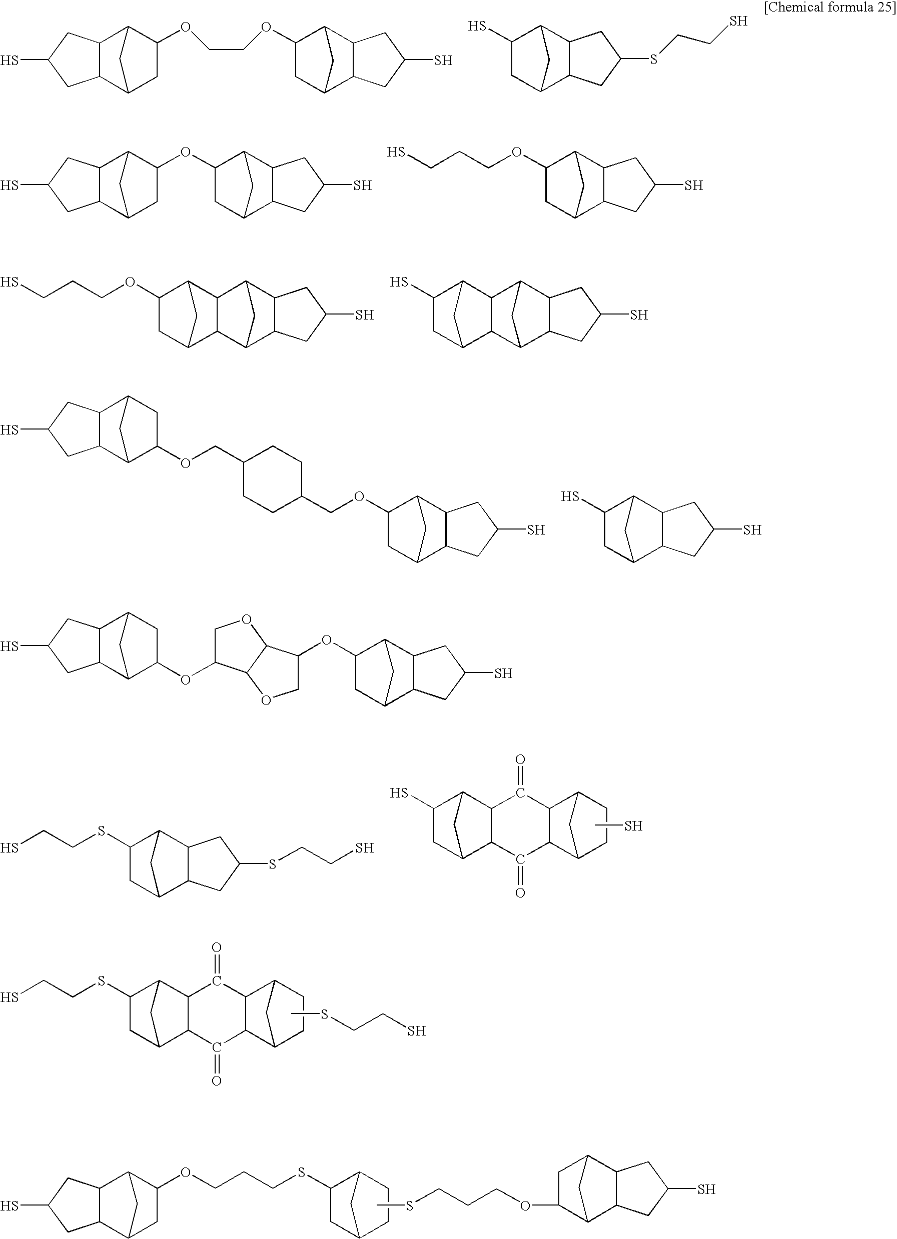

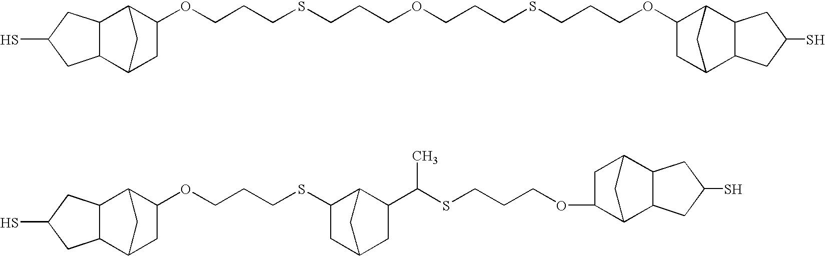

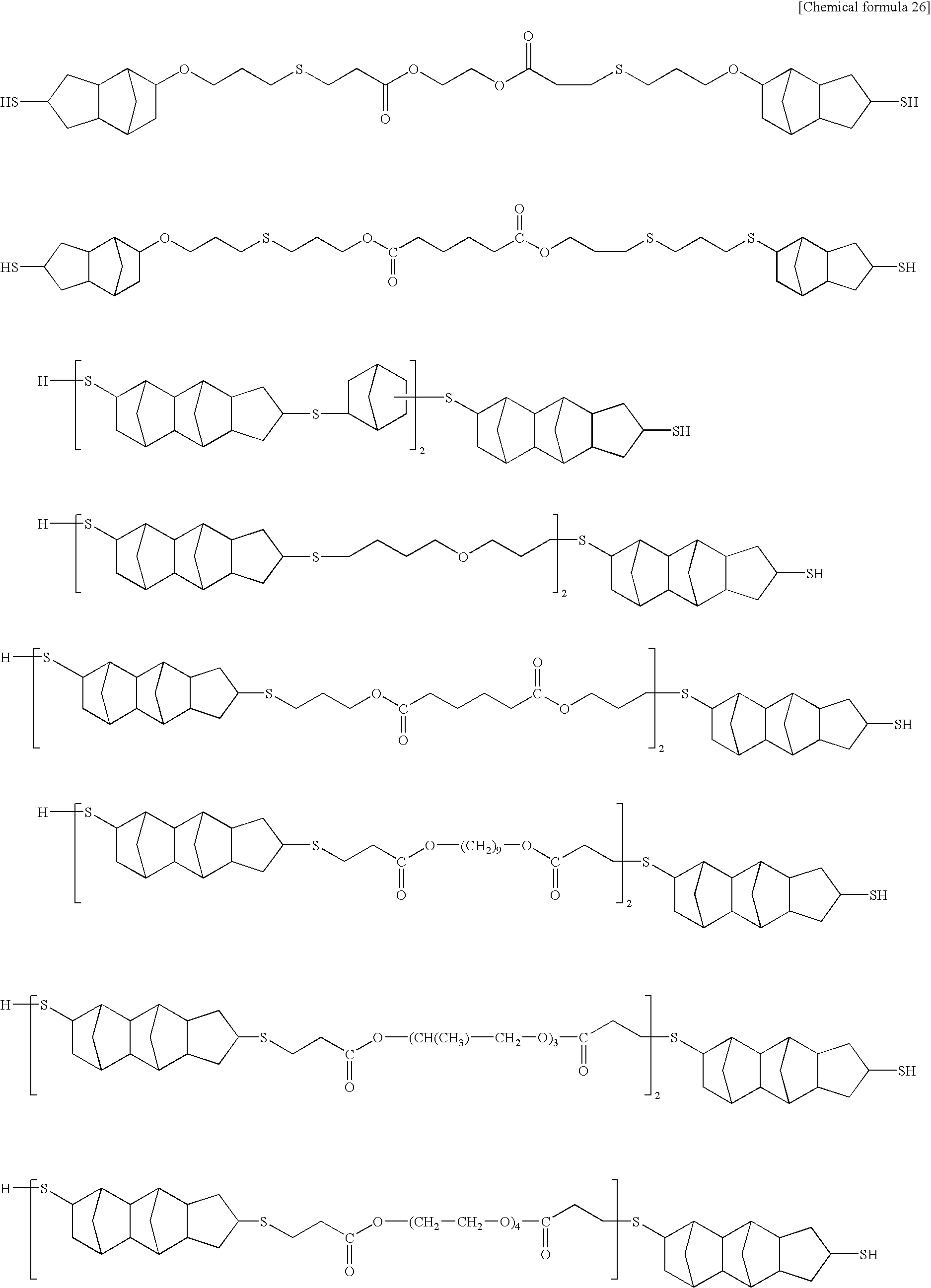

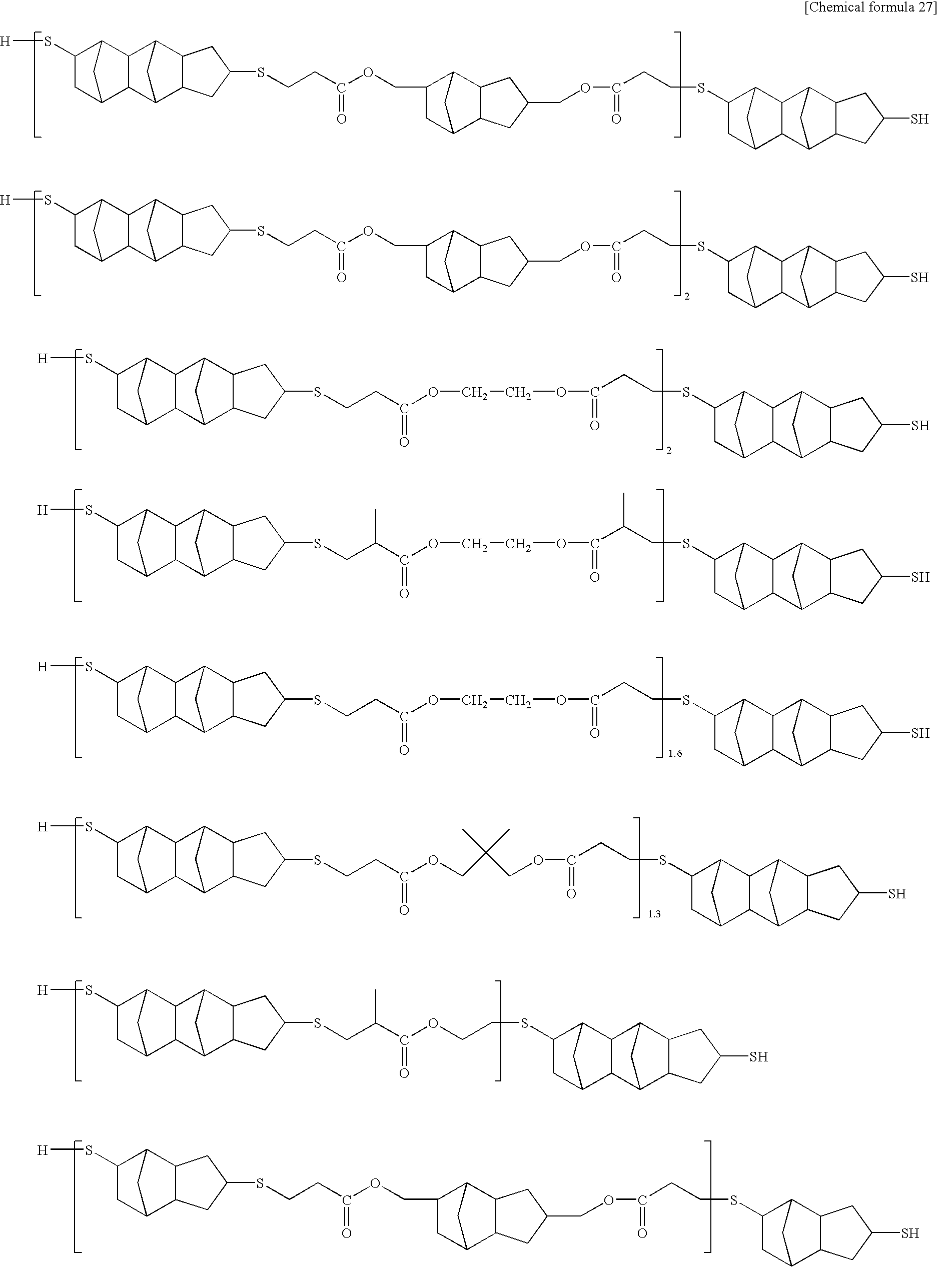

Examples of the bisphenol compound available for Component (B) include bis(4-hydroxyphenyl)methane, 1,1-bis(4-hydroxyphenyl)ethane, 1,2-bis(4-hydroxyphenyl)ethane, 2,2-bis(4-hydroxyphenyl)propane, 1,1-bis(4-hydroxyphenyl)propane, 1,1-bis(3-methyl-4-hydroxyphenyl)propane, 1,1-bis(3-fluoro-4-hydroxyphenyl)propane, 1,1-bis(3-chloro-4-hydroxyphenyl)propane, 1,1-bis(3-phenyl-4-hydroxyphenyl)propane, 2,2-bis(4-hydroxyphenyl)butane, 2,2-bis(3-methyl-hydroxyphenyl)butane, 2,2-bis(3-fluoro-hydroxyphenyl)butane, 2,2-bis(3-chloro-hydroxyphenyl)butane, 2,2-bis(3-phenyl-hydroxyphenyl)butane, 2,2-bis(3-methyl-4-hydroxyphenyl)butane, 2,2-bis(4-hydroxyphenyl)octane, 4,4-bis(4-hydroxyphenyl)heptane, 1,1-bis(4-hydroxyphenyl)-1,1-diphenylmethane, 1,1-bis(4-hydroxyphenyl)-1-phenylethane, 1,1-bis(4-hydroxyphenyl)-1-phenylmethane, bis(4-hydroxyphenyl)ether, bis(4-hydroxyphenyl)sulfide, bis(4-hydroxyphenyl)sulfone, 1,1-bis(4-hydroxyphenyl)cyclopentane, 1,1-bis(4-hydroxyphenyl)cyclohexane, 2,2-bis(3-methyl-4-hydroxyphenyl)propane, 2,2-bis(3-phenyl-4-hydroxyphenyl)propane, 2-(3-methyl-4-hydroxyphenyl)-2-(4-hydroxyphenyl)-1-phenylethane, bis(3-methyl-4-hydroxyphenyl)sulfide, bis(3-methyl-4-hydroxyphenyl)sulfone, 1,1-bis(3-methyl-4-hydroxyphenyl)cyclohexane, 4,4′-biphenol, 3,3′-dimethyl-4,4′-biphenol, 3,3′-diphenyl-4,4′-biphenol, 3,3′-dichloro-4,4′-biphenol, 3,3′-difluoro-4,4′-biphenol, 3,3′,5,5′-tetramethyl-4,4′-biphenol, 2,2-bis(2-methyl-4-hydroxyphenyl)propane, 1,1-bis(2-butyl-4-hydroxy-5-methylphenyl)butane, 1,1-bis(2-tert-butyl-4-hydroxy-5-methylphenyl)ethane, 1,1-bis(2-tert-butyl-4-hydroxy-5-methylphenyl)propane, 1,1-bis(2-tert-butyl-4-hydroxy-5-methylphenyl)butane, 1,1-bis(2-tert-butyl-4-hydroxy-5-methylphenyl)isobutane, 1,1-bis(2-tert-butyl-4-hydroxy-5-methylphenyl)heptane, 1,1-bis(2-tert-butyl-4-hydroxy-5-methylphenyl)-1-phenylmethane, 1,1-bis(2-tert-amyl-4-hydroxy-5-methylphenyl)butane, bis(3-chloro-4-hydroxyphenyl)methane, bis(3,5-dibromo-4-hydroxyphenyl)methane, 2,2-bis(3-chloro-4-hydroxyphenyl)propane, 2,2-bis(3-fluoro-4-hydroxyphenyl)propane, 2,2-bis(3-bromo-4-hydroxyphenyl)propane, 2,2-bis(3,5-difluoro-4-hydroxyphenyl)propane, 2,2-bis(3,5-dichloro-4-hydroxyphenyl)propane, 2,2-bis(3,5-dibromo-4-hydroxyphenyl)propane, 2,2-bis(3-bromo-4-hydroxy-5-chlorophenyl)propane, 2,2-bis(3,5-dichloro-4-hydroxyphenyl)butane, 2,2-bis(3,5-dibromo-4-hydroxyphenyl)butane, 1-phenyl-1,1-bis(3-fluoro-4-hydroxyphenyl)ethane, bis(3-fluoro-4-hydroxyphenyl)ether, 3,3′-difluoro-4,4′-dihydroxybiphenyl, 1,1-bis(3-cyclohexyl-4-hydroxyphenyl)cyclohexane, 2,2-bis(3-cyclohexyl-4-hydroxyphenyl)propane, 1,1-bis(3-ethyl-4-hydroxyphenyl)cyclohexane, 2,2-bis(3-ethyl-4-hydroxyphenyl)propane, 1,1-bis(3-propyl-4-hydroxyphenyl)cyclohexane, 2,2-bis(3-propyl-4-hydroxyphenyl)propane, 1,1-bis(3-isopropyl-4-hydroxyphenyl)cyclohexane, 2,2-bis(3-isopropyl-4-hydroxyphenyl)propane, 1,1-bis(3-butyl-4-hydroxyphenyl)cyclohexane, 2,2-bis(3-butyl-4-hydroxyphenyl)propane, 1,1-bis(3-sec-butyl-4-hydroxyphenyl)cyclohexane, 2,2-bis(3-sec-butyl-4-hydroxyphenyl)propane, 1,1-bis(3-tert-butyl-4-hydroxyphenyl)cyclohexane, 2,2-bis(3-tert-butyl-4-hydroxyphenyl)propane, 1,1-bis(3-isobutyl-4-hydroxyphenyl)cyclohexane, 2,2-bis(3-isobutyl-4-hydroxyphenyl)propane, 2,2-bis(4-hydroxyphenyl)hexafluoropropane, 1,1-bis(3-phenyl-4-hydroxyphenyl)cyclohexane, bis(3-phenyl-4-hydroxyphenyl)sulfone, 4,4′-(3,3,5-trimethylcyclohexylidene)diphenol, 4,4′-(1,4-phenylenebis(1-methylethylidene)bisphenol, 4,4′-(1,3-phenylenebis(1-methylethylidene)bisphenol, and terminal phenolpolydimethyl siloxane. Of those, 1,1-bis(4-hydroxyphenyl)ethane, 2,2-bis(4-hydroxyphenyl)propane, 2,2-bis(4-hydroxyphenyl)butane, 1,1-bis(4-hydroxyphenyl)cyclohexane, 2,2-bis(3-methyl-4-hydroxyphenyl)propane, 1,1-bis(3-methyl-4-hydroxyphenyl)cyclohexane, 1,1-bis(3-cyclohexyl-4-hydroxyphenyl)cyclohexane, 2,2-bis(3-cyclohexyl-4-hydroxyphenyl)propane, 1,1-bis(3-ethyl-4-hydroxyphenyl)cyclohexane, 2,2-bis(3-ethyl-4-hydroxyphenyl)propane, 1,1-bis(3-propyl-4-hydroxyphenyl)cyclohexane, 2,2-bis(3-propyl-4-hydroxyphenyl)propane, 1,1-bis(3-isopropyl-4-hydroxyphenyl)cyclohexane, 2,2-bis(3-isopropyl-4-hydroxyphenyl)propane, 1,1-bis(3-butyl-4-hydroxyphenyl)cyclohexane, 2,2-bis(3-butyl-4-hydroxyphenyl)propane, 1,1-bis(3-sec-butyl-4-hydroxyphenyl)cyclohexane, 2,2-bis(3-sec-butyl-4-hydroxyphenyl)propane, 1,1-bis(3-tert-butyl-4-hydroxyphenyl)cyclohexane, 2,2-bis(3-tert-butyl-4-hydroxyphenyl)propane, 1,1-bis(3-isobutyl-4-hydroxyphenyl)cyclohexane, and 2,2-bis(3-isobutyl-4-hydroxyphenyl)propane are preferable.

The method of producing the polythiocarbonate resin of the present invention includes: a first step of reacting a dithiol compound (A) alone, a mixture of a dithiol compound (A) and a bisphenol compound (B), or a bisphenol compound (B) alone with a dihalogenated carbonyl compound or a haloformate compound as a carbonic acid ester formative compound by an interfacial polycondensation method in the presence of an alkaline solution and an organic solvent incapable of mixing with water to obtain an oligomer having a haloformate terminal and having a viscosity average molecular weight of less than 7,000; and a second step of reacting the obtained oligomer with a bisphenol compound, a dithiol compound, or a dithiol compound and a bisphenol compound by an interfacial polycondensation method in the presence of an alkaline solution and an organic solvent incapable of mixing with water to obtain a polymer having a viscosity average molecular weight of 7,000 or more.

In the method of producing the polythiocarbonate resin of the present invention, examples of a carbonic acid ester formative compound to be used include: phosgene as a dihalogenated carbonyl compound; and chloroformate as a haloformate compound.

In the case where the carbonic acid ester formative compounds is used, the first step may be performed in the presence of an acid acceptor (including: a basic alkali metal compound such as an alkali metal hydroxide or an alkali metal carbonate; or an organic base such as pyridine) in an appropriate organic solvent.

Various compounds may be used as an alkali metal hydroxide or an alkali metal carbonate. In general, sodium hydroxide, potassium hydroxide, sodium carbonate, or potassium carbonate is preferably used from an economical viewpoint, and those compounds are generally used in a form of a solution.

A use ratio of the carbonic acid ester formative compound may appropriately adjusted in consideration of a stoichiometric ratio (equivalent) of a reaction.

In the case where a gaseous carbonic acid ester formative compound such as phosgene is used, a method of blowing the gaseous carbonic acid ester formative compound into a reaction system is preferably employed.

Similarly, a use ratio of the acid acceptor may appropriately be adjusted in consideration of a stoichiometric ratio (equivalent) of a reaction.

To be specific, 2 equivalents or a slightly excess amount thereof of an acid acceptor is preferably used with respect to a total moles (generally, 1 mole corresponds to 1 equivalent) of the dithiol compound to be used, or the dithiol compound and bisphenol compound to be used.

Examples of the organic solvent to be used in the first and second steps include one kind or a mixture of various solvents to be used in production of a polycarbonate resin.

Typical examples of the organic solvent include carbon hydride solvents such as toluene and xylene, and halogenated carbon hydride solvents including methylene chloride and chlorobenzene.

The reactions may be performed by adding: a catalyst for accelerating polymerization reactions in the first and second steps including a tertiary amine or a quaternary amine such as triethylamine; a terminating agent for adjusting a degree of polymerization including p-tert-butylphenol, cumyl phenol, or phenyl phenol; or a branching agent including phloroglucin, pyrogallol, 4,6-dimethyl-2,4,6-tris(4-hydroxyphenyl)-2-heptene, 1,3,5-tris(4-hydroxyphenyl)benzene, 1,1,1-tris(4-hydroxyphenyl)ethane, tris(4-hydroxyphenyl)phenylmethane, 2,2-bis[4,4-bis(4-hydroxyphenyl)cyclohexyl]propane, 2,4-bis[2-bis(4-hydroxyphenyl)-2-propyl]phenol, 2,6-bis(2-hydroxy-5-methylbenzyl)-4-methylphenol, 2-(4-hydroxyphenyl)-2-(2,4-dihydroxyphenyl)propane, tetrakis(4-hydroxyphenyl)methane, tetrakis[4-(4-hydroxyphenylisopropyl)phenoxy]methane, 2,4-dihydroxybenzoic acid, trimesic acid, or cyanuric acid.

The reactions in the first and second steps are performed in a temperature range of generally 0 to 150° C., and preferably 5 to 40° C.

A reaction pressure may be any of reduced pressure, normal pressure, or increased pressure, but the reactions are generally performed under normal pressure or under about a pressure of a reaction system.

A reaction time is generally 1 min to 5 hours, and preferably 10 min to 2 hours for the first step, and generally 1 min to 5 hours, and preferably 10 min to 2 hours for the second step.

A reaction type may be a semi-continuous-type, a batch-type, or the like, in addition to the interfacial polycondensation method described above.

The reduced viscosity (ηsp/C) of the polymer to be obtained may be adjusted to 0.2 dl/g or more by various methods such as adjusting the reaction conditions or adjusting a use amount of a molecular-weight-modifier.

The obtained polymer may be appropriately subjected to physical treatment (such as mixing or fractionation) and/or chemical treatment (such as polymer reaction, cross-linking treatment, or partial decomposition treatment), to thereby adjust the reduced viscosity to a predetermined value.

A reaction product (crude product) obtained in the first and second steps may be subjected to various known aftertreatments such as separation and purification, to thereby collect as a polythiocarbonate resin having a desired purity (degree of purification).

The polythiocarbonate resin of the present invention may be added with an antioxidant, a pigment, a dye, an impact modifier, a filler, a UV absorber, a lubricant, a releasing agent, a crystal nucleator, a plasticizer, a fluidity improver, an antistatic agent, and the like during a production step and/or fabrication as required, in addition to the raw materials or the catalyst.

Further, for improving properties of the resin, a polythiocarbonate resin excluding those described above or a thermoplastic resin may be blended for use.

Examples of the antioxidant include: phosphite compounds such as triphenyl phosphite, tris(4-methylphenyl)phosphite, tris(4-t-butylphenyl)phosphite, tris(monononylphenyl)phosphite, tris(2-methyl-4-ethylphenyl)phosphite, tris(2-methyl-4-t-butylphenyl)phosphite, tris(2,4-di-t-butylphenyl)phosphite, tris(2,6-di-t-butylphenyl)phosphite, tris(2,4-di-t-butyl-5-methylphenyl)phosphite, tris(mono,dinonylphenyl)phosphite, bis(monononylphenyl)pentaerythritol-di-phosphite, bis(2,4-di-t-butylphenyl)pentaerythritol-di-phosphite, bis(2,6-di-t-butyl-4-methylphenyl)pentaerythritol-di-phosphite, bis(2,4,6-tri-t-butylphenyl)pentaerythritol-di-phosphite, bis(2,4-di-t-butyl-5-methylphenyl)pentaerythritol-di-phosphite, 2,2-methylenebis(4,6-dimethylphenyl)octylphosphite, 2,2-methylenebis(4-t-butyl-6-methylphenyl)octylphosphite, 2,2-methylenebis(4,6-di-t-butylphenyl)octylphosphite, 2,2-methylenebis(4,6-dimethylphenyl)hexylphosphite, 2,2-methylenebis(4,6-di-t-butylphenyl)hexylphosphite, and 2,2-methylenebis(4,6-di-t-butylphenyl)stearylphosphite; hindered phenol-based compounds such as pentaerythritol-tetrakis[3-(3,5-di-t-butyl-4-hydroxyphenyl)propionate], 1,6-hexanediol-bis[3-(3,5-di-t-butyl-4-hydroxyphenyl)propionate], octadecyl-3-(3,5-di-t-butyl-4-hydroxyphenyl)propionate, 1,3,5-trimethyl-2,4,6-tris(3,5-di-t-butyl-4-hydroxybenzyl)benzene, triethylene glycol-bis[3-(3-t-butyl-5-methyl-4-hydroxyphenyl)propionate], 3,9-bis{2-[3-(3-t-butyl-4-hydroxy-5-methylphenyl)propionyloxy]-1,1-dimethylethyl}-2,4,8,10-tetraoxaspiro[5,5]undecane, and 1,1,3-tris[2-methyl-4-(3,5-di-t-butyl-4-hydroxyphenylpropionyloxy)-5-t-butylphenyl]butane; and lactone-based compounds such as 5,7-di-t-butyl-3-(3,4-dimethylphenyl)-3H-benzofran-2-one. The use of the compounds which hardly contain an organic impurity, a metal impurity, chlorine, and the like, and thus have a high purity is preferable to maintain a favorable color tone.

One kind of antioxidant may be used alone, or two or more kinds thereof may be used in combination.

A small amount of an antioxidant such as sodium sulfite or hydrosulfite may effectively be added as desired during polymerization of the raw materials, in particular.

An addition amount of the antioxidant is 0.005 to 1 part by mass, preferably 0.01 to 0.5 part by mass, and more preferably 0.01 to 0.2 part by mass with respect to 100 parts by mass of the polythiocarbonate resin. An addition amount thereof of 0.005 to 1 part by mass can provide a sufficient desired effect and favorable heat resistance and mechanical strength.

Examples of the ultraviolet absorber include: triazoles such as 2-(5-methyl-2-hydroxyphenyl)benzotriazole, 2-[2-hydroxy-3,5-bis(α,α-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-2-hydroxyphenyl)-5-chlorobenzotriazole, 2-(3,5-di-t-amyl-2-hydroxyphenyl)benzotriazole, 2-(2′-hydroxy-5′-t-octylphenyl)benzotriazole, and 2,2′-methylenebis[4-(1,1,3,3-tetramethylbutyl)-6-[(2H-benzotriazol-2-yl)phenol]]; and 2-(4,6-diphenyl-1,3,5-triazin-2-yl)-5-[(hexyl)oxy]-phenol, 2,4-dihydroxobenzofenone, 2-hydroxy-4-n-octyloxybenzofenone, 2-hydroxy-4-methoxy-2′-carboxybenzofenone, a dimethyl succinate-1-(2-hydroxyethyl)-4-hydroxy-2,2,6,6-tetramethylpiperidine condensation polymer, bis(1-octyloxy-2,2,6,6-tetramethyl-4-piperidyl)sebacate, and bis(2,2,6,6-tetramethyl-4-piperidyl)sebacate. Of those, 2,2′-methylenebis[4-(1,1,3,3-tetramethylbutyl)-6-(2H-benzotriazol-2-yl)phenol]], 2-[2-hydroxy-3,5-bis(α,α-dimethylbenzyl)phenyl]-2H-benzotriazole, 2-(3-t-butyl-5-methyl-2-hydroxyphenyl)-5-chlorobenzotriazole, and 2-(3,5-di-t-butyl-2-hydroxyphenyl)-5-chlorobenzotriazole are preferably used.

One kind of UV absorber may be used alone, or two or more kinds thereof may be used in combination. A UV absorber containing substantially no organic impurities, metal impurities, chlorine, and the like and having a high purity is preferably used.

An addition amount of the UV absorber is 0.005 to 1 part by mass, preferably 0.01 to 0.5 part by mass, and more preferably 0.05 to 0.4 part by mass with respect to 100 parts by mass of the polythiocarbonate resin.

An addition amount thereof of less than 0.005 part by mass may provide an insufficient UV transmission protecting effect, and an addition amount thereof of more than 1 mass % may cause coloring or degradation of mechanical strength.

A generally used releasing agent may be used, and examples thereof include: natural or synthetic paraffins; silicone oil; polyethylene waxes; bees wax; and a fatty acid ester such as monoglyceride stearate, monoglyceride palmitate, or pentaerythritol tetrastearate. Particularly preferred examples thereof include monoglyceride stearate, monoglyceride palmitate, and pentaerythritol tetrastearate.

One kind of releasing agent may be used alone, or two or more kinds thereof may be used in combination. A releasing agent containing substantially no organic impurities, metal impurities, chlorine, and the like and having a high purity is preferably used.

In general, about 0.005 to 2 parts by mass of the releasing agent is used with respect to 100 parts by mass of the polythiocarbonate resin. However, the addition amount is desirably set in a minimum amount satisfying a required releasing effect for maintaining favorable color and reducing whitening, bleed out, or the like due to poor compatibility.

In addition, a pigment, a dye, an impact modifier, a filler, a lubricant, a crystal nucleator, a plasticizer, a fluidity improver, an antistatic agent, or the like may be used alone or used in combination as required.

Various additives are preferably added after addition of the raw materials for the polythiocarbonate resin for suppressing heat degradation of the additives themselves. This case results in a complex extrusion step requiring a large L/D for an extruder, coloring or molecular weight reduction due to increase of heat history in the extrusion step of the polycarbonate resin, or cost increase due to addition of an extruder or a device for supplying additives. Thus, positions for adding the additives are preferably appropriately set in consideration of the balance among the effect and the results.

In the case where those additives are used, at least an antioxidant is effectively used in combination.

Next, the present invention 2 will be described in detail.

The sulfur-containing compound of the present invention 2 is obtained by reacting the dithiol compound (II) and the diene compound (III) as described by the following scheme (A), for example. The diol and the diene are not each limited to one kind, and one or more kinds thereof may be used.

$$HS - {G}^{1} - SH + {G}^{{2}^{″}} \to X - {( S - {G}^{1} - S - {G}^{2} )}_{n} - S - {G}^{1} - S - {X}^{′} \\ \begin{matrix} \begin{matrix} & & ( II ) & & & & ( III ) & & & & & & & & & & & ( I ) & & & & \end{matrix} & & & & & & & & & & & & & & & & & & & \end{matrix} \qquad ( A )$$

In the formula: X and X′ each independently represent —H or -G^{2′}; G¹ represents an aliphatic or alicyclic hydrocarbon group which may contain a sulfur and/or oxygen atom, or an aromatic group or condensed polycyclic aromatic group which may be substituted; G² and G^{2′} each represent a reactive group derived from G^{2″}; G² represents a group in which two carbon-carbon double bonds of G^{2″} reacted; G^{2′} represents a group in which one carbon-carbon double bond of G^{2″} reacted; G^{2″} represents an aliphatic or alicyclic hydrocarbon compound which has two or more carbon-carbon double bonds and which may contain at least one atom selected from the group consisting of oxygen, nitrogen, sulfur, and silicon, or an aromatic or condensed polycyclic aromatic compound which may be substituted; and n represents an integer of 1 to 200.

The reaction may proceed by only mixing the dithiol (II) and the diene (III), but requires heating, photoirradiation, and a catalyst depending on the kind of diene (III) to be used.

For heating, a temperature of 0° C. to 200° C. is preferred.

Although depending on the kind of a reactive group of diene (III) for polymerization, examples of the catalyst to be used include: amines, for example, ethyl amine, amino ethanol, triethyl amine, tributyl amine, N,N-diethylamino ethanol, triethanolamine, pyridine, morpholine, imidazole, aniline, ethylenediamine; azo-based radical initiators, for example, 2,2′-azobisisobutyronitrile (AIBN), 2,2′-azobis(2,4-dimethylvaleronitrile) (ADVN), 2,2′-azobis(2-methylpropionatemethyl), 2,2′-azobis(2-methylbutyronitrile) (AMBN), 2,2′-azobis(2,4′-dimethyl-4-methoxyvaleronitrile) (V-70), and 4,4′-azobis(4-cyanopentanoic acid) (ACVA); peroxide-based radical initiators, for example, lauroyl peroxide, benzoyl peroxide, bis(4-tert-butylcyclohexyl)peroxydicarbonate, tert-butylperoxy-2-ethylhexanoate, methyl ethyl ketone peroxide, hydrogen peroxide water, air, oxygen, and ozone; phosphines, for example, trimethylphosphine, triethylphosphine, tripropylphosphine, triburilphosphine, and triphenylphosphine; and Lewis acids, for example, aluminum chloride, zinc chloride, iron chloride, titanium chloride, dimethyltin dichloride, dimethyltin oxide, tetrachlorotin, monobutyltin trichloride, dibutyltin dichloride, tributyltin chloride, tetrabutyltin, dibutyltin oxide, dibutyltin diurate, dibutyltin dilaurate, dibutyltin octanoate, tin stearate, tetraisopropoxytitanium, tetrabutoxytitanium, triethylborane, 9-borabicyclo[3.3.1]nonane (9-BBN), and boron trifluoride.

A reaction solvent may be used or not used. When the reaction solvent is used, examples thereof include: hydrocarbons, for example, pentane, hexane, cyclohexane, heptane, octane, nonane, and decane; aromatics, for example, benzene, toluene, xylene, and chlorobenzene; halogenated hydrocarbons, for example, chloroform, dichloromethane, dichloroethane, and carbon tetrachloride; ketones, for example, acetone, methyl ethyl ketone, isopropyl ketone, and isophorone; esters, for example, ethyl acetate and methyl acetate; ethers, for examples, diethylether, tert-butylmethylether, monoglyme, tetrahydrofuran, and dioxane; water; alcohols, for example, methanol, ethanol, propanol, isopropanol, butanol, ethylene glycol, diethylene glycol, and triethylene glycol; and nonprotonic polar solvents, for example, acetonitrile, dimethyl sulfoxide, N,N-dimethylformamide, and N-methylpyrolidone.

A reaction temperature varies depending on the kind of dithiol or diene to be used, the molar ratio of dithiol to diene in a reaction, the kind or use amount of a reaction solvent, and the kind or use amount of a catalyst to be used, and cannot be determined generally.

Practically, in the case where a base is used as a catalyst and no solvent is used, for example, a temperature allowing a mixture of the dithiol and the diene to be dissolved and be stirred, that is, from room temperature to 150° C. is preferred.

In the case where a base is used as a catalyst and a solvent is used, a room temperature of the solvent to a reflux temperature of the solvent is preferred.

In the case where a radical initiator is used as a catalyst and no solvent is used, a reaction is preferably performed at a temperature allowing a mixture of the dithiol and the diene to be dissolved and be stirred or at about a temperature of a 10-hour half-life of the radical initiator.

In the case where a radical initiator is used as a catalyst and a solvent is used, a room temperature to a reflux temperature of the solvent or a temperature of a 10-hour half-life of the radical initiator is preferred.

In the case where the reaction involves photoirradiation, 0° C. to a boiling point of a solvent is preferred.

An oligomer to be produced is an oligomer or an oligomer mixture which contains at least one of a dimer, a trimer, a tetramer, and a multimer of a higher degree and which may contain unreacted raw materials.

In general, a reaction product contains unreacted raw materials and several kinds of oligomers.

In the present invention, in the case where a reaction is performed without a solvent, a reaction product may be directly used as a polymer raw material for an optical material.

In the case where a reaction is performed by using a solvent, the solvent may be distilled off after the reaction and a reaction product may be used as a polymer raw material for an optical material.

In the case where a reaction is performed by using a solvent to be used in production of a resin, a reaction product may be directly used as a polymer raw material.

As required, an oligomer may be isolated and purified or a required oligomer component may be extracted, and then be used as a polymer raw material.

In the present invention, the dithiol compound employs a compound represented by the following general formula (II):

HS-G¹-SH (II)

where G¹ represents an aliphatic or alicyclic hydrocarbon group which may contain a sulfur and/or oxygen atom, or an aromatic group or condensed polycyclic aromatic group which may be substituted.

A preferred example of the dithiol compound represented by the general formula (II) is a compound having an aliphatic group or an alicyclic hydrocarbon group as G¹.

Specific examples of the dithiol compound having an aliphatic group as G¹ include HSCH₂CH₂SH, HSCH₂CH₂CH₂SH, HSCH₂CH₂CH₂CH₂SH, HSCH₂CH₂CH₂CH₂CH₂SH, HSCH₂CH₂CH₂CH₂CH₂CH₂SH, HSCH₂CH₂OCH₂CH₂SH, and HSCR₂CH₂SCH₂CH₂SH.

Examples of the dithiol compound having an alicyclic hydrocarbon group as G¹ include: a dithiol compound having 6 to 35 carbon atoms and a cyclohexane group which may contain a sulfur and/or oxygen atom as an alicyclic hydrocarbon group; a dithiol compound having 7 to 35 carbon atoms and a norbornane group which may contain a sulfur and/or oxygen atom as an alicyclic hydrocarbon group; and a dithiol compound having 10 to 35 carbon atoms and an adamantane group which may contain a sulfur and/or oxygen atom as an alicyclic hydrocarbon group.

Of those, preferred examples thereof include dithiol compounds to be described below.

In the present invention, one kind of dithiol compound may be used alone, or two or more kinds thereof may be used in combination.

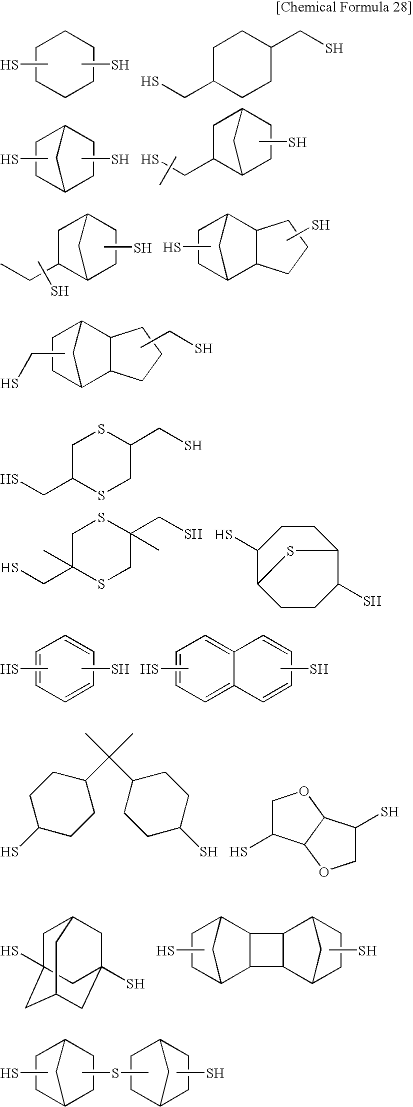

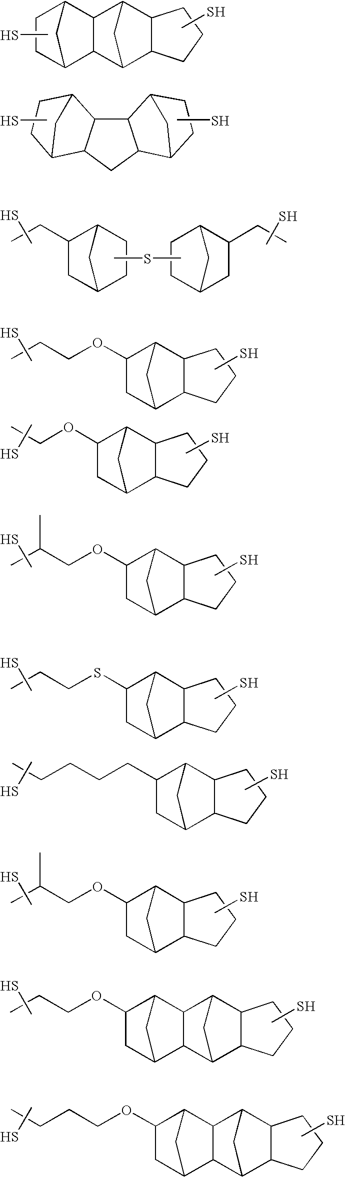

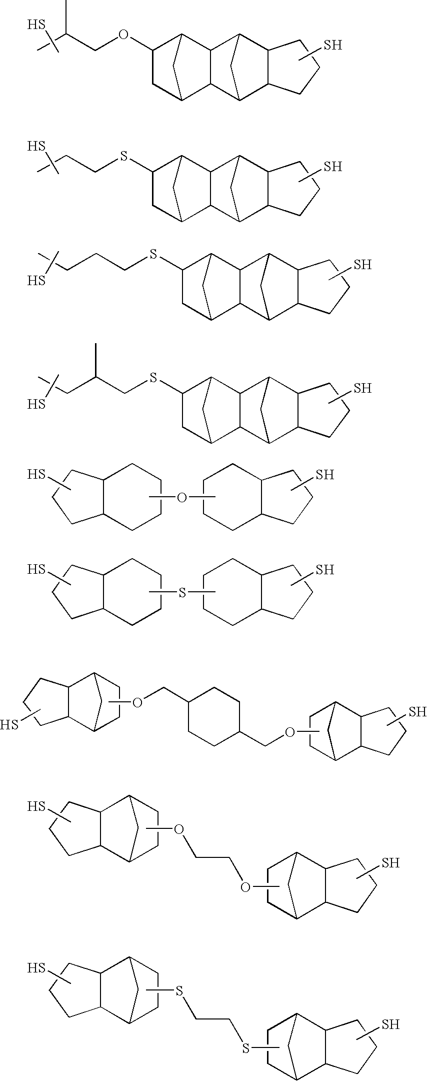

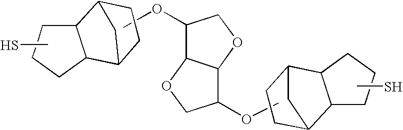

In the present invention, the diene compound employs a compound represented by the following general formula (III):

G^{2″} (III)

where G^{2″} represents an aliphatic or alicyclic hydrocarbon compound which has two or more carbon-carbon double bonds and which may contain at least one atom selected from the group consisting of oxygen, nitrogen, sulfur, and silicon, or an aromatic compound or condensed polycyclic aromatic compound which may be substituted.

A preferred example of the diene compound represented by G^{2″} is at least one compound selected from the group consisting of: an aliphatic or alicyclic hydrocarbon compound having two or more carbon-carbon double bonds and an acrylate group which may contain at least one atom selected from the group consisting of oxygen, nitrogen, sulfur, and silicon; an aliphatic or alicyclic hydrocarbon compound having a methacrylate group which may contain at least one atom selected from the group consisting of oxygen, nitrogen, sulfur, and silicon; an aliphatic or alicyclic hydrocarbon compound having an allyl group which may contain at least one atom selected from the group consisting of oxygen, nitrogen, sulfur, and silicon; and an aliphatic or alicyclic hydrocarbon compound having a vinyl group which may contain at least one atom selected from the group consisting of oxygen, nitrogen, sulfur, and silicon. To be specific, the diene compound represented by G^{2″} is at least one compound selected from diene compounds to be described below.

Further, UA-NDP, UA-160™, UA-122P (all available from Shin-Nakamura Chemical Co., Ltd.), BY16-152D and BY16-152B (both available from Dow Corning Toray Silicone Co., Ltd.), and the like may be used.

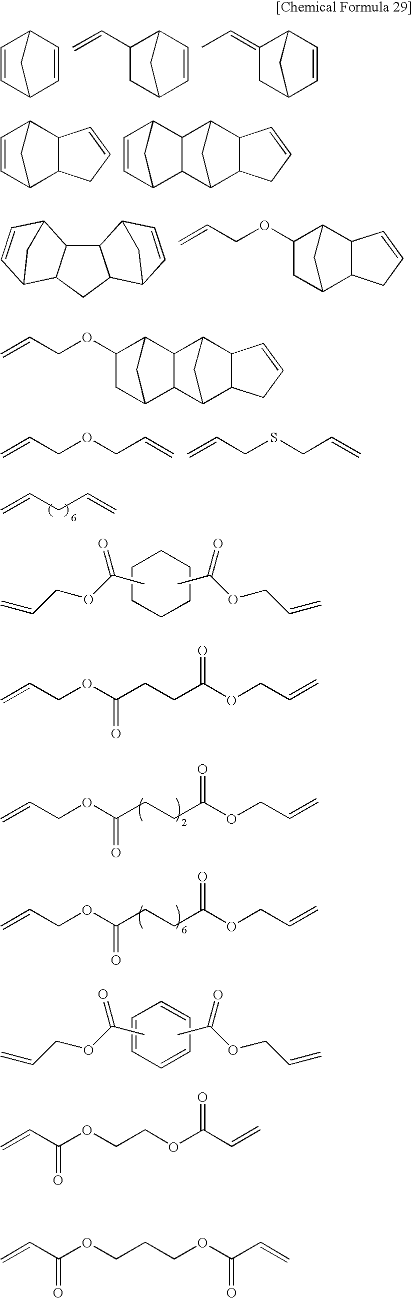

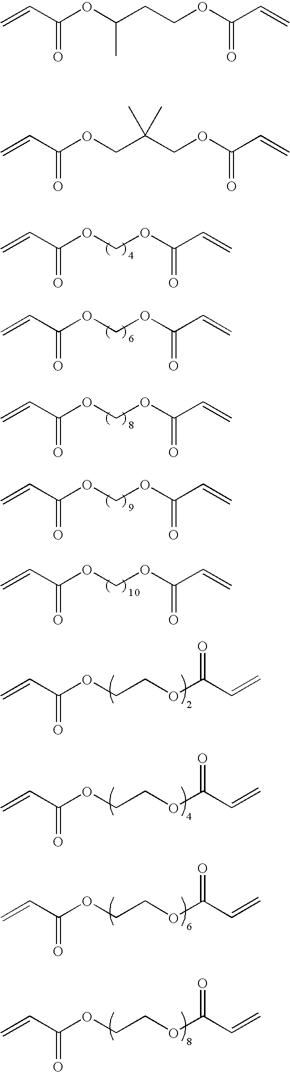

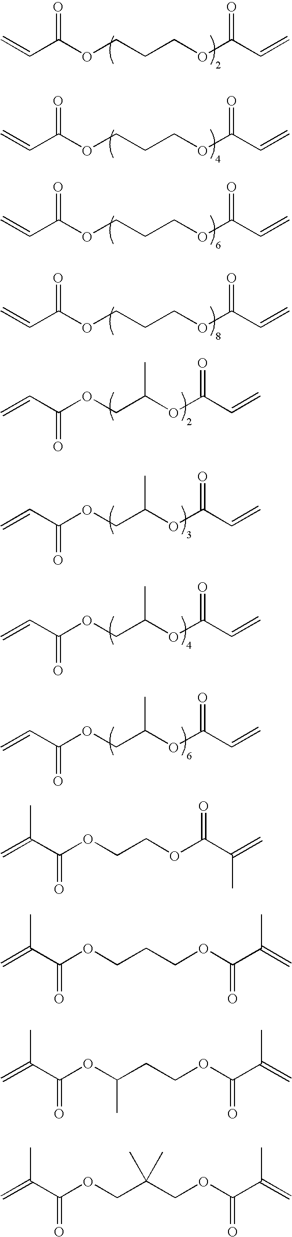

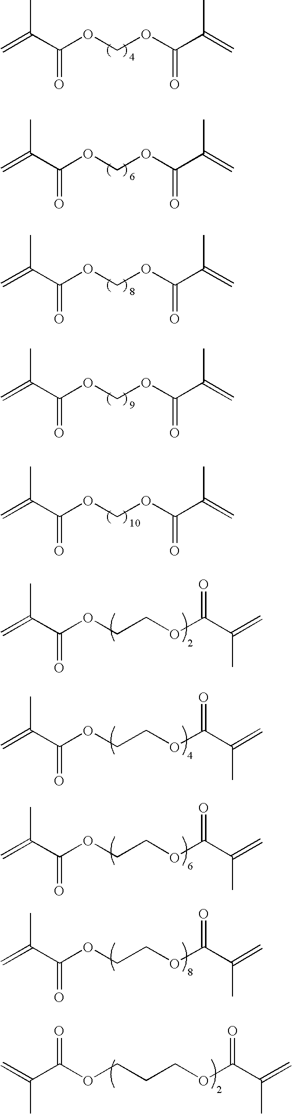

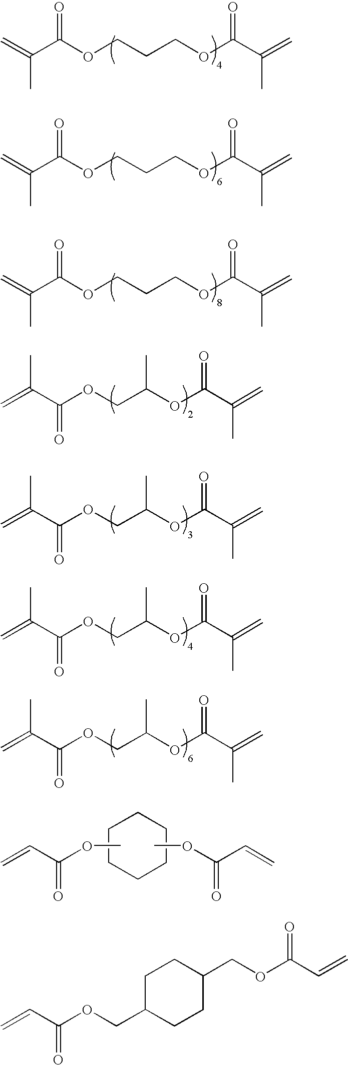

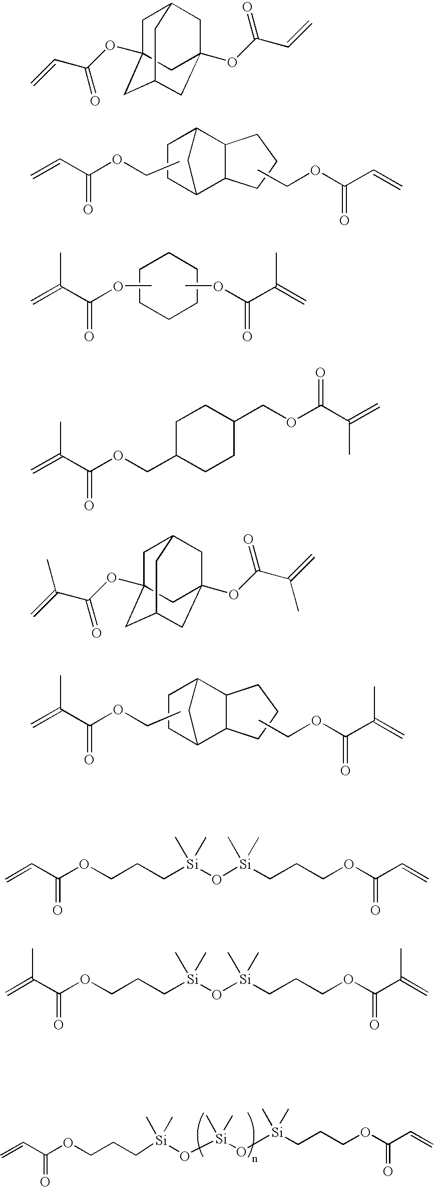

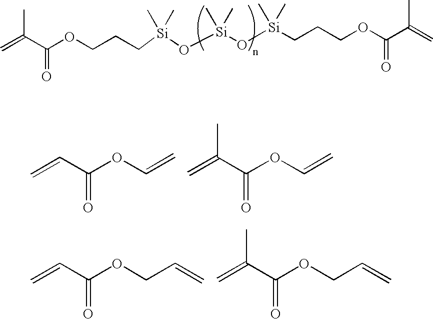

The dithiol compound represented by the general formula (II) can be synthesized by reacting a halide (IV) with a mercapto agent as described by the following scheme (B), for example:

C₁-G¹-Cl→HS-G¹-SH (B)

(IV) (II)

where G¹ is the same as that described above.

Examples of a typical synthesis method represented by the scheme (B) include the following methods (1) to (5).

(1) A method of synthesizing a dithiol compound by: synthesizing an isothiouronium salt through a reaction of a halide (IV) and thiourea; and hydrolyzing the isothiouronium salt.
(2) A method of synthesizing a dithiol compound by reacting a halide (IV) and an alkali metal hydrosulfide.
(3) A method of synthesizing a dithiol compound by: synthesizing an O-alkyldithiocarbonic acid ester through a reaction of a halide (IV) and an alkali metal salt of O-alkyldithiocarbonic acid; and hydrolyzing the O-alkyldithiocarbonic acid ester with an alkali metal salt.
(4) A method of synthesizing a dithiol compound by: synthesizing a Bunte salt through a reaction of a halide (IV) and sodium thiosulfate; and hydrolyzing the Bunte salt with an acid.
(5) A method of synthesizing a dithiol compound by: synthesizing a thiocarbonic acid ester through a reaction of a halide (IV) and an alkali metal salt of thiocarbonic acid; and hydrolyzing the thiocarbonic acid ester with a base.

The dithiol compound represented by the general formula (II) can be synthesized by reacting a hydroxide compound (V) with a mercapto agent as described by the following scheme (C).

HO-G¹-OH→HS-G¹-SH (C)

(V) (II)

An example of a typical synthesis method represented by the scheme (C) is a method of synthesizing a dithiol compound by: synthesizing an isothiouronium salt through a reaction of a hydroxide compound (V) with thiourea in the presence of bromic acid or hydrochloric acid; and then hydrolyzing the isothiouronium salt.

An alicyclic dithiol compound can be synthesized by, for example, reacting a mercapto agent with a corresponding alicyclic diene compound (VI) and hydrolyzing the resultant with an alkali metal salt as described by a scheme (D). A dithiol compound can be obtained by synthesizing an acetylthio compound through a reaction of thioacetic acid with a corresponding alicyclic diene compound (IV) and then hydrolyzing the resultant with an alkali metal salt as described by the following scheme (D).

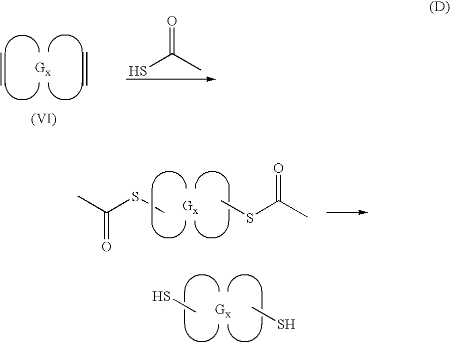

Of the diene compounds represented by the general formula (III) and used in the present invention, an aliphatic or alicyclic hydrocarbon compound which has an acrylate group or a methacrylate group and which may contain at least atom selected from the group consisting of oxygen, nitrogen, sulfur, and silicon can be obtained by reacting (meth) acrylic acid with a corresponding diol (HO-G_{Y}-OH) under heating as described by the following scheme (E), for example.

For example, di(meth)acrylate (III) can be obtained by: reacting (meth)acrylic acid and a diol (HO-G_{Y}-OH) in a toluene solvent and by using p-toluenesulfonic acid or methanesulfonic acid; and distilling off water to be produced out of the system with a Dean-Stark trap or the like.

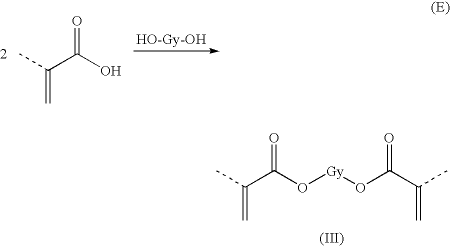

As described by a scheme (F), di(meth)acrylate (III) can be obtained by reacting (meth)acrylic chloride with a corresponding diol (HO-G_{Y}-OH) in the presence of a base.

For example, di(meth)acrylate (III) can be obtained by reacting (meth)acrylic chloride with a corresponding diol (HO-G_{Y}-OH) in a toluene solvent and by using triethylamine as a catalyst.

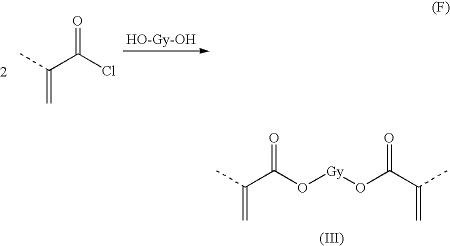

The sulfur-containing polymer of the present invention is not particularly limited as long as it is a polymer prepared by using the sulfur-containing compound of the present invention as a raw material. A preferred example thereof is a polythiocarbonate obtained through a reaction of: a polymer product of at least one compound selected from the sulfur-containing compounds of the present invention, and at least one compound selected from the group consisting of a polyisocyanate compound, a polyisothiocyanate compound, and an isothiocyanate compound having an isocyanate group; and a polycarbonate oligomer having a dihydric phenol or a functional group capable of reacting with the sulfur-containing compound on its terminal.

In the polymer product of at least one compound selected from the sulfur-containing compounds of the present invention, and at least one compound selected from the group consisting of a polyisocyanate compound, a polyisothiocyanate compound, and an isothiocyanate compound having an isocyanate group, a use ratio [(NCO+NCS)]/SH] (functional group) of at least one compound selected from the group consisting of a polyisocyanate compound, a polyisothiocyanate compound, and an isothiocyanate compound having an isocyanate group to the sulfur-containing compound is generally 0.5 to 3.0, and preferably 0.5 to 1.5 in molar ratio.

The polymer product is generally obtained through injection polymerization. To be specific, the polymer product is obtained by: mixing at least one compound selected from the group consisting of a polyisocyanate compound, a polyisothiocyanate compound, and an isothiocyanate compound having an isocyanate group, and the sulfur-containing compound; subjecting this mixed liquid to degassing by an appropriate method as required; injecting the mixed liquid into a mold; and generally polymerizing the resultant under gradual heating from low temperatures to high temperatures.

A polymerization temperature and a polymerization time vary depending on the composition of a monomer and the kinds and use amounts of additives. However, polymerization is generally started from about 20° C. and involves heating to about 120° C. for about 8 to 24 hours.

In this case, the mold may be subjected to known releasing treatment for facilitating releasing property after polymerization.

Various substances such as an internal releasing agent, a chain extending agent, a cross-linking agent, a light stabilizer, a UV absorber, an antioxidant, an oil-soluble dye, and a filler may be added in accordance with the purpose in a similar manner as in a known forming method.

Further, a known reaction catalyst to be used in production of polyurethane can appropriately be added for adjusting to a desired reaction rate.

The polymer product contains as a main component a thiocarbamic acid S-alkyl ester-based resin and/or a dithiourethane-based resin, and mainly has a thiocarbamic acid S-alkylester bond formed of an isocyanate group and a mercapto group and/or a dithiourethane bond formed of an isothiocyanate group and a mercapto group.

An allophanate bond, a urea bond, a thiourea bond, a biuret bond, or the like may be included in addition to the above-mentioned bonds in accordance with the intended purpose of the sulfur-containing polymer.

For example, a cross-linking density may be increased by reacting an isocyanate group with a thiocarbamic acid S-alkylester bond or reacting an isothiocyanate group with a dithiourethane bond, to thereby often provide preferred results.

In this case, a reaction temperature is set to 100° C. or higher, and a large amount of an isocyanate component and/or an isothiocyanate component is used.

Alternatively, an amine or the like may partly be used in combination with a urea bond or a biuret bond.

In the case where a compound excluding a mercapto compound capable of reacting with an isocyanate compound or an isothiocyanate compound is used, coloring should be taken into consideration, in particular.

The polythiocarbonate of the present invention 2 preferably has a reduced viscosity (ηsp/C) of 0.2 dl/g or more at 20° C. as a 0.5 g/dl solution containing methylenechloride as a solvent.

A reduced viscosity of 0.2 dl/g or less may provide a resin having degraded mechanical strength, which is easily cracked.

The reduced viscosity is more preferably 0.2 to 5.0 dl/g, particularly preferably 0.27 to 2.0 dl/g, and most preferably 0.37 to 0.7 dl/g.

A reduced viscosity of more than 5.0 dl/g may degrade formability.

A method of producing the polythiocarbonate resin of the present invention is not particularly limited, and the polythiocarbonate may be produced by using a monomer required for forming the polythiocarbonate of the present invention in accordance with a known method (such as an interfacial polycondensation method using phosgene and an alkaline solution, a method using phosgene and pyridine, or a method involving ester exchange).

For example, the polythiocarbonate of the present invention may be produced by a method to be described below.

That is, the polythiocarbonate of the present invention may be produced by reacting a dithiol compound (A) having at least a condensed alicyclic ring structure alone, or a component (A) and a bisphenol compound (B) with a carbonic acid ester formative compound.

A ratio of the components (A) and (B) to be used is appropriately selected, to thereby adjust a ratio of copolymerization.

In the present invention, it is important that impurities in a polythiocarbonate to be obtained be in a certain amount or less, and thus an interfacial polycondensation method using phosgene and an alkaline solution is preferably employed from this viewpoint.

As described in the present invention 1, the polythiocarbonate of the present invention may be synthesized by using at least a dithiol compound having a condensed alicyclic ring structure and represented by the general formula HS—X—W-(Z-W)ₙ—Y—SH (where X, Y, Z, W, and n represent the same as those described above) as a raw material and as the component (A).

Examples of the dithiol compound represented by the general formula as the component (A) include the compounds as described in the present invention 1 (see, chemical formulae 25 to 27), or the like.

Examples of the bisphenol compound available for Component (B) include bis(4-hydroxyphenyl)methane, 1,1-bis(4-hydroxyphenyl)ethane, 1,2-bis(4-hydroxyphenyl)ethane, 2,2-bis(4-hydroxyphenyl)propane, 1,1-bis(4-hydroxyphenyl)propane, 1,1-bis(3-methyl-4-hydroxyphenyl)propane, 1,1-bis(3-fluoro-4-hydroxyphenyl)propane, 1,1-bis(3-chloro-4-hydroxyphenyl)propane, 1,1-bis(3-phenyl-4-hydroxyphenyl)propane, 2,2-bis(4-hydroxyphenyl)butane, 2,2-bis(3-methyl-hydroxyphenyl)butane, 2,2-bis(3-fluoro-hydroxyphenyl)butane, 2,2-bis(3-chloro-hydroxyphenyl)butane, 2,2-bis(3-phenyl-hydroxyphenyl)butane, 2,2-bis(3-methyl-4-hydroxyphenyl)butane, 2,2-bis(4-hydroxyphenyl)octane, 4,4-bis(4-hydroxyphenyl)heptane, 1,1-bis(4-hydroxyphenyl)-1,1-diphenylmethane, 1,1-bis(4-hydroxyphenyl)-1-phenylethane, 1,1-bis(4-hydroxyphenyl)-1-phenylmethane, bis(4-hydroxyphenyl)ether, bis(4-hydroxyphenyl)sulfide, bis(4-hydroxyphenyl)sulfone, 1,1-bis(4-hydroxyphenyl)cyclopentane, 1,1-bis(4-hydroxyphenyl)cyclohexane, 2,2-bis(3-methyl-4-hydroxyphenyl)propane, 2,2-bis(3-phenyl-4-hydroxyphenyl)propane, 2-(3-methyl-4-hydroxyphenyl)-2-(4-hydroxyphenyl)-1-phenylethane, bis(3-methyl-4-hydroxyphenyl)sulfide, bis(3-methyl-4-hydroxyphenyl)sulfone, 1,1-bis(3-methyl-4-hydroxyphenyl)cyclohexane, 4,4′-biphenol, 3,3′-dimethyl-4,4′-biphenol, 3,3′-diphenyl-4,4′-biphenol, 3,3′-dichloro-4,4′-biphenol, 3,3′-difluoro-4,4′-biphenol, 3,3′,5,5′-tetramethyl-4,4′-biphenol, 2,2-bis(2-methyl-4-hydroxyphenyl)propane, 1,1-bis(2-butyl-4-hydroxy-5-methylphenyl)butane, 1,1-bis(2-tert-butyl-4-hydroxy-3-methylphenyl)ethane, 1,1-bis(2-tert-butyl-4-hydroxy-5-methylphenyl)propane, 1,1-bis(2-tert-butyl-4-hydroxy-5-methylphenyl)butane, 1,1-bis(2-tert-butyl-4-hydroxy-5-methylphenyl)isobutane, 1,1-bis(2-tert-butyl-4-hydroxy-5-methylphenyl)heptane, 1,1-bis(2-tert-butyl-4-hydroxy-5-methylphenyl)-1-phenylmethane, 1,1-bis(2-tert-amyl-4-hydroxy-5-methylphenyl)butane, bis(3-chloro-4-hydroxyphenyl)methane, bis(3,5-dibromo-4-hydroxyphenyl)methane, 2,2-bis(3-chloro-4-hydroxyphenyl)propane, 2,2-bis(3-fluoro-4-hydroxyphenyl)propane, 2,2-bis(3-bromo-4-hydroxyphenyl)propane, 2,2-bis(3,5-difluoro-4-hydroxyphenyl)propane, 2,2-bis(3,5-dichloro-4-hydroxyphenyl)propane, 2,2-bis(3,5-dibromo-4-hydroxyphenyl)propane, 2,2-bis(3-bromo-4-hydroxy-5-chlorophenyl)propane, 2,2-bis(3,5-dichloro-4-hydroxyphenyl)butane, 2,2-bis(3,5-dibromo-4-hydroxyphenyl)butane, 1-phenyl-1,1-bis(3-fluoro-4-hydroxyphenyl)ethane, bis(3-fluoro-4-hydroxyphenyl)ether, 3,3′-difluoro-4,4′-dihydroxybiphenyl, 1,1-bis(3-cyclohexyl-4-hydroxyphenyl)cyclohexane, 2,2-bis(3-cyclohexyl-4-hydroxyphenyl)propane, 1,1-bis(3-ethyl-4-hydroxyphenyl)cyclohexane, 2,2-bis(3-ethyl-4-hydroxyphenyl)propane, 1,1-bis(3-propyl-4-hydroxyphenyl)cyclohexane, 2,2-bis(3-propyl-4-hydroxyphenyl)propane, 1,1-bis(3-isopropyl-4-hydroxyphenyl)cyclohexane, 2,2-bis(3-isopropyl-4-hydroxyphenyl)propane, 1,1-bis(3-butyl-4-hydroxyphenyl)cyclohexane, 2,2-bis(3-butyl-4-hydroxyphenyl)propane, 1,1-bis(3-sec-butyl-4-hydroxyphenyl)cyclohexane, 2,2-bis(3-sec-butyl-4-hydroxyphenyl)propane, 1,1-bis(3-tert-butyl-4-hydroxyphenyl)cyclohexane, 2,2-bis(3-tert-butyl-4-hydroxyphenyl)propane, 1,1-bis(3-isobutyl-4-hydroxyphenyl)cyclohexane, 2,2-bis(3-isobutyl-4-hydroxyphenyl)propane, 2,2-bis(4-hydroxyphenyl)hexafluoropropane, 1,1-bis(3-phenyl-4-hydroxyphenyl)cyclohexane, bis(3-phenyl-4-hydroxyphenyl)sulfone, 4,4′-(3,3,5-trimethylcyclohexylidene)diphenol, 4,4′-(1,4-phenylenebis(1-methylethylidene))bisphenol, 4,4′-(1,3-phenylenebis(1-methylethylidene))bisphenol, and terminal phenolpolydimethyl siloxane. Of those, 1,1-bis(4-hydroxyphenyl)ethane, 2,2-bis(4-hydroxyphenyl)propane, 2,2-bis(4-hydroxyphenyl)butane, 1,1-bis(4-hydroxyphenyl)cyclohexane, 2,2-bis(3-methyl-4-hydroxyphenyl)propane, 1,1-bis(3-methyl-4-hydroxyphenyl)cyclohexane, 1,1-bis(3-cyclohexyl-4-hydroxyphenyl)cyclohexane, 2,2-bis(3-cyclohexyl-4-hydroxyphenyl)propane, 1,1-bis(3-ethyl-4-hydroxyphenyl)cyclohexane, 2,2-bis(3-ethyl-4-hydroxyphenyl)propane, 1,1-bis(3-propyl-4-hydroxyphenyl)cyclohexane, 2,2-bis(3-propyl-4-hydroxyphenyl)propane, 1,1-bis(3-isopropyl-4-hydroxyphenyl)cyclohexane, 2,2-bis(3-isopropyl-4-hydroxyphenyl)propane, 1,1-bis(3-butyl-4-hydroxyphenyl)cyclohexane, 2,2-bis(3-butyl-4-hydroxyphenyl)propane, 1,1-bis(3-sec-butyl-4-hydroxyphenyl)cyclohexane, 2,2-bis(3-sec-butyl-4-hydroxyphenyl)propane, 1,1-bis(3-tert-butyl-4-hydroxyphenyl)cyclohexane, 2,2-bis(3-tert-butyl-4-hydroxyphenyl)propane, 1,1-bis(3-isobutyl-4-hydroxyphenyl)cyclohexane, and 2,2-bis(3-isobutyl-4-hydroxyphenyl)propane are preferable.

The method of producing the polythiocarbonate resin of the present invention includes: a first step of reacting a dithiol compound (A) alone, a mixture of a dithiol compound (A) and a bisphenol compound (B), or a bisphenol compound (B) alone with a dihalogenated carbonyl compound or a haloformate compound as a carbonic acid ester formative compound by an interfacial polycondensation method in the presence of an alkaline solution and an organic solvent incapable of mixing with water to obtain an oligomer having a haloformate terminal and having a viscosity average molecular weight of less than 7,000; and a second step of reacting the obtained oligomer with a bisphenol compound, a dithiol compound, or a dithiol compound and a bisphenol compound by an interfacial polycondensation method in the presence of an alkaline solution and an organic solvent incapable of mixing with water to obtain a polymer having a viscosity average molecular weight of 7,000 or more.

In the method of producing the polythiocarbonate of the present invention, examples of a carbonic acid ester formative compound to be used include: phosgene as a dihalogenated carbonyl compound; and chloroformate as a haloformate compound.

In the case where the carbonic acid ester formative compound is used, the first step may be performed in the presence of an acid acceptor (including: a basic alkali metal compound such as an alkali metal hydroxide or an alkali metal carbonate; or an organic base such as pyridine) in an appropriate organic solvent.

Various compounds may be used as an alkali metal hydroxide or an alkali metal carbonate. In general, sodium hydroxide, potassium hydroxide, sodium carbonate, or potassium carbonate is preferably used from an economical viewpoint, and the compound is generally used in a form of a solution.

A use ratio of the carbonic acid ester formative compound may appropriately be adjusted in consideration of a stoichiometric ratio (equivalent) of a reaction.

In the case where a gaseous carbonic acid ester formative compound such as phosgene is used, a method of blowing the gaseous carbonic acid ester formative compound into a reaction system is preferably employed.

Similarly, a use ratio of the acid acceptor may appropriately be adjusted in consideration of a stoichiometric ratio (equivalent) of a reaction.

To be specific, 2 equivalents or a slightly excess amount thereof of an acid acceptor is preferably used with respect to a total moles (generally, 1 mole corresponds to 1 equivalent) of the dithiol compound to be used, or the dithiol compound and bisphenol compound to be used.

Examples of the organic solvent to be used in the first and second steps include one kind or a mixture of various solvents to be used in production of a polycarbonate resin.

Typical examples of the organic solvent include carbon hydride solvents such as toluene and xylene, and halogenated carbon hydride solvents including methylene chloride and chlorobenzene.

The reactions may be performed by adding: a catalyst for accelerating polymerization reactions in the first and second steps including a tertiary amine or a quaternary amine such as triethylamine; a terminating agent for adjusting a degree of polymerization including p-tert-butylphenol, cumyl phenol, or phenyl phenol; or a branching agent including phloroglucin, pyrogallol, 4,6-dimethyl-2,4,6-tris(4-hydroxyphenyl)-2-heptene, 1,3,5-tris(4-hydroxyphenyl)benzene, 1,1,1-tris(4-hydroxyphenyl)ethane, tris(4-hydroxyphenyl)phenylmethane, 2,2-bis[4,4-bis(4-hydroxyphenyl)cyclohexyl]propane, 2,4-bis[2-bis(4-hydroxyphenyl)-2-propyl]phenol, 2,6-bis(2-hydroxy-5-methylbenzyl)-4-methylphenol, 2-(4-hydroxyphenyl)-2-(2,4-dihydroxyphenyl)propane, tetrakis(4-hydroxyphenyl)methane, tetrakis[4-(4-hydroxyphenylisopropyl)phenoxy]methane, 2,4-dihydroxybenzoic acid, trimesic acid, or cyanuric acid.

The reactions in the first and second steps are performed in a temperature range of generally 0 to 150° C., and preferably 5 to 40° C.

A reaction pressure may be any of reduced pressure, normal pressure, or increased pressure, but the reactions are generally performed under normal pressure or under about a pressure of a reaction system.

A reaction time is generally 1 min to 5 hours, and preferably 10 min to 2 hours for the first step, and generally 1 min to 5 hours, and preferably 10 min to 2 hours for the second step.

A reaction type may be a semi-continuous-type, a batch-type, or the like, in addition to the interfacial polycondensation method described above.

The reduced viscosity (ηsp/C) of the polymer to be obtained may be adjusted to 0.2 dl/g or more by various methods such as adjusting the reaction conditions or adjusting a use amount of a molecular-weight-modifier.

The obtained polymer may appropriately be subjected to physical treatment (such as mixing or fractionation) and/or chemical treatment (such as polymer reaction, cross-linking treatment, or partial decomposition treatment), to thereby adjust the reduced viscosity to a predetermined value.

A reaction product (crude product) obtained in the first and second steps may be subjected to various known after treatments such as separation and purification, to thereby collect as a polythiocarbonate having a desired purity (degree of purification).

The sulfur-containing polymer of the present invention may have an antioxidant, a pigment, a dye, an impact modifier, a filler, a UV absorber, a lubricant, a releasing agent, a crystal nucleator, a plasticizer, a fluidity improver, an antistatic agent, and the like added during a production step and/or fabrication as required, in addition to the raw materials or the catalyst.

Further, for improving properties of the resin, a sulfur-containing polymer excluding those described above or a thermoplastic resin may be blended for use.

Examples of the antioxidant include: phosphite compounds such as triphenyl phosphite, tris(4-methylphenyl)phosphite, tris(4-t-butylphenyl)phosphite, tris(monononylphenyl)phosphite, tris(2-methyl-4-ethylphenyl)phosphite, tris(2-methyl-4-t-butylphenyl)phosphite, tris(2,4-di-t-butylphenyl)phosphite, tris(2,6-di-t-butylphenyl)phosphite, tris(2,4-di-t-butyl-5-methylphenyl)phosphite, tris(mono,dinonylphenyl)phosphite, bis(monononylphenyl)pentaerythritol-di-phosphite, bis(2,4-di-t-butylphenyl)pentaerythritol-di-phosphite, bis(2,6-di-t-butyl-4-methylphenyl)pentaerythritol-di-phosphite, bis(2,4,6-tri-t-butylphenyl)pentaerythritol-di-phosphite, bis(2,4-di-t-butyl-5-methylphenyl)pentaerythritol-di-phosphite, 2,2-methylenebis(4,6-dimethylphenyl)octylphosphite, 2,2-methylenebis(4-t-butyl-6-methylphenyl)octylphosphite, 2,2-methylenebis(4,6-di-t-butylphenyl)octylphosphite, 2,2-methylenebis(4,6-dimethylphenyl)hexylphosphite, 2,2-methylenebis(4,6-di-t-butylphenyl)hexylphosphite, and 2,2-methylenebis(4,6-di-t-butylphenyl)stearylphosphite; hindered phenol-based compounds such as pentaerythritol-tetrakis[3-(3,5-di-t-butyl-4-hydroxyphenyl)pro pionate], 1,6-hexanediol-bis[3-(3,5-di-t-butyl-4-hydroxyphenyl)propionate], octadecyl-3-(3,5-di-t-butyl-4-hydroxyphenyl)propionate, 1,3,5-trimethyl-2,4,6-tris(3,5-di-t-butyl-4-hydroxybenzyl)benzene, triethylene glycol-bis[3-(3-t-butyl-5-methyl-4-hydroxyphenyl)propionate], 3,9-bis{2-[3-(3-t-butyl-4-hydroxy-5-methylphenyl)propionyloxy]-1,1-dimethylethyl}-2,4,8,10-tetraoxaspiro[5,5]undecane, and 1,1,3-tris[2-methyl-4-(3,5-di-t-butyl-4-hydroxyphenylpropionyloxy)-5-t-butylphenyl]butane; and lactone-based compounds such as 5,7-di-t-butyl-3-(3,4-dimethylphenyl)-3H-benzofran-2-one. The use of the compounds which hardly contain an organic impurity, a metal impurity, chlorine, and the like, and thus have a high purity is preferable to maintain a color tone.

One kind of antioxidant may be used alone, or two or more kinds thereof may be used in combination.

A small amount of an antioxidant such as sodium sulfite or hydrosulfite may effectively be added as desired during polymerization of the raw materials, in particular.

An addition amount of the antioxidant is 0.005 to 1 part by mass, preferably 0.01 to 0.5 part by mass, and more preferably 0.01 to 0.2 part by mass with respect to 100 parts by mass of the sulfur-containing polymer. An addition amount thereof of 0.005 to 1 part by mass can provide a sufficient desired effect and favorable heat resistance and mechanical strength.

Examples of the ultraviolet absorber include: triazoles such as 2-(5-methyl-2-hydroxyphenyl)benzotriazole, 2-[2-hydroxy-3,5-bis(α,α-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-2-hydroxyphenyl)-5-chlorobenzotriazole, 2-(3,5-di-t-amyl-2-hydroxyphenyl)benzotriazole, 2-(2′-hydroxy-5′-t-octylphenyl)benzotriazole, and 2,2′-methylenebis[4-(1,1,3,3-tetramethylbutyl)-6-[(2H-benzotriazol-2-yl)phenol]]; and 2-(4,6-diphenyl-1,3,5-triazin-2-yl)-5-[(hexyl)oxy]-phenol, 2,4-dihydroxobenzofenone, 2-hydroxy-4-n-octyloxybenzofenone, 2-hydroxy-4-methoxy-2′-carboxybenzofenone, a dimethyl succinate-1-(2-hydroxyethyl)-4-hydroxy-2,2,6,6-tetramethylpiperidine condensation polymer, bis(1-octyloxy-2,2,6,6-tetramethyl-4-piperidyl)sebacate, and bis(2,2,6,6-tetramethyl-4-piperidyl)sebacate. Of those, 2,2′-methylenebis[4-(1,1,3,3-tetramethylbutyl)-6-(2H-benzotriazol-2-yl)phenol]], 2-[2-hydroxy-3,5-bis(α,α-dimethylbenzyl)phenyl]-2H-benzotriazole, 2-(3-t-butyl-5-methyl-2-hydroxyphenyl)-5-chlorobenzotriazole, and 2-(3,5-di-t-butyl-2-hydroxyphenyl)-5-chlorobenzotriazole are preferably used.

One kind of UV absorber may be used alone, or two or more kinds thereof may be used in combination. A UV absorber containing substantially no organic impurities, metal impurities, chlorine, and the like and having a high purity is preferably used.

An addition amount of the UV absorber is 0.005 to 1 part by mass, preferably 0.01 to 0.5 part by mass, and more preferably 0.05 to 0.4 part by mass with respect to 100 parts by mass of the sulfur-containing polymer.

An addition amount thereof of less than 0.005 part by mass may provide an insufficient UV transmission protecting effect, and an addition amount thereof of more than 1 mass % may cause coloring or degradation of mechanical strength.

A generally used releasing agent may be used, and examples thereof include: natural or synthetic paraffins; silicone oil; polyethylene waxes; bees wax; and a fatty acid ester such as monoglyceride stearate, monoglyceride palmitate, or pentaerythritol tetrastearate. Particularly preferred examples thereof include monoglyceride stearate, monoglyceride palmitate, and pentaerythritol tetrastearate.

One kind of releasing agent may be used alone, or two or more kinds thereof may be used in combination. A releasing agent containing substantially no organic impurities, metal impurities, chlorine, and the like and having a high purity is preferably used.

In general, about 0.005 to 2 parts by mass of the releasing agent is used with respect to 100 parts by mass of the sulfur-containing polymer. However, the addition amount is desirably set in a minimum amount satisfying a required releasing effect for maintaining favorable color and reducing whitening, bleed out, or the like due to poor compatibility.

In addition, a pigment, a dye, an impact modifier, a filler, a lubricant, a crystal nucleator, a plasticizer, a fluidity improver, an antistatic agent, or the like may be used alone or used in combination as required.

Various additives are preferably added after addition of the raw materials for the sulfur-containing polymer for suppressing heat degradation of the additives themselves. This case results in a complex extrusion step requiring a large L/D for an extruder, coloring or molecular weight reduction due to increase of heat history in the extrusion step of the sulfur-containing polymer, or cost increase due to addition of an extruder or a device for supplying additives. Thus, positions for adding the additives are preferably arbitrarily set in consideration of the balance among the effect and the results.

In the case where those additives are used, at least an antioxidant is effectively used in combination.

### EXAMPLES

Next, the present invention will be descried in more detail by way of examples, but the present invention is not limited to the examples in any way.

Note that evaluation of physical properties in Examples and Comparative Examples was performed as described below.

(1) Refractive Index (n_{D}) and Abbe Number (ν_{D})

Measurement was performed at 20° C. by using an Abbe refractometer manufactured by Atago Co., Ltd.

Note that in the case where a sample was a resin, measurement was performed by preparing a test piece with length×width×thickness of 20 mm×8 mm×3 mm and using a sulfur-methylene iodide solution as an intermediate liquid. In the case where a sample was solid powder at normal temperatures, a refractive index was determined by extrapolation and an Abbe number was determined from the refractive index.

(2) Reduced Viscosity (ηsp/C)

A reduced viscosity (ηsp/C) of a 0.5 g/dl solution containing methylene chloride as a solvent at 20° C. was measured by using an automatic viscometer VMR-042 and an automatic Ubbelohde improved viscometer (RM-type) manufactured by Rigo Co., Ltd.

### (3) Viscosity Average Molecular Weight

A viscosity average molecular weight was calculated from the following expressions (i) and (ii).

ηsp/C=[η](1+K′ηsp) (i)

[η]=KM^{a} (ii)

where

ηsp/C: reduced viscosity

[η]: intrinsic viscosity

C: polymer concentration (5 g/l)

K′: constant (0.28)

K: constant (1.23×10⁻⁵)

a: constant (0.83)

M: viscosity average molecular weight

### (4) Heat Resistance

(i) A glass transition temperature was measured by DSC.

A glass transition temperature of lower than 80° C. was indicated by “x”, and a glass transition temperature of 80° C. or higher and lower than 100° C. was indicated by “Δ”. A glass transition temperature of 100° C. or higher and lower than 120° C. was indicated by “o”, and a glass transition temperature of 120° C. or higher was indicated by “⊚”.

(ii) A viscosity average molecular weight before and after heating at 250° C. for 15 min was measured.

In the case where a molecular weight before heating was defined as 100, a relative molecular weight of 95 or more after heating was indicated by “o”. A relative molecular weight of 85 or more and less than 95 after heating was indicated by “Δ”, and a relative molecular weight of less than 85 after heating was indicated by “x”.

### Synthesis Example 1

### Method of Synthesizing 2,2-bis(4-hydroxyphenyl)propane Polythiocarbonate Resin having Chloroformate Group on Molecular Terminal

A solution prepared by dissolving 74 parts by mass of 2,2-bis(4-hydroxyphenyl)propane(bisphenol A; bis A) in 585 parts by mass of a 6 mass % solution of sodium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 2,2-bis(4-hydroxyphenyl)propane polythiocarbonate resin (hereinafter, referred to as bis A oligomer) having a chloroformate group on a molecular terminal and having a degree of polymerization of 2 to 4.

### Synthesis Example 2

### Method of Synthesizing 1,1-bis(4-hydroxyphenyl)cyclohexane Polythiocarbonate Resin having Chloroformate Group on Molecular Terminal

A solution prepared by dissolving 87 parts by mass of 1,1-bis(4-hydroxyphenyl)cyclohexane(bisphenol Z; bis Z) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(4-hydroxyphenyl)cyclohexane polythiocarbonate resin (hereinafter, referred to as bis Z oligomer) having a chloroformate group on a molecular terminal and having a degree of polymerization of 2 to 4.

### Synthesis Example 3

### Method of Synthesizing 2,2-bis(3-cyclohexyl-4-hydroxyphenyl)propane Polythiocarbonate Resin having Chloroformate Group on Molecular Terminal

A solution prepared by dissolving 127 parts by mass of 2,2-bis(3-cyclohexyl-4-hydroxyphenyl)propane(bisphenol CHA; bis CHA) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 2,2-bis(3-cyclohexyl-4-hydroxyphenyl) propane polythiocarbonate resin (hereinafter, referred to as bis CHA oligomer) having a chloroformate group on a molecular terminal and having a degree of polymerization of 2 to 4.

### Synthesis Example 4

### Method of Synthesizing 1,1-bis(3-cyclohexyl-4-hydroxyphenyl)cyclohexane Polythiocarbonate Resin having Chloroformate Group on Molecular Terminal

A solution prepared by dissolving 140 parts by mass of 1,1-bis(3-cyclohexyl-4-hydroxyphenyl)cyclohexane(bisphenol CHZ; bis Z) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(3-cyclohexyl-4-hydroxyphenyl)cyclohexane polythiocarbonate resin (hereinafter, referred to as bis CHZ oligomer) having a chloroformate group on a molecular terminal and having a degree of polymerization of 2 to 4.

### Synthesis Example 5

### Method of Synthesizing 2,2-bis(4-hydroxyphenyl) Adamantane Polythiocarbonate Resin having Chloroformate Group on Molecular Terminal

A solution prepared by dissolving 104 parts by mass of 2,2-bis(4-hydroxyphenyl)adamantane(2,2-adamantanebisphenol; b is 22Ad) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 2,2-bis(4-hydroxyphenyl)adamantane polythiocarbonate resin (hereinafter, referred to as bis 22Ad oligomer) having a chloroformate group on a molecular terminal and having a degree of polymerization of 2 to 4.

### Synthesis Example 6

### Method of Synthesizing 1,1-bis(3-ethyl-4-hydroxyphenyl)cyclohexane Polythiocarbonate Resin having Chloroformate Group on Molecular Terminal

A solution prepared by dissolving 105 parts by mass of 1,1-bis(3-ethyl-4-hydroxyphenyl)cyclohexane(bisphenol EPZ; bis EPZ) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(3-ethyl-4-hydroxyphenyl)cyclohexane polythiocarbonate resin (hereinafter, referred to as bis EPZ oligomer) having a chloroformate group on a molecular terminal and having a degree of polymerization of 2 to 4.

### Synthesis Example 7

### Method of Synthesizing Terpene Bisphenol Polythiocarbonate Resin having Chloroformate Group on Molecular Terminal

A solution prepared by dissolving 105 parts by mass of a terpene bisphenol mixture synthesized following Synthesis Example 1 of Japanese Patent Application Laid-Open No. H09 (1997)-68817 in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a terpene bisphenol polythiocarbonate resin (hereinafter, referred to as a bis TPP oligomer) having a chloroformate group on a molecular terminal and having a degree of polymerization of 2 to 4.

### Synthesis Example 8

### Method of Synthesizing 1,1-bis(4-hydroxyphenyl)-3,3,5-trimethylcyclohexane Polythiocarbonate Resin having Chloroformate Group on Molecular Terminal

A solution prepared by dissolving 101 parts by mass of 1,1-bis(4-hydroxyphenyl)-3,3,5-trimethylcyclohexane(trimethylcyclohexane bisphenol; bis I) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(4-hydroxyphenyl)-3,3,5-trimethylcyclohexane polythiocarbonate resin (hereinafter, referred to as bis I oligomer) having a chloroformate group on a molecular terminal and having a degree of polymerization of 2 to 4.

### Synthesis Example 9

### Method of Synthesizing 4,4′-[1,3-phenylenebis(1-methylethylidene)]bisphenol Polythiocarbonate Resin having Chloroformate Group on Molecular Terminal

A solution prepared by dissolving 112 parts by mass of 4,4-[1,3-phenylenebis(1-methylethylidene)]bisphenol (BisPM) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 4,4-[1,3-phenylenebis(1-methylethylidene)]bisphenol polythiocarbonate resin (hereinafter, referred to as BisPM oligomer) having a chloroformate group on a molecular terminal and having a degree of polymerization of 2 to 4.

### Synthesis Example 10

### Method of Synthesizing bis(3,5-dibromo-4-hydroxyphenyl)sulfone Polythiocarbonate Resin having Chloroformate Group on Molecular Terminal

A solution prepared by dissolving 177 parts by mass of bis(3,5-dibromo-4-hydroxyphenyl) sulfone (TBS) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a bis(3,5-dibromo-4-hydroxyphenyl)sulfone polythiocarbonate resin (hereinafter, referred to as TBS oligomer) having a chloroformate group on a molecular terminal and having a degree of polymerization of 2 to 4.

### Synthesis Example 11

### Method of Synthesizing 1,1-bis(4-hydroxyphenyl)cyclohexane/9,9-bis(3-methyl-4-hydroxy phenyl)fluorene Copolymer Polythiocarbonate Resin having Chloroformate Group on Molecular Terminal

A solution prepared by dissolving 54 parts by mass of 1,1-bis(4-hydroxyphenyl)cyclohexane (bis Z) and 47 parts by mass of 9,9-bis(3-methyl-4-hydroxyphenyl)fluorene (FLC) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(4-hydroxyphenyl)cyclohexane/9,9-bis(3-methyl-4-hydroxy phenyl) fluorene polythiocarbonate resin (hereinafter, referred to as a Z-FLC oligomer) having a chloroformate group on a molecular terminal and having a degree of polymerization of 2 to 4.

### Synthesis Example 12

### Method of Synthesizing 1,1-bis(4-hydroxyphenyl)cyclohexane/4,4′dihydroxydiphenylether Copolymer Polythiocarbonate Resin having Chloroformate Group on Molecular Terminal

A solution prepared by dissolving 54 parts by mass of 1,1-bis(4-hydroxyphenyl)cyclohexane (bis Z) and 25 parts by mass of 4,4′dihydroxydiphenylether (DHPE) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(4-hydroxyphenyl)cyclohexane/4,4′dihydroxydiphenylether polythiocarbonate resin (hereinafter, referred to as a Z-DHPE oligomer) having a chloroformate group on a molecular terminal and having a degree of polymerization of 2 to 4.

### Synthesis Example 13

### Method of Synthesizing 1,1-bis(4-hydroxyphenyl)cyclohexane/4,4′dihydroxybenzophenone Copolymer Polythiocarbonate Resin having Chloroformate Group on Molecular Terminal

A solution prepared by dissolving 54 parts by mass of 1,1-bis(4-hydroxyphenyl)cyclohexane (bis Z) and 27 parts by mass of 4,4′dihydroxybenzophenone (DHPK) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(4-hydroxyphenyl)cyclohexane/4,4′dihydroxybenzophenone polythiocarbonate resin (hereinafter, referred to as a Z-DHPK oligomer) having a chloroformate group on a molecular terminal and having a degree of polymerization of 2 to 4.

### Synthesis Example 14

### Method of Synthesizing 1,1-bis(4-hydroxyphenyl)cyclohexane/4,4′dihydroxybiphenyl Copolymer Polythiocarbonate Resin having Chloroformate Group on Molecular Terminal

A solution prepared by dissolving 54 parts by mass of 1,1-bis(4-hydroxyphenyl)cyclohexane (bis Z) and 23 parts by mass of 4,4′dihydroxybiphenyl (BP) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(4-hydroxyphenyl)cyclohexane/4,4′dihydroxybiphenyl polythiocarbonate resin (hereinafter, referred to as a Z-BP oligomer) having a chloroformate group on a molecular terminal and having a degree of polymerization of 2 to 4.

### Synthesis Example 15

### Method of Synthesizing 1,1-bis(4-hydroxyphenyl)cyclohexane/2,7-naphthalene Diol Copolymer Polythiocarbonate Resin having Chloroformate Group on Molecular Terminal

A solution prepared by dissolving 54 parts by mass of 1,1-bis(4-hydroxyphenyl)cyclohexane (bis Z) and 16 parts by mass of 2,7-naphthalene diol (27NP) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(4-hydroxyphenyl)cyclohexane/2,7-naphthalene diol polythiocarbonate resin (hereinafter, referred to as a Z-27NP oligomer) having a chloroformate group on a molecular terminal and having a degree of polymerization of 2 to 4.

### Synthesis Example 16

### Method of Synthesizing 1,1-bis (3-methyl-4-hydroxyphenyl)cyclohexane Polythiocarbonate Resin having Chloroformate Group on Molecular Terminal

A solution prepared by dissolving 96 parts by mass of 1,1-bis(3-methyl-4-hydroxyphenyl)cyclohexane (bisphenol CZ; bis CZ) in 607 parts by mass of a 9.4 mass % solution of potassium hydroxide, and 334 parts by mass of methylene chloride were mixed. A phosgene gas was blown into the solution under stirring and cooling at a rate of 4.2 parts by mass/min for 15 min.

Then, this reaction liquid was left standing to separate an organic layer, to thereby obtain a methylene chloride solution of a 1,1-bis(3-methyl-4-hydroxyphenyl)cyclohexane polythiocarbonate resin (hereinafter, referred to as a CZ oligomer) having a chloroformate group on a molecular terminal and having a degree of polymerization of 2 to 4.

### Example 1

Methylene chloride was added to 200 ml of the methylene chloride solution of the bis A oligomer to make a total volume of 450 ml. Then, a diol compound (21.7 g) having the following structure and synthesized by the method described in Example 5 of Japanese Patent Application No. 2003-193486:

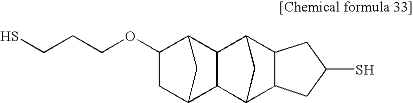

and a 12.2 mass % solution of potassium hydroxide (150 ml) were mixed, and 1.1 g of p-tert-butylphenol as a molecular-weight-modifier was added thereto.

Next, 2 ml of a 7 mass % triethylamine solution as a catalyst was added to this mixed liquid under vigorous stirring for a reaction at 28° C. for 1.5 hours under stirring.

After completion of the reaction, a reaction product was diluted with 1 L of methylene chloride, and washed twice with 1.5 L of water, once with 1 L of 0.01 mol/l of hydrochloric acid, and twice with 1 L of water in the given order. Then, an organic layer was charged into methanol, and a precipitated polymer was filtrated and dried, to thereby obtain a polythiocarbonate resin (PC-1).

The reduced viscosity [ηsp/C] of a 0.5 g/dl solution of the thus-obtained polythiocarbonate resin containing methylene chloride as a solvent was 0.46 dl/g at 20° C.

The reduced viscosity was measured by using an automatic viscometer VMR-042 and an automatic Ubbelohde improved viscometer (RM-type) manufactured by Rigo Co., Ltd.

The structure and copolymer composition of the obtained polythiocarbonate resin (PC-1) were determined as described below through ¹H-NMR spectroscopy.

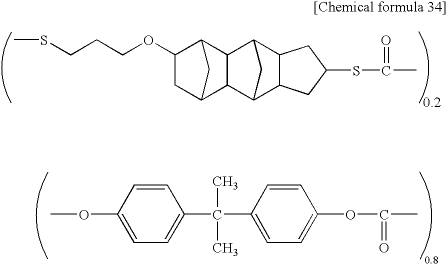

The obtained polythiocarbonate resin was formed into a film having a thickness of 0.2 mm through heat press formation, and the refractive index and Abbe number of the film were measured.

Table 1-1 shows the results.

### Example 2

A polythiocarbonate resin (PC-2) was obtained in the same manner as in Example 1 except that the bis Z oligomer was used instead of the bis A oligomer of Example 1.

The reduced viscosity [ηsp/C] of a 0.5 g/dl solution of the thus-obtained polythiocarbonate resin containing methylene chloride as a solvent was 0.42 dl/g at 20° C.

The structure and copolymer composition of the obtained polythiocarbonate resin (PC-2) were determined as described below through ¹H-NMR spectroscopy.

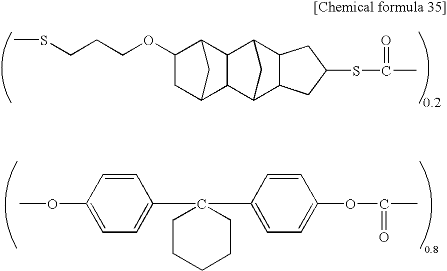

The obtained polythiocarbonate resin was formed into a film having a thickness of 0.2 mm through heat press formation, and the refractive index and Abbe number of the film were measured.

Table 1-1 shows the results.

### Example 3

A polythiocarbonate resin (PC-3) was obtained in the same manner as in Example 1 except that a dithiol compound (17.3 g) having the following structure and synthesized by the method described in Example 6 of Japanese Patent Application No. 2003-193486 was used instead of the dithiol compound of Example 1.

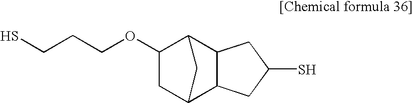

The reduced viscosity [ηsp/C] of a 0.5 g/dl solution of the thus-obtained polythiocarbonate resin containing methylene chloride as a solvent was 0.49 dl/g at 20° C.

The structure and copolymer composition of the obtained polythiocarbonate resin (PC-3) were determined as described below through ¹H-NMR spectroscopy.

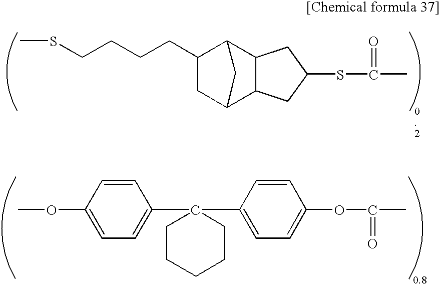

The obtained polythiocarbonate resin was formed into a film having a thickness of 0.2 mm through heat press formation, and the refractive index and Abbe number of the film were measured.

Table 1-1 shows the results.

### Example 4

A polythiocarbonate resin (PC-4) was obtained in the same manner as in Example 1 except that the bis CHA oligomer was used instead of the bis A oligomer of Example 1.

The reduced viscosity [ηsp/C] of a 0.5 g/dl solution of the thus-obtained polythiocarbonate resin containing methylene chloride as a solvent was 0.45 dl/g at 20° C.

The structure and copolymer composition of the obtained polythiocarbonate resin (PC-4) were determined as described below through ¹H-NMR spectroscopy.

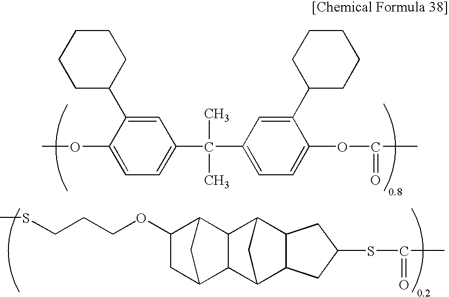

The obtained polythiocarbonate resin was formed into a film having a thickness of 0.2 mm through heat press formation, and the refractive index and Abbe number of the film were measured.

Table 1-1 shows the results.

### Example 5

A polythiocarbonate resin (PC-5) was obtained in the same manner as in Example 1 except that the bis CHZ oligomer was used instead of the bis A oligomer of Example 1.

The reduced viscosity [ηsp/C] of a 0.5 g/dl solution of the thus-obtained polythiocarbonate resin containing methylene chloride as a solvent was 0.47 dl/g at 20° C.

The structure and copolymer composition of the obtained polythiocarbonate resin (PC-5) were determined as described below through ¹H-NMR spectroscopy.

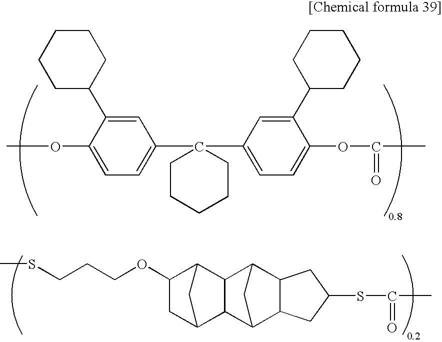

The obtained polythiocarbonate resin was formed into a film having a thickness of 0.2 mm through heat press formation, and the refractive index and Abbe number of the film were measured.

Table 1-1 shows the results.

### Example 6

A polythiocarbonate resin (PC-6) was obtained in the same manner as in Example 1 except that the bis 22Ad oligomer was used instead of the bis A oligomer of Example 1.

The reduced viscosity [ηsp/C] of a 0.5 g/dl solution of the thus-obtained polythiocarbonate resin containing methylene chloride as a solvent was 0.41 dl/g at 20° C.

The structure and copolymer composition of the obtained polythiocarbonate resin (PC-6) were determined as described below through ¹H-NMR spectroscopy.

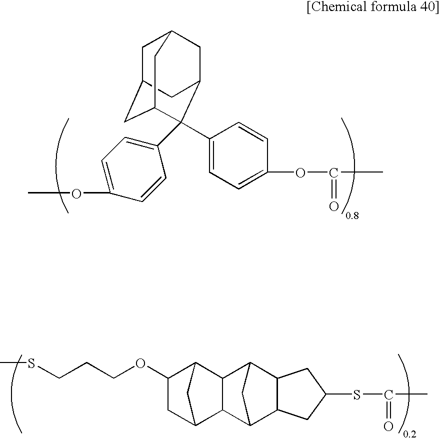

The obtained polythiocarbonate resin was formed into a film having a thickness of 0.2 mm through heat press formation, and the refractive index and Abbe number of the film were measured.

Table 1-1 shows the results.

### Example 7

A polythiocarbonate resin (PC-7) was obtained in the same manner as in Example 1 except that the bis EPZ oligomer was used instead of the bis A oligomer of Example 1.

The reduced viscosity [ηsp/C] of a 0.5 g/dl solution of the thus-obtained polythiocarbonate resin containing methylene chloride as a solvent was 0.44 dl/g at 20° C.

The structure and copolymer composition of the obtained polythiocarbonate resin (PC-7) were determined as described below through ¹H-NMR spectroscopy.

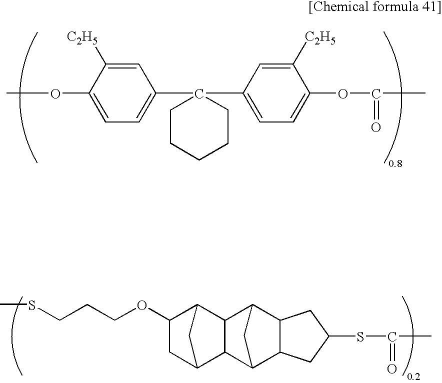

The obtained polythiocarbonate resin was formed into a film having a thickness of 0.2 mm through heat press formation, and the refractive index and Abbe number of the film were measured.

Table 1-1 shows the results.

### Example 8

A polythiocarbonate resin (PC-8) was obtained in the same manner as in Example 1 except that the bis TIP oligomer was used instead of the bis A oligomer of Example 1.

The reduced viscosity [ηsp/C] of a 0.5 g/dl solution of the thus-obtained polythiocarbonate resin containing methylene chloride as a solvent was 0.42 dl/g at 20° C.

The structure and copolymer composition of the obtained polythiocarbonate resin (PC-8) were determined as described below (i.e., a mixture having the following structure) through ¹H-NMR spectroscopy.

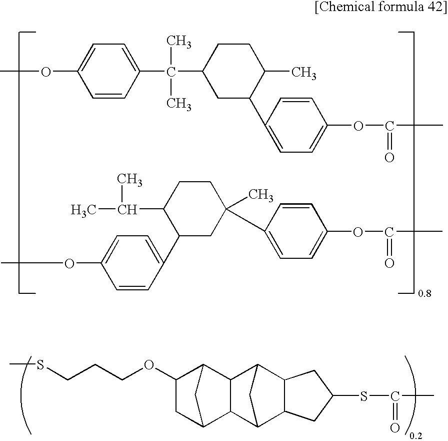

The obtained polythiocarbonate resin was formed into a film having a thickness of 0.2 mm through heat press formation, and the refractive index and Abbe number of the film were measured.

Table 1-1 shows the results.

### Example 9

A polythiocarbonate resin (PC-9) was obtained in the same manner as in Example 1 except that the bis I oligomer was used instead of the bis A oligomer of Example 1.

The reduced viscosity [ηsp/C] of a 0.5 g/dl solution of the thus-obtained polythiocarbonate resin containing methylene chloride as a solvent was 0.47 dl/g at 20° C.

The structure and copolymer composition of the obtained polythiocarbonate resin (PC-9) were determined as described below through ¹H-NMR spectroscopy.

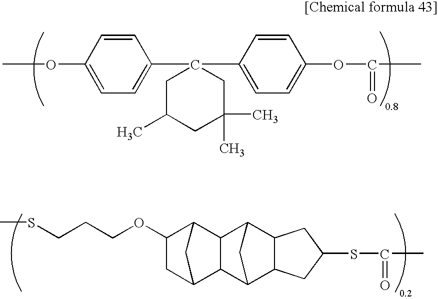

The obtained polythiocarbonate resin was formed into a film having a thickness of 0.2 mm through heat press formation, and the refractive index and Abbe number of the film were measured.

Table 1-1 shows the results.

### Example 10

A polythiocarbonate resin (PC-10) was obtained in the same manner as in Example 1 except that the bis PM oligomer was used instead of the bis A oligomer of Example 1.

The reduced viscosity [ηsp/C] of a 0.5 g/dl solution of the thus-obtained polythiocarbonate resin containing methylene chloride as a solvent was 0.42 dl/g at 20° C.

The structure and copolymer composition of the obtained polythiocarbonate resin (PC-10) were determined as described below through ¹H-NMR spectroscopy.

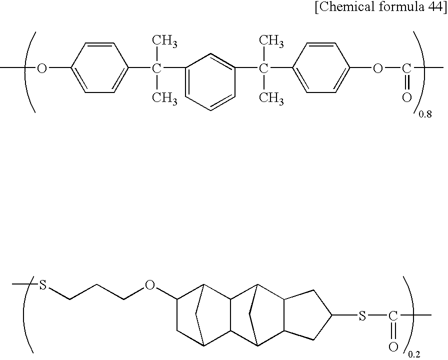

The obtained polythiocarbonate resin was formed into a film having a thickness of 0.2 mm through heat press formation, and the refractive index and Abbe number of the film were measured.

Table 1-1 shows the results.

### Example 11

A polythiocarbonate resin (PC-11) was obtained in the same manner as in Example 1 except that the TBS oligomer was used instead of the bis A oligomer of Example 1.

The reduced viscosity [ηsp/C] of a 0.5 g/dl solution of the thus-obtained polythiocarbonate resin containing methylene chloride as a solvent was 0.41 dl/g at 20° C.

The structure and copolymer composition of the obtained polythiocarbonate resin (PC-11) were determined as described below through ¹H-NMR spectroscopy.

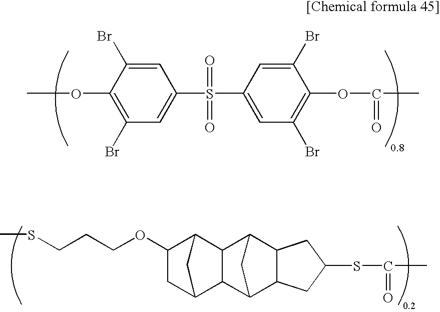

The obtained polythiocarbonate resin was formed into a film having a thickness of 0.2 mm through heat press formation, and the refractive index and Abbe number of the film were measured.

Table 1-1 shows the results.

### Example 12

A polythiocarbonate resin (PC-12) was obtained in the same manner as in Example 1 except that the Z-FLC oligomer was used instead of the bis A oligomer of Example 1.

The reduced viscosity [ηsp/C] of a 0.5 g/dl solution of the thus-obtained polythiocarbonate resin containing methylene chloride as a solvent was 0.45 dl/g at 20° C.

The structure and copolymer composition of the obtained polythiocarbonate resin (PC-12) were determined as described below through ¹H-NMR spectroscopy.

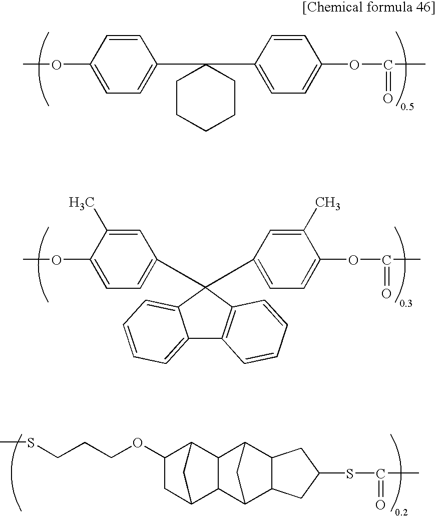

The obtained polythiocarbonate resin was formed into a film having a thickness of 0.2 mm through heat press formation, and the refractive index and Abbe number of the film were measured.

Table 1-1 shows the results.

### Example 13

A polythiocarbonate resin (PC-13) was obtained in the same manner as in Example 1 except that the Z-DHPE oligomer was used instead of the bis A oligomer of Example 1.

The reduced viscosity [ηsp/C] of a 0.5 g/dl solution of the thus-obtained polythiocarbonate resin containing methylene chloride as a solvent was 0.42 dl/g at 20° C.

The structure and copolymer composition of the obtained polythiocarbonate resin (PC-13) were determined as described below through ¹H-NMR spectroscopy.

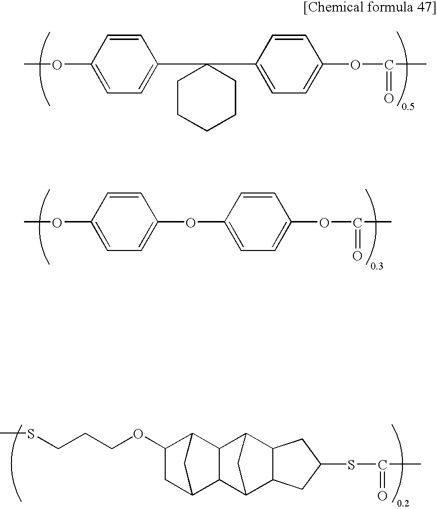

The obtained polythiocarbonate resin was formed into a film having a thickness of 0.2 mm through heat press formation, and the refractive index and Abbe number of the film were measured.

Table 1-1 shows the results.

### Example 14

A polythiocarbonate resin (PC-14) was obtained in the same manner as in Example 1 except that the Z-DHPK oligomer was used instead of the bis A oligomer of Example 1.

The reduced viscosity [ηsp/C] of a 0.5 g/dl solution of the thus-obtained polythiocarbonate resin containing methylene chloride as a solvent was 0.43 dl/g at 20° C.

The structure and copolymer composition of the obtained polythiocarbonate resin (PC-14) were determined as described below through ¹H-NMR spectroscopy.

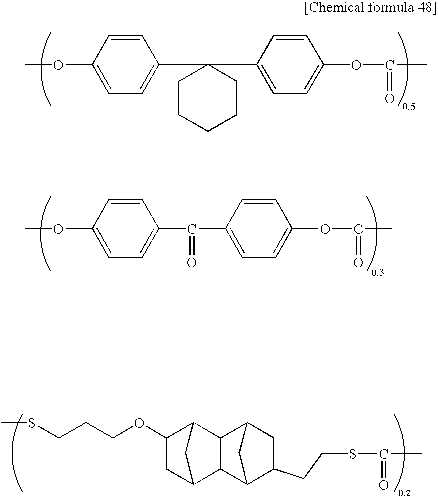

The obtained polythiocarbonate resin was formed into a film having a thickness of 0.2 mm through heat press formation, and the refractive index and Abbe number of the film were measured.

Table 1-1 shows the results.

### Example 15

A polythiocarbonate resin (PC-15) was obtained in the same manner as in Example 1 except that the Z-BP oligomer was used instead of the bis A oligomer of Example 1.

The reduced viscosity [ηsp/C] of a 0.5 g/dl solution of the thus-obtained polythiocarbonate resin containing methylene chloride as a solvent was 0.47 dl/g at 20° C.

The structure and copolymer composition of the obtained polythiocarbonate resin (PC-15) were determined as described below through ¹H-NMR spectroscopy.

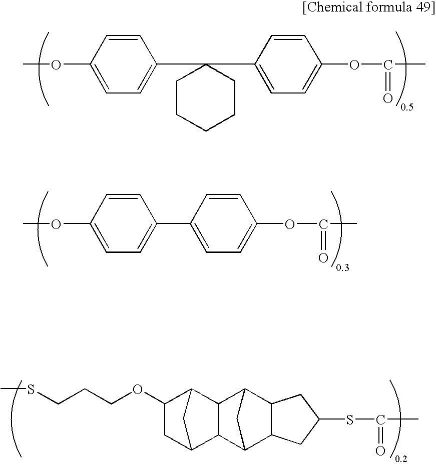

The obtained polythiocarbonate resin was formed into a film having a thickness of 0.2 mm through heat press formation, and the refractive index and Abbe number of the film were measured.

Table 1-1 shows the results.

### Example 16

A polythiocarbonate resin (PC-16) was obtained in the same manner as in Example 1 except that the Z-27NP oligomer was used instead of the bis A oligomer of Example 1.

The reduced viscosity [ηsp/C] of a 0.5 g/dl solution of the thus-obtained polythiocarbonate resin containing methylene chloride as a solvent was 0.45 dl/g at 20° C.

The structure and copolymer composition of the obtained polythiocarbonate resin (PC-16) were determined as described below through ¹H-NMR spectroscopy.

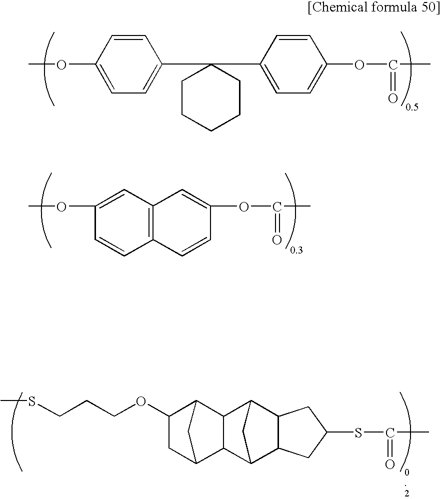

The obtained polythiocarbonate resin was formed into a film having a thickness of 0.2 mm through heat press formation, and the refractive index and Abbe number of the film were measured.

Table 1-1 shows the results.

### Example 17

A polythiocarbonate resin (PC-17) was obtained in the same manner as in Example 1 except that a dithiol compound (17.3 g) having the following structure was used instead of the dithiol compound of Example 1.

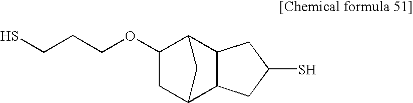

The reduced viscosity [rηsp/C] of a 0.5 g/dl solution of the thus-obtained polythiocarbonate resin containing methylene chloride as a solvent was 0.49 dl/g at 20° C.

The structure and copolymer composition of the obtained polythiocarbonate resin (PC-17) were determined as described below through ¹H-NMR spectroscopy.

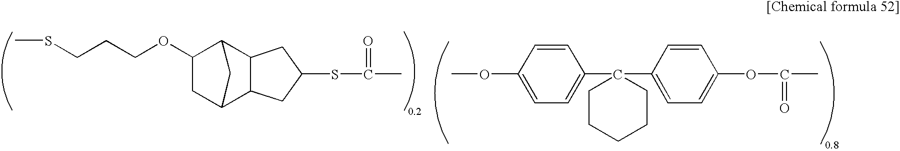

The obtained polythiocarbonate resin was formed into a film having a thickness of 0.2 mm through heat press formation, and the refractive index and Abbe number of the film were measured.

Table 1-1 shows the results.

### Example 18

A polythiocarbonate resin (PC-18) was obtained in the same manner as in Example 1 except that a dithiol compound (17.3 g) was used instead of the dithiol compound of Example 1.

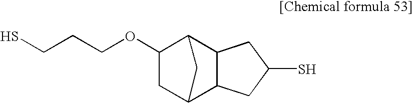

The reduced viscosity [ηsp/C] of a 0.5 g/dl solution of the thus-obtained polythiocarbonate resin containing methylene chloride as a solvent was 0.46 dl/g at 20° C.

The structure and copolymer composition of the obtained polythiocarbonate resin (PC-18) were determined as described below through ¹H-NMR spectroscopy.

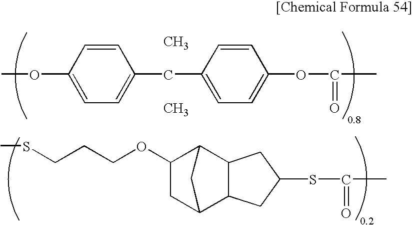

The obtained polythiocarbonate resin was formed into a film having a thickness of 0.2 mm through heat press formation, and the refractive index and Abbe number of the film were measured.

Table 1-1 shows the results.

### Example 19

A polythiocarbonate resin (PC-19) was obtained in the same manner as in Example 1 except that a dithiol compound (17.8 g) having the following structure and synthesized by the method described in Example 7 of Japanese Patent Application No. 2003-193486 was used instead of the dithiol compound of Example 1.

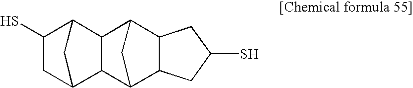

The reduced viscosity [ηsp/C] of a 0.5 g/dl solution of the thus-obtained polythiocarbonate resin containing methylene chloride as a solvent was 0.48 dl/g at 20° C.

The structure and copolymer composition of the obtained polythiocarbonate resin (PC-19) were determined as described below through ¹H-NMR spectroscopy.

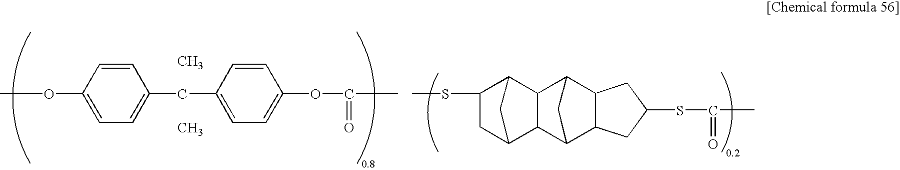

The obtained polythiocarbonate resin was formed into a film having a thickness of 0.2 mm through heat press formation, and the refractive index and Abbe number of the film were measured.

Table 1-1 shows the results.

### Example 20

A polythiocarbonate resin (PC-20) was obtained in the same manner as in Example 1 except that a dithiol compound (13.4 g) having the following structure and synthesized by the method described in Example 12 of Japanese Patent Application No. 2003-193486 was used instead of the dithiol compound of Example 1.

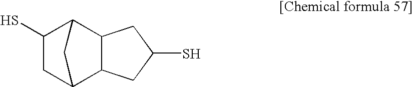

The reduced viscosity [ηsp/C] of a 0.5 g/dl solution of the thus-obtained polythiocarbonate resin containing methylene chloride as a solvent was 0.46 dl/g at 20° C.

The structure and copolymer composition of the obtained polythiocarbonate resin (PC-20) were determined as described below through ¹H-NMR spectroscopy.

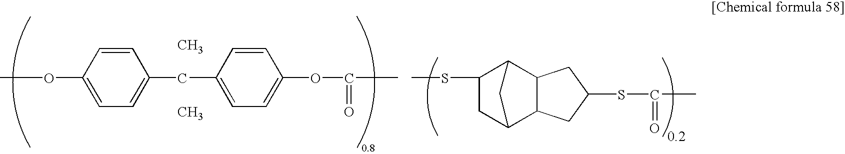

The obtained polythiocarbonate resin was formed into a film having a thickness of 0.2 mm through heat press formation, and the refractive index and Abbe number of the film were measured.

Table 1-1 shows the results.

### Example 21

A polythiocarbonate resin (PC-21) was obtained in the same manner as in Example 1 except that a dithiol compound (26.4 g) having the following structure described in Example 2 of Japanese Patent Application No. 2003-193486 was used instead of the dithiol compound of Example 1.

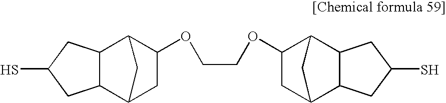

The reduced viscosity [ηsp/C] of a 0.5 g/dl solution of the thus-obtained polythiocarbonate resin containing methylene chloride as a solvent was 0.44 dl/g at 20° C.

The structure and copolymer composition of the obtained polythiocarbonate resin (PC-21) were determined as described below through ¹H-NMR spectroscopy.

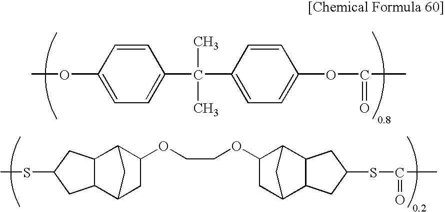

The obtained polythiocarbonate resin was formed into a film having a thickness of 0.2 mm through heat press formation, and the refractive index and Abbe number of the film were measured.

Table 1-1 shows the results.

### Example 22

A polythiocarbonate resin (PC-22) was obtained in the same manner as in Example 1 except that a dithiol compound (23.5 g) having the following structure described in Example 3 of Japanese Patent Application No. 2003-193486 was used instead of the dithiol compound of Example 1.

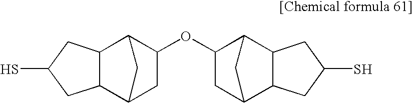

The reduced viscosity [ηsp/C] of a 0.5 g/dl solution of the thus-obtained polythiocarbonate resin containing methylene chloride as a solvent was 0.45 dl/g at 20° C.

The structure and copolymer composition of the obtained polythiocarbonate resin (PC-22) were determined as described below through ¹H-NMR spectroscopy.

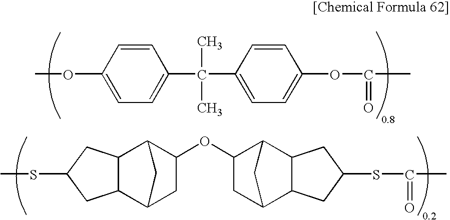

The obtained polythiocarbonate resin was formed into a film having a thickness of 0.2 mm through heat press formation, and the refractive index and Abbe number of the film were measured.

Table 1-1 shows the results.

### Example 23

A polythiocarbonate resin (PC-23) was obtained in the same manner as in Example 1 except that a dithiol compound (21.5 g) having the following structure described in Example 4 of Japanese Patent Application No. 2003-193486 was used instead of the dithiol compound of Example 1.

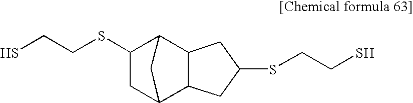

The reduced viscosity [rηsp/C] of a 0.5 g/dl solution of the thus-obtained polythiocarbonate resin containing methylene chloride as a solvent was 0.42 dl/g at 20° C.

The structure and copolymer composition of the obtained polythiocarbonate resin (PC-23) were determined as described below through ¹H-NMR spectroscopy.

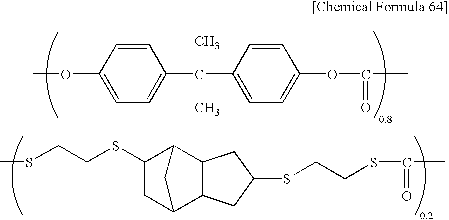

The obtained polythiocarbonate resin was formed into a film having a thickness of 0.2 mm through heat press formation, and the refractive index and Abbe number of the film were measured.

Table 1-1 shows the results.

### Example 24

A polythiocarbonate resin (PC-24) was obtained in the same manner as in Example 1 except that a dithiol compound (20.7 g) having the following structure described in Example 8 of Japanese Patent Application No. 2003-193486 was used instead of the dithiol compound of Example 1.

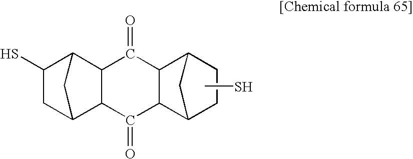

The reduced viscosity [ηsp/C] of a 0.5 g/dl solution of the thus-obtained polythiocarbonate resin containing methylene chloride as a solvent was 0.49 dl/g at 20° C.

The structure and copolymer composition of the obtained polythiocarbonate resin (PC-24) were determined as described below through ¹H-NMR spectroscopy.

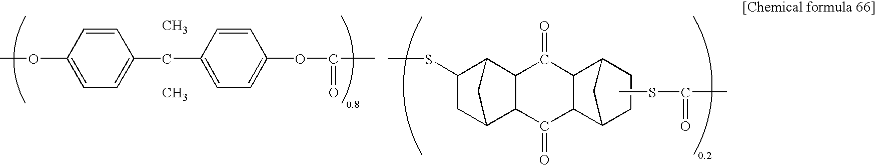

The obtained polythiocarbonate resin was formed into a film having a thickness of 0.2 mm through heat press formation, and the refractive index and Abbe number of the film were measured.

Table 1-1 shows the results.

### Example 25

A polythiocarbonate resin (PC-25) was obtained in the same manner as in Example 1 except that a dithiol compound (28.7 g) having the following structure and synthesized by the method described in Example 9 of Japanese Patent Application No. 2003-193486 was used instead of the dithiol compound of Example 1.

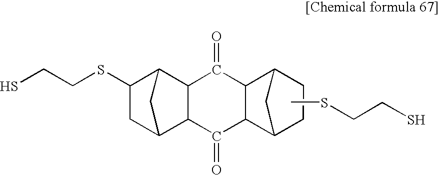

The reduced viscosity [ηsp/C] of a 0.5 g/dl solution of the thus-obtained polythiocarbonate resin containing methylene chloride as a solvent was 0.42 dl/g at 20° C.

The structure and copolymer composition of the obtained polythiocarbonate resin (PC-25) were determined as described below through ¹H-NMR spectroscopy.

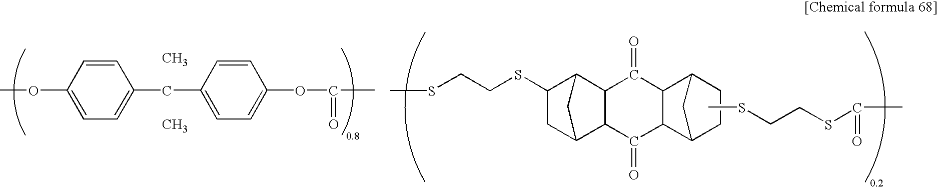

The obtained polythiocarbonate resin was formed into a film having a thickness of 0.2 mm through heat press formation, and the refractive index and Abbe number of the film were measured.

Table 1-1 shows the results.

### Example 26

A polythiocarbonate resin (PC-26) was obtained in the same manner as in Example 1 except that a dithiol compound (31.9 g) having the following structure described in Example 10 of Japanese Patent Application No. 2003-193486 was used instead of the dithiol compound of Example 1.

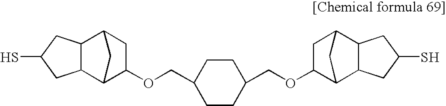

The reduced viscosity [ηsp/C] of a 0.5 g/dl solution of the thus-obtained polythiocarbonate resin containing methylene chloride as a solvent was 0.45 dl/g at 20° C.

The structure and copolymer composition of the obtained polythiocarbonate resin (PC-26) were determined as described below through ¹H-NMR spectroscopy.

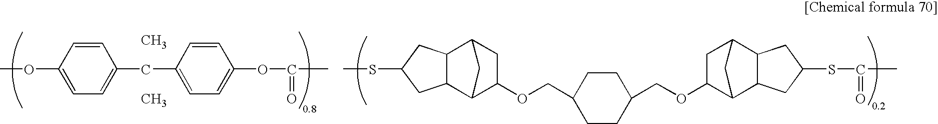

The obtained polythiocarbonate resin was formed into a film having a thickness of 0.2 mm through heat press formation, and the refractive index and Abbe number of the film were measured.

Table 1-2 shows the results.

### Example 27

A polythiocarbonate resin (PC-27) was obtained in the same manner as in Example 1 except that a dithiol compound (32.0 g) having the following structure and synthesized by the method described in Example 11 of Japanese Patent Application No. 2003-193486 was used instead of the dithiol compound of Example 1.

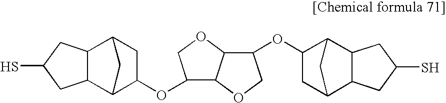

The reduced viscosity [ηsp/C] of a 0.5 g/dl solution of the thus-obtained polythiocarbonate resin containing methylene chloride as a solvent was 0.48 dl/g at 20° C.

The structure and copolymer composition of the obtained polythiocarbonate resin (PC-27) were determined as described below through ¹H-NMR spectroscopy.

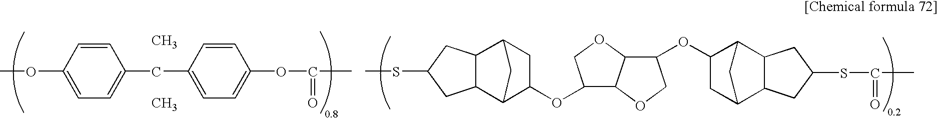

The obtained polythiocarbonate resin was formed into a film having a thickness of 0.2 mm through heat press formation, and the refractive index and Abbe number of the film were measured.

Table 1-2 shows the results.

### Example 28

A polythiocarbonate resin (PC-28) was obtained in the same manner as in Example 1 except that a dithiol compound (40.8 g) having the following structure and synthesized by the method described in Example 1 of Japanese Patent Application No. 2004-119379 (i.e., an isomeric mixture having a different binding position of asymmetric dithiol compound) was used instead of the dithiol compound of Example 1.

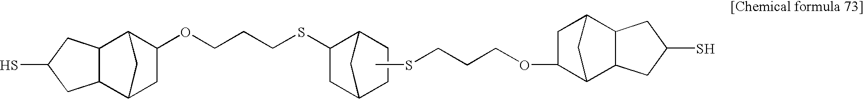

The reduced viscosity [ηsp/C] of a 0.5 g/dl solution of the thus-obtained polythiocarbonate resin containing methylene chloride as a solvent was 0.42 dl/g at 20° C.

The structure and copolymer composition of the obtained polythiocarbonate resin (PC-28) were determined as described below through ¹H-NMR spectroscopy.

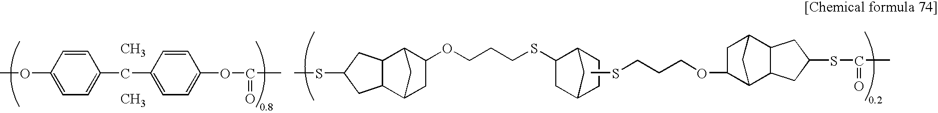

The obtained polythiocarbonate resin was formed into a film having a thickness of 0.2 mm through heat press formation, and the refractive index and Abbe number of the film were measured.

Table 1-2 shows the results.

### Example 29

A polythiocarbonate resin (PC-29) was obtained in the same manner as in Example 1 except that a dithiol (41.4 g) having the following structure and synthesized by the method described in Example 2 of Japanese Patent Application No. 2004-119379 was used instead of the dithiol compound of Example 1.

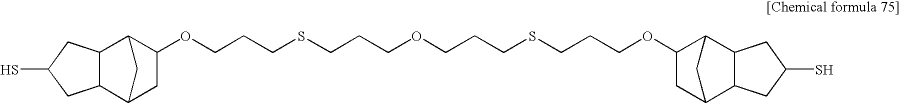

The reduced viscosity [ηsp/C] of a 0.5 g/dl solution of the thus-obtained polythiocarbonate resin containing methylene chloride as a solvent was 0.40 dl/g at 20° C.

The structure and copolymer composition of the obtained polythiocarbonate resin (PC-29) were determined as described below through ¹H-NMR spectroscopy.

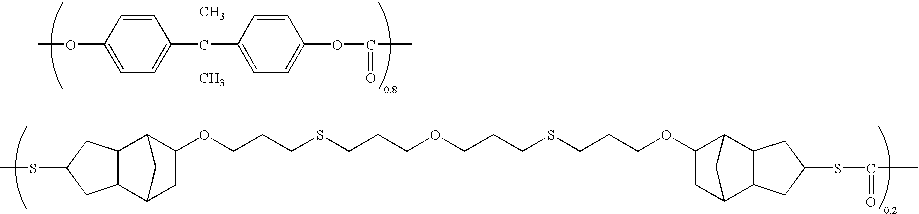

The obtained polythiocarbonate resin was formed into a film having a thickness of 0.2 mm through heat press formation, and the refractive index and Abbe number of the film were measured.

Table 1-2 shows the results.

### Example 30

A polythiocarbonate resin (PC-30) was obtained in the same manner as in Example 1 except that a dithiol compound (42.6 g) having the following structure described in Example 3 of Japanese Patent Application No. 2004-119379 was used instead of the dithiol compound of Example 1.

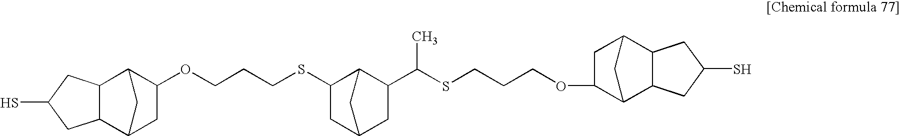

The reduced viscosity [ηsp/C] of a 0.5 g/dl solution of the thus-obtained polythiocarbonate resin containing methylene chloride as a solvent was 0.43 dl/g at 20° C.

The structure and copolymer composition of the obtained polythiocarbonate resin (PC-30) were determined as described below through ¹H-NMR spectroscopy.

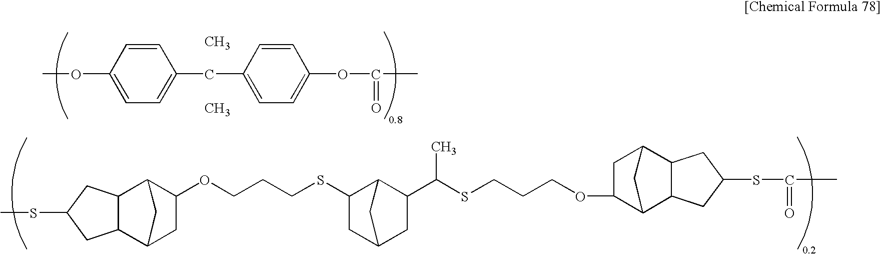

The obtained polythiocarbonate resin was formed into a film having a thickness of 0.2 mm through heat press formation, and the refractive index and Abbe number of the film were measured.

Table 1-2 shows the results.

### Example 31

A polythiocarbonate resin (PC-31) was obtained in the same manner as in Example 1 except that a dithiol compound (46.0 g) having the following structure described in Example 5 of Japanese Patent Application No. 2004-119379 was used instead of the dithiol compound of Example 1.

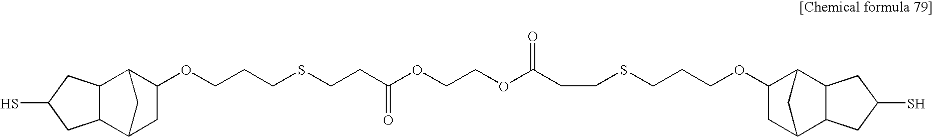

The reduced viscosity [ηsp/C] of a 0.5 g/dl solution of the thus-obtained polythiocarbonate resin containing methylene chloride as a solvent was 0.41 dl/g at 20° C.

The structure and copolymer composition of the obtained polythiocarbonate resin (PC-31) was determined as described below through ¹R-NMR spectroscopy.

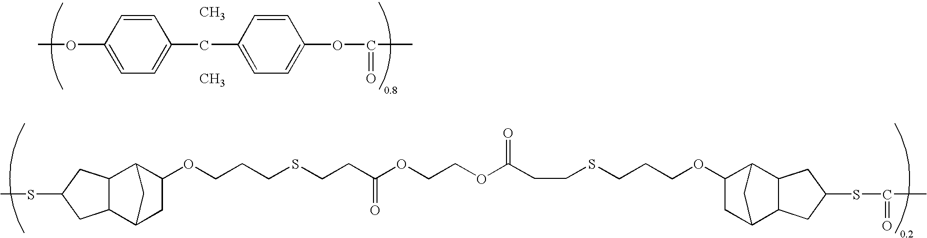

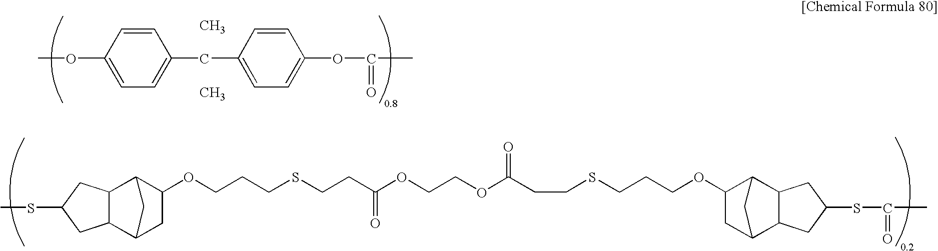

The obtained polythiocarbonate resin was formed into a film having a thickness of 0.2 mm through heat press formation, and the refractive index and Abbe number of the film were measured.

Table 1-2 shows the results.

### Example 32

A polythiocarbonate resin (PC-32) was obtained in the same manner as in Example 1 except that a dithiol compound (49.8 g) having the following structure described in Example 6 of Japanese Patent Application No. 2004-119379 was used instead of the dithiol compound of Example 1.

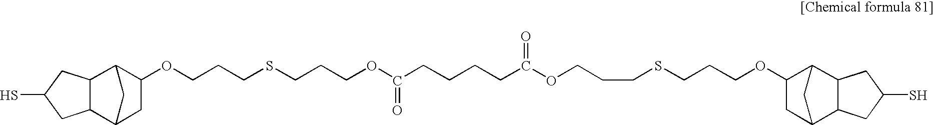

The reduced viscosity [ηsp/C] of a 0.5 g/dl solution of the thus-obtained polythiocarbonate resin containing methylene chloride as a solvent was 0.40 dl/g at 20° C.

The structure and copolymer composition of the obtained polythiocarbonate resin (PC-32) were determined as described below through ¹H-NMR spectroscopy.

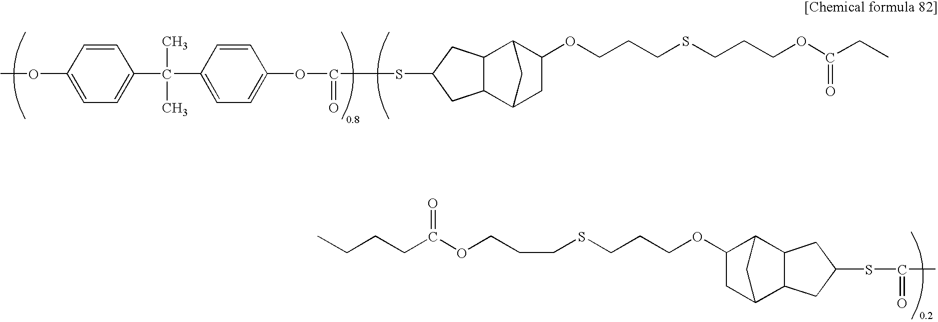

The obtained polythiocarbonate resin was formed into a film having a thickness of 0.2 mm through heat press formation, and the refractive index and Abbe number of the film were measured.

Table 1-2 shows the results.

### Example 33

A polythiocarbonate resin (PC-33) was obtained in the same manner as in Example 1 except that a dithiol compound (65.8 g) having the following structure described in Example 7 of Japanese Patent Application No. 2004-119379 was used instead of the dithiol compound of Example 1.

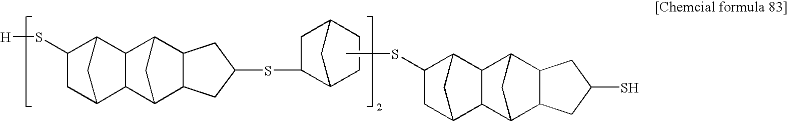

The reduced viscosity [ηsp/C] of a 0.5 g/dl solution of the thus-obtained polythiocarbonate resin containing methylene chloride as a solvent was 0.41 dl/g at 20° C.

The structure and copolymer composition of the obtained polythiocarbonate resin (PC-33) were determined as described below through ¹H-NMR spectroscopy.

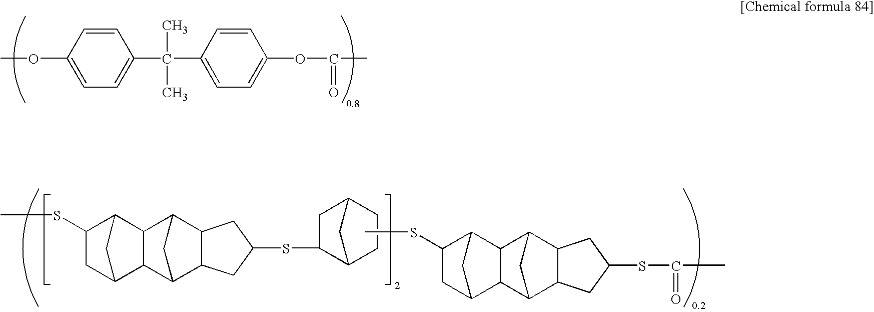

The obtained polythiocarbonate resin was formed into a film having a thickness of 0.2 mm through heat press formation, and the refractive index and Abbe number of the film were measured.

Table 1-2 shows the results.

### Example 34

A polythiocarbonate resin (PC-34) was obtained in the same manner as in Example 1 except that a dithiol compound (66.6 g) having the following structure described in Example 9 of Japanese Patent Application No. 2004-119379 was used instead of the dithiol compound of Example 1.

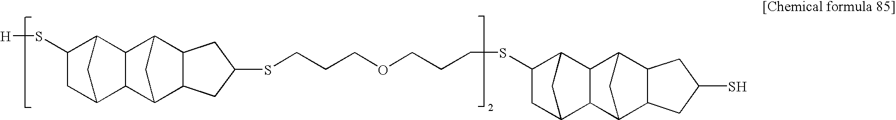

The reduced viscosity [ηsp/C] of a 0.5 g/dl solution of the thus-obtained polythiocarbonate resin containing methylene chloride as a solvent was 0.40 dl/g at 20° C.

The structure and copolymer composition of the obtained polythiocarbonate resin (PC-34) were determined as described below through ¹H-NMR spectroscopy.

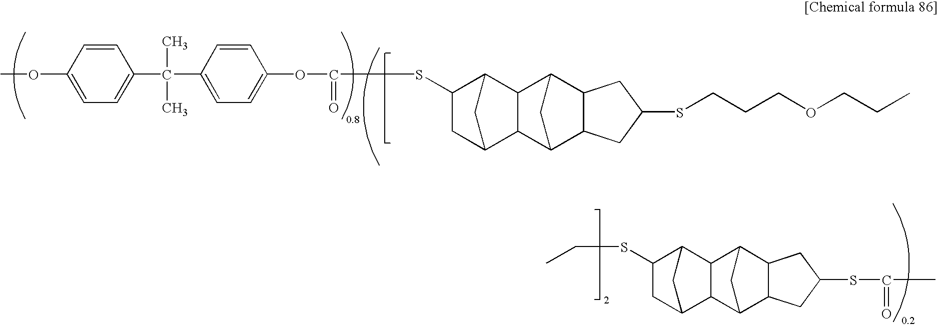

The obtained polythiocarbonate resin was formed into a film having a thickness of 0.2 mm through heat press formation, and the refractive index and Abbe number of the film were measured.

Table 1-2 shows the results.

### Example 35

A polythiocarbonate resin (PC-35) was obtained in the same manner as in Example 1 except that a dithiol compound (83.8 g) having the following structure described in Example 10 of Japanese Patent Application No. 2004-119379 was used instead of the dithiol compound of Example 1.

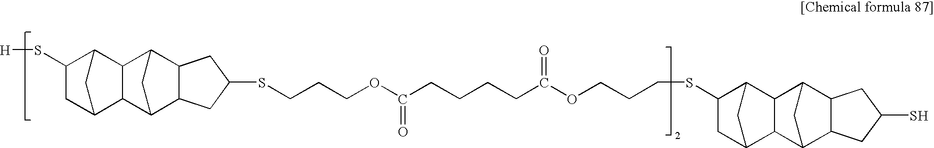

The reduced viscosity [ηsp/C] of a 0.5 g/dl solution of the thus-obtained polythiocarbonate resin containing methylene chloride as a solvent was 0.41 dl/g at 20° C.

The structure and copolymer composition of the obtained polythiocarbonate resin (PC-35) were determined as described below through ¹H-NMR spectroscopy.

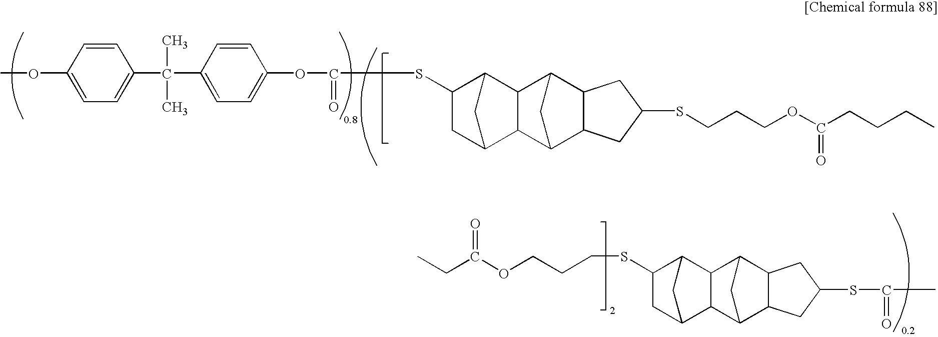

The obtained polythiocarbonate resin was formed into a film having a thickness of 0.2 mm through heat press formation, and the refractive index and Abbe number of the film were measured.

Table 1-2 shows the results.

### Example 36

A polythiocarbonate resin (PC-36) was obtained in the same manner as in Example 1 except that a dithiol compound (89.4 g) having the following structure and synthesized by the method described in Example 22 of Japanese Patent Application No. 2004-119379 was used instead of the dithiol compound of Example 1.

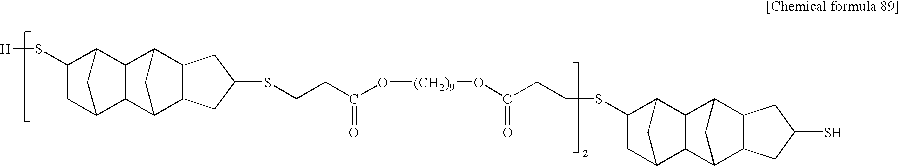

The reduced viscosity [ηsp/C] of a 0.5 g/dl solution of the thus-obtained polythiocarbonate resin containing methylene chloride as a solvent was 0.39 dl/g at 20° C.

The structure and copolymer composition of the obtained polythiocarbonate resin (PC-36) were determined as described below through ¹H-NMR spectroscopy.

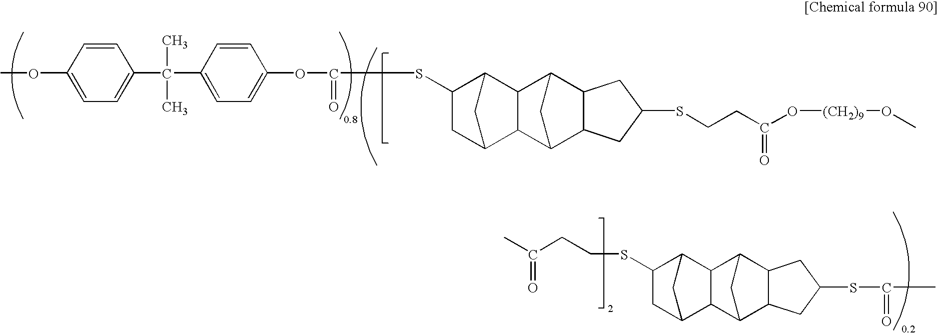

The obtained polythiocarbonate resin was formed into a film having a thickness of 0.2 mm through heat press formation, and the refractive index and Abbe number of the film were measured.

Table 1-2 shows the results.

### Example 37

A polythiocarbonate resin (PC-37) was obtained in the same manner as in Example 1 except that a dithiol compound (93.7 g) having the following structure described in Example 23 of Japanese Patent Application No. 2004-119379 was used instead of the dithiol compound of Example 1.

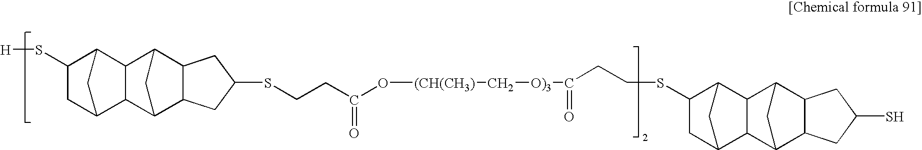

The reduced viscosity [ηsp/C] of a 0.5 g/dl solution of the thus-obtained polythiocarbonate resin containing methylene chloride as a solvent was 0.39 dl/g at 20° C.

The structure and copolymer composition of the obtained polythiocarbonate resin (PC-37) was determined as described below through ¹H-NMR spectroscopy.

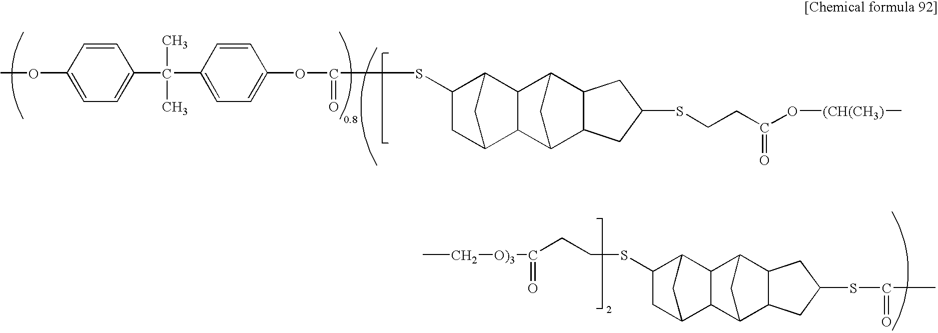

The obtained polythiocarbonate resin was formed into a film having a thickness of 0.2 mm through heat press formation, and the refractive index and Abbe number of the film were measured.

Table 1-2 shows the results.

### Example 38

A polythiocarbonate resin (PC-38) was obtained in the same manner as in Example 1 except that a dithiol compound (94.0 g) having the following structure described in Example 24 of Japanese Patent Application No. 2004-119379 was used instead of the dithiol compound of Example 1.

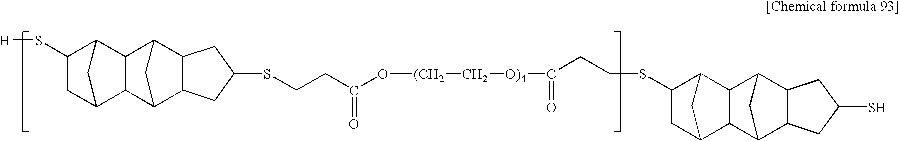

The reduced viscosity [ηsp/C] of a 0.5 g/dl solution of the thus-obtained polythiocarbonate resin containing methylene chloride as a solvent was 0.39 dl/g at 20° C.

The structure and copolymer composition of the obtained polythiocarbonate resin (PC-38) were determined as described below through ¹H-NMR spectroscopy.

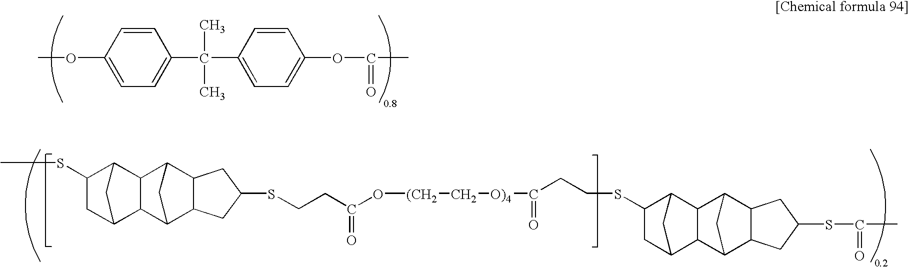

The obtained polythiocarbonate resin was formed into a film having a thickness of 0.2 mm through heat press formation, and the refractive index and Abbe number of the film were measured.

Table 1-2 shows the results.

### Example 39

A polythiocarbonate resin (PC-39) was obtained in the same manner as in Example 1 except that a dithiol compound (56.1 g) having the following structure described in Example 29 of Japanese Patent Application No. 2004-119379 was used instead of the dithiol compound of Example 1.

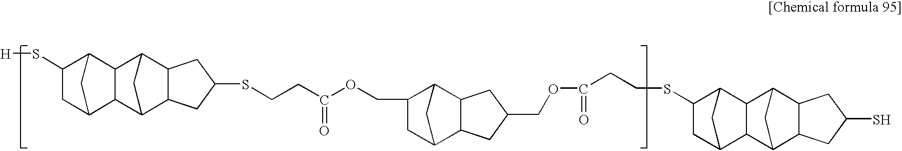

The reduced viscosity [ηsp/C] of a 0.5 g/dl solution of the thus-obtained polythiocarbonate resin containing methylene chloride as a solvent was 0.44 dl/g at 20° C.

The structure and copolymer composition of the obtained polythiocarbonate resin (PC-39) was determined as described below through ¹H-NMR spectroscopy.

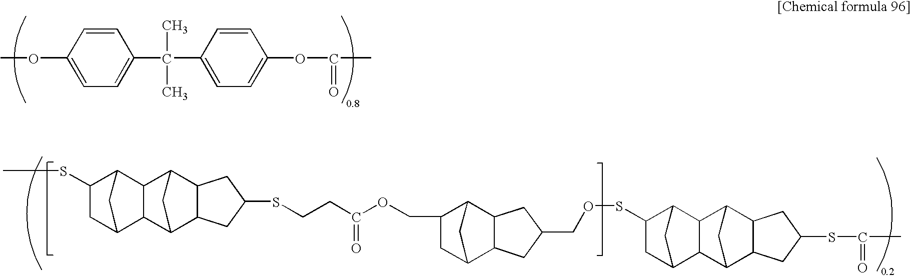

The obtained polythiocarbonate resin was formed into a film having a thickness of 0.2 mm through heat press formation, and the refractive index and Abbe number of the film were measured.

Table 1-2 shows the results.

### Example 40

A polythiocarbonate resin (PC-40) was obtained in the same manner as in Example 1 except that a dithiol compound (94.3 g) having the following structure described in Example 30 of Japanese Patent Application No. 2004-119379 was used instead of the dithiol compound of Example 1.

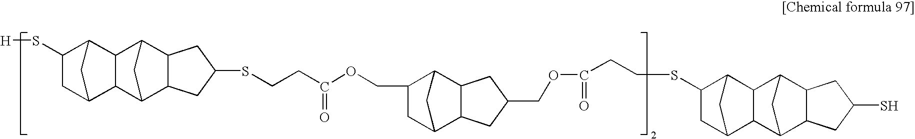

The reduced viscosity [ηsp/C] of a 0.5 g/dl solution of the thus-obtained polythiocarbonate resin containing methylene chloride as a solvent was 0.44 dl/g at 20° C.

The structure and copolymer composition of the obtained polythiocarbonate resin (PC-40) was determined as described below through ¹H-NMR spectroscopy.

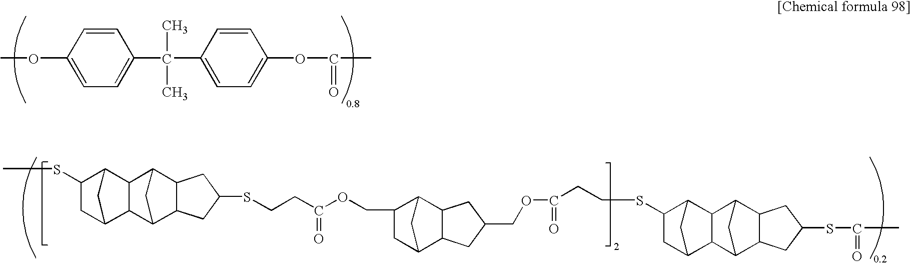

The obtained polythiocarbonate resin was formed into a film having a thickness of 0.2 mm through heat press formation, and the refractive index and Abbe number of the film were measured.

Table 1-2 shows the results.

### Example 41

A polythiocarbonate resin (PC-41) was obtained in the same manner as in Example 1 except that a dithiol compound (76.3 g) having the following structure described in Example 8 of Japanese Patent Application No. 2004-119379 was used instead of the dithiol compound of Example 1.

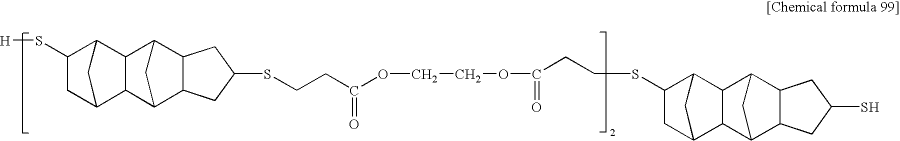

The reduced viscosity [ηsp/C] of a 0.5 g/dl solution of the thus-obtained polythiocarbonate resin containing methylene chloride as a solvent was 0.47 dl/g at 20° C.

The structure and copolymer composition of the obtained polythiocarbonate resin (PC-41) were determined as described below through ¹H-NMR spectroscopy.

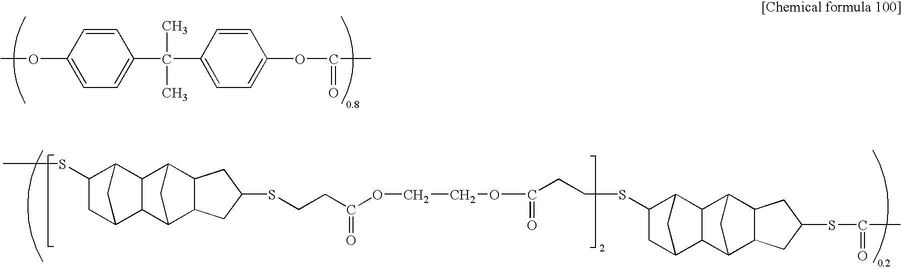

The obtained polythiocarbonate resin was formed into a film having a thickness of 0.2 mm through heat press formation, and the refractive index and Abbe number of the film were measured.

Table 1-2 shows the results.

### Example 42

A polythiocarbonate resin (PC-42) was obtained in the same manner as in Example 1 except that a dithiol compound (48.9 g) having the following structure described in Example 32 of Japanese Patent Application No. 2004-119379 was used instead of the dithiol compound of Example 1.

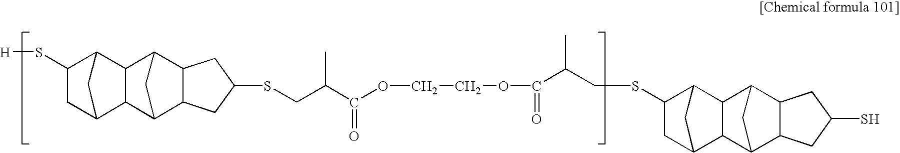

The reduced viscosity [ηsp/C] of a 0.5 g/dl solution of the thus-obtained polythiocarbonate resin containing methylene chloride as a solvent was 0.49 dl/g at 20° C.

The structure and copolymer composition of the obtained polythiocarbonate resin (PC-42) were determined as described below through ¹H-NMR spectroscopy.

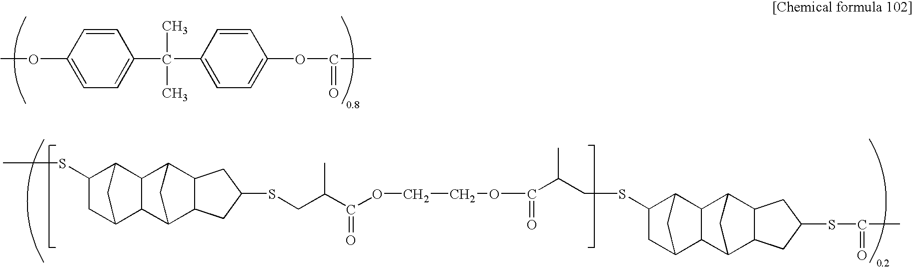

The obtained polythiocarbonate resin was formed into a film having a thickness of 0.2 mm through heat press formation, and the refractive index and Abbe number of the film were measured.

Table 1-2 shows the results.

### Example 43

A polythiocarbonate resin (PC-43) was obtained in the same manner as in Example 1 except that a dithiol compound (64.6 g) having the following structure described in Example 34 of Japanese Patent Application No. 2004-119379 was used instead of the dithiol compound of Example 1.

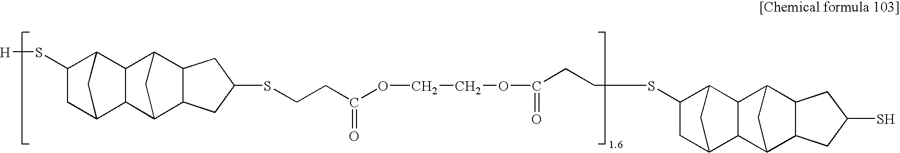

The reduced viscosity [ηsp/C] of a 0.5 g/dl solution of the thus-obtained polythiocarbonate resin containing methylene chloride as a solvent was 0.46 dl/g at 20° C.

The structure and copolymer composition of the obtained polythiocarbonate resin (PC-43) were determined as described below through ¹H-NMR spectroscopy.

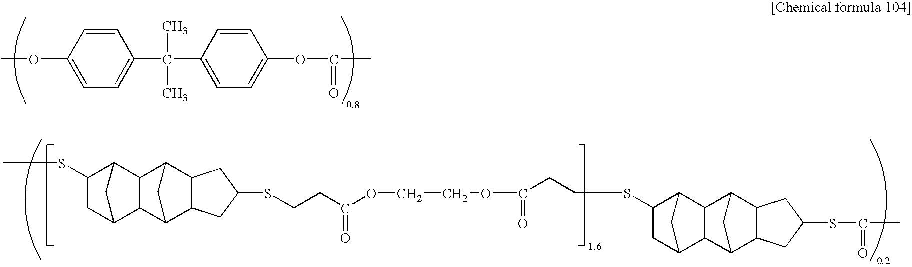

The obtained polythiocarbonate resin was formed into a film having a thickness of 0.2 mm through heat press formation, and the refractive index and Abbe number of the film were measured.

Table 1-2 shows the results.

### Example 44

A polythiocarbonate resin (PC-44) was obtained in the same manner as in Example 1 except that a dithiol compound (59.5 g) having the following structure described in Example 39 of Japanese Patent Application No. 2004-119379 was used instead of the dithiol compound of Example 1.

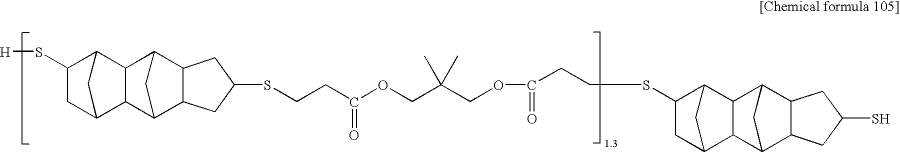

The reduced viscosity [ηsp/C] of a 0.5 g/dl solution of the thus-obtained polythiocarbonate resin containing methylene chloride as a solvent was 0.49 dl/g at 20° C.

The structure and copolymer composition of the obtained polythiocarbonate resin (PC-44) were determined as described below through ¹H-NMR spectroscopy.

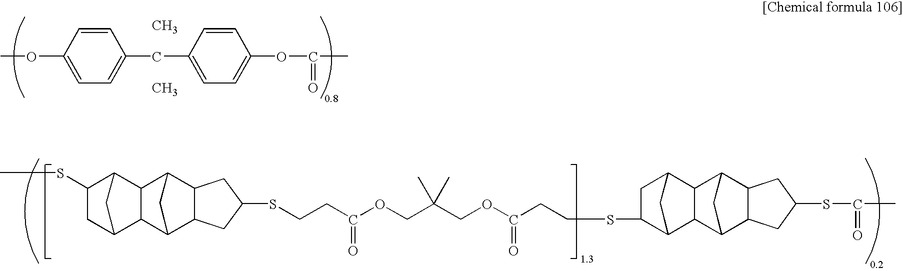

The obtained polythiocarbonate resin was formed into a film having a thickness of 0.2 mm through heat press formation, and the refractive index and Abbe number of the film were measured.

Table 1-2 shows the results.

### Example 45

A polythiocarbonate resin (PC-45) was obtained in the same manner as in Example 1 except that a dithiol compound (43.2 g) having the following structure described in Example 48 of Japanese Patent Application No. 2004-119379 was used instead of the dithiol compound of Example 1.

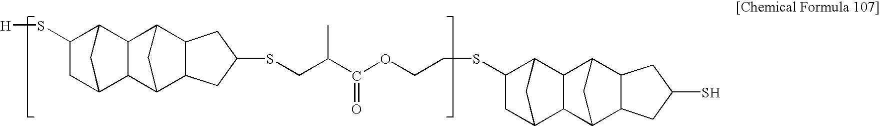

The reduced viscosity [ηsp/C] of a 0.5 g/dl solution of the thus-obtained polythiocarbonate resin containing methylene chloride as a solvent was 0.49 dl/g at 20° C.

The structure and copolymer composition of the obtained polythiocarbonate resin (PC-45) were determined as described below through ¹H-NMR spectroscopy.

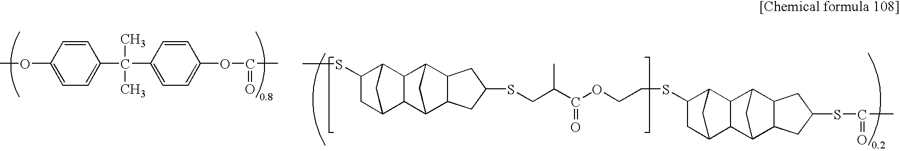

The obtained polythiocarbonate resin was formed into a film having a thickness of 0.2 mm through heat press formation, and the refractive index and Abbe number of the film were measured.

Table 1-2 shows the results.

### Example 46

A polythiocarbonate resin (PC-46) was obtained in the same manner as in Example 39 except that the bis Z oligomer was used instead of the bis A oligomer of Example 39.

The reduced viscosity [ηsp/C] of a 0.5 g/dl solution of the thus-obtained polythiocarbonate resin containing methylene chloride as a solvent was 0.52 dl/g at 20° C.

The structure and copolymer composition of the obtained polythiocarbonate resin (PC-46) were determined as described below through ¹H-NMR spectroscopy.

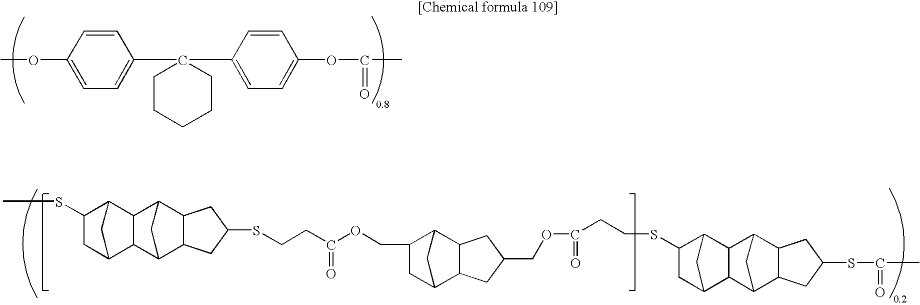

The obtained polythiocarbonate resin was formed into a film having a thickness of 0.2 mm through heat press formation, and the refractive index and Abbe number of the film were measured.

Table 1-2 shows the results.

### Example 47

A polythiocarbonate resin (PC-47) was obtained in the same manner as in Example 39 except that the bis CZ oligomer was used instead of the bis A oligomer of Example 39.

The reduced viscosity [ηsp/C] of a 0.5 g/dl solution of the thus-obtained polythiocarbonate resin containing methylene chloride as a solvent was 0.49 dl/g at 20° C.

The structure and copolymer composition of the obtained polythiocarbonate resin (PC-47) were determined as described below through ¹H-NMR spectroscopy.

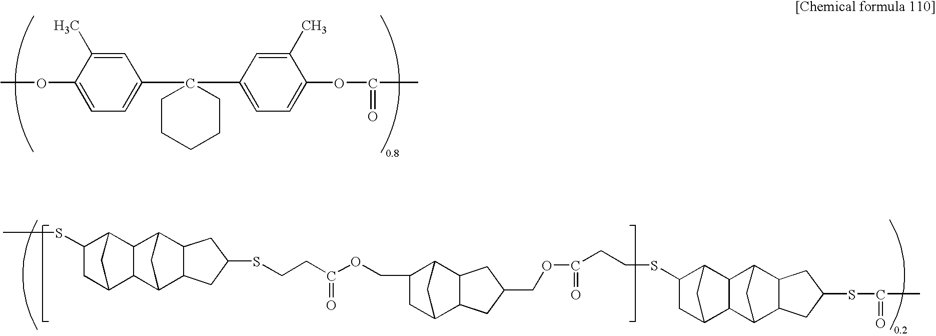

The obtained polythiocarbonate resin was formed into a film having a thickness of 0.2 mm through heat press formation, and the refractive index and Abbe number of the film were measured.

Table 1-2 shows the results.

### Example 48

A polythiocarbonate resin (PC-48) was obtained in the same manner as in Example 1 except that a dithiol compound (47.2 g) having the following structure described in Example 27 of Japanese Patent Application No. 2004-119379 was used instead of the dithiol compound of Example 1.

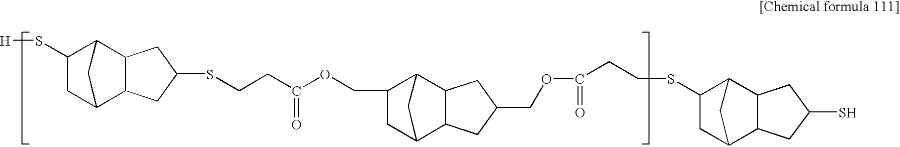

The reduced viscosity [ηsp/C] of a 0.5 g/dl solution of the thus-obtained polythiocarbonate resin containing methylene chloride as a solvent was 0.46 dl/g at 20° C.

The structure and copolymer composition of the obtained polythiocarbonate resin (PC-48) were determined as described below through ¹H-NMR spectroscopy.

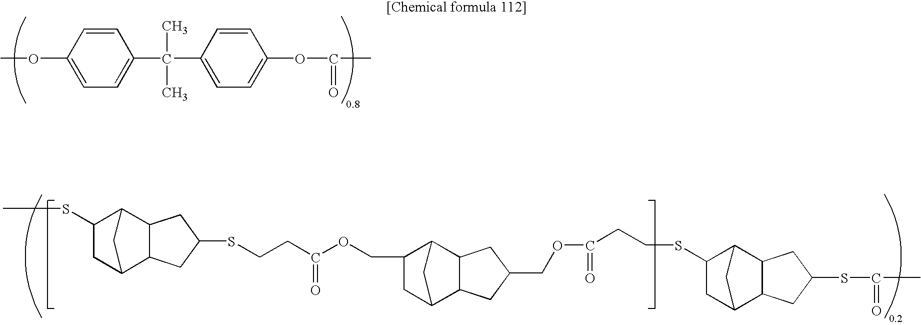

The obtained polythiocarbonate resin was formed into a film having a thickness of 0.2 mm through heat press formation, and the refractive index and Abbe number of the film were measured.

Table 1-2 shows the results.

### Comparative Example 1

A commercially available bisphenol A polycarbonate resin (Tarflon A1900, trade name, available from Idemitsu Petrochemical Co., Ltd.) was used as a reference.

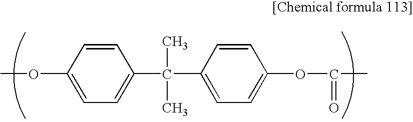

The reduced viscosity (ηsp/C) of the resin was measured and was 0.47 dl/g.

Table 1-2 shows the results of measurement of the refractive index and Abbe number of the polymer and the results of evaluation on appearance and heat resistance of the polymer.

[Table 1]

TABLE 1-1

| | | | Heat | Heat |
|---|---|---|---|---|
| | Refractive | Abbe number | resistance | resistance |
| Example | index (nₚ) | (νₚ) | (i) | (ii) |
| PC-1 | 1.59 | 32.3 | ∘ | ∘ |
| PC-2 | 1.59 | 33.9 | ∘ | ∘ |
| PC-3 | 1.59 | 32.9 | ∘ | ∘ |
| PC-4 | 1.57 | 36.5 | ∘ | ∘ |
| PC-5 | 1.57 | 36.9 | ∘ | ∘ |
| PC-6 | 1.59 | 34.0 | ∘ | ∘ |
| PC-7 | 1.58 | 35.0 | Δ | ∘ |
| PC-8 | 1.56 | 35.6 | ∘ | ∘ |
| PC-9 | 1.59 | 34.0 | ∘ | ∘ |
| PC-10 | 1.59 | 32.5 | Δ | ∘ |
| PC-11 | 1.62 | 29.0 | ∘ | ∘ |
| PC-12 | 1.61 | 31.2 | ∘ | ∘ |
| PC-13 | 1.59 | 31.5 | ∘ | ∘ |
| PC-14 | 1.59 | 32.0 | ∘ | ∘ |
| PC-15 | 1.61 | 32.0 | ∘ | ∘ |
| PC-16 | 1.61 | 32.0 | ∘ | ∘ |
| PC-17 | 1.59 | 31.6 | ∘ | ∘ |
| PC-18 | 1.59 | 31.0 | ∘ | ∘ |
| PC-19 | 1.59 | 32.2 | ∘ | ∘ |
| PC-20 | 1.59 | 31.4 | ∘ | ∘ |
| PC-21 | 1.58 | 33.2 | ∘ | ∘ |
| PC-22 | 1.58 | 33.0 | ∘ | ∘ |
| PC-23 | 1.58 | 32.0 | ∘ | ∘ |
| PC-24 | 1.59 | 31.0 | ∘ | ∘ |
| PC-25 | 1.58 | 33.0 | ∘ | ∘ |

[Table 2]

TABLE 1-2

| | | | Heat | Heat |
|---|---|---|---|---|
| | Refractive | Abbe number | resistance | resistance |
| Example | index (nₚ) | (νₚ) | (i) | (ii) |
| PC-26 | 1.58 | 34.0 | ∘ | ∘ |
| PC-27 | 1.58 | 33.8 | ∘ | ∘ |
| PC-28 | 1.58 | 34.5 | ∘ | ∘ |
| PC-29 | 1.59 | 33.5 | ∘ | ∘ |
| PC-30 | 1.58 | 34.0 | ∘ | ∘ |
| PC-31 | 1.58 | 34.0 | ∘ | ∘ |
| PC-32 | 1.58 | 34.3 | ∘ | ∘ |
| PC-33 | 1.59 | 35.0 | ∘ | ∘ |
| PC-34 | 1.58 | 34.5 | ∘ | ∘ |
| PC-35 | 1.58 | 36.0 | x | ∘ |
| PC-36 | 1.58 | 37.5 | x | ∘ |
| PC-37 | 1.58 | 37.4 | x | ∘ |
| PC-38 | 1.57 | 37.0 | x | ∘ |
| PC-39 | 1.58 | 36.0 | ∘ | ∘ |
| PC-40 | 1.58 | 37.5 | ∘ | ∘ |
| PC-41 | 1.58 | 37.0 | x | ∘ |
| PC-42 | 1.58 | 35.0 | ∘ | ∘ |
| PC-43 | 1.58 | 36.0 | Δ | ∘ |
| PC-44 | 1.58 | 35.2 | Δ | ∘ |
| PC-45 | 1.58 | 34.0 | ∘ | ∘ |
| PC-46 | 1.59 | 36.3 | ∘ | ∘ |
| PC-47 | 1.59 | 37.0 | ∘ | ∘ |
| PC-48 | 1.58 | 34.0 | ∘ | ∘ |
| Comp. Ex. | 1.58 | 30.4 | ∘ | ∘ |
| (PCA) | | | | |

### Example 49

A mixture containing 4.47 g (17.3 mmol) of mercaptopropoxy-mercapto-octahydro-methano-indene (isomeric mixture) and 0.80 g (8.64 mmol) of a norbornadiene compound was stirred at 70° C. for 5 hours, to thereby obtain a colorless transparent viscous liquid.

The obtained viscous liquid had a refractive index (n_{D}) of 1.56 and an Abbe number (ν_{D}) of 51.

### Example 50

A mixture containing 4.47 g (17.3 mmol) of mercaptopropoxy-mercapto-octahydro-methano-indene (isomeric mixture) and 0.85 g (8.64 mmol) of diallyl ether stirred at 70° C. for 5 hours, and at 90° C. for 5 hours, to thereby obtain a pale yellow viscous liquid.

The obtained viscous liquid had a refractive index (n_{D}) of 1.55 and an Abbe number (ν_{D}) of 50.

### Example 51

A mixture containing 4.47 g (17.3 mmol) of mercaptopropoxy-mercapto-octahydro-methano-indene (isomeric mixture) and 1.04 g (8.64 mmol) of ethylidene-2-norbornene was stirred at 70° C. for 5 hours, at 90° C. for 5 hours, and at 120° C. at 5 hours, to thereby obtain a pale yellow viscous liquid.

The obtained viscous liquid had a refractive index (n_{D}) of 1.56 and an Abbe number (ν_{D}) of 47.

### Example 52

A mixture containing 4.47 g (17.3 mmol) of mercaptopropoxy-mercapto-octahydro-methano-indene (isomeric mixture) and 1.04 g (8.64 mmol) of 5-vinyl-2-norbornene was stirred at 70° C. for 5 hours, at 90° C. for 5 hours, and at 120° C. at 5 hours, to thereby obtain a pale yellow viscous liquid.

The obtained viscous liquid had a refractive index (n_{D}) of 1.56 and an Abbe number (ν_{D}) of 51.

### Example 53

A mixture containing 8.94 g (34.6 mmol) of mercaptopropoxy-mercapto-octahydro-methano-indene (isomeric mixture), 2.94 g (17.3 mmol) of ethylene glycol diacrylate, and 0.05 g (0.5 mmol) of triethylamine was stirred at 70° C. for 9 hours, to thereby obtain a colorless transparent viscous liquid.

The obtained viscous liquid had a refractive index (n_{D}) of 1.55 and an Abbe number (ν_{D}) of 49.

### Example 54

A mixture containing 8.95 g (34.6 mmol) of mercaptopropoxy-mercapto-octahydro-methano-indene (isomeric mixture) and 3.91 g (17.3 mmol) of diallyl adipate was stirred at 70° C. for 5 hours. Then, 0.057 g (0.35 mmol) of AIBN was added to the mixture, and the mixture was stirred at 70° C. for 5 hours, to thereby obtain a pale yellow viscous liquid.

The obtained viscous liquid had a refractive index (n_{D}) of 1.54 and an Abbe number (ν_{D}) of 53.

### Example 55

A mixture containing 6.91 g (25.9 mmol) of dimercapto-dodecahydro-dimethano-cyclopenta[b]naphthalene (isomeric mixture) and 1.59 g (17.3 mmol) of a norbornadiene compound was stirred at 70° C. for 7 hours, to thereby obtain a pale yellow viscous liquid.

The obtained viscous liquid had a refractive index (n_{D}) of 1.60 and an Abbe number (ν_{D}) of 48.

### Example 56

A mixture containing 6.91 g (25.9 mmol) of dimercapto-dodecahydro-dimethano-cyclopenta[b]naphthalene (isomeric mixture), 2.94 g (17.3 mmol) of ethylene glycol diacrylate, and 0.06 g (0.6 mmol) of triethylamine was stirred at 70° C. for 8 hours, to thereby obtain a pale yellow viscous liquid.

The obtained viscous liquid had a refractive index (n_{D}) of 1.58 and an Abbe number (ν_{D}) of 51.

### Example 57

A mixture containing 6.91 g (25.9 mmol) of dimercapto-dodecahydro-dimethano-cyclopenta[b]naphthalene (isomeric mixture) and 1.70 g (17.3 mmol) of diallyl ether was stirred at 90° C. for 8 hours. Then, 0.06 g (0.35 mmol) of 2,2′-azobisisobutyronitrile (AIBN) was added to the mixture, and the mixture was stirred at 90° C. for 4 hours, to thereby obtain a pale yellow viscous liquid.

The obtained viscous liquid had a refractive index (n_{D}) of 1.57 and an Abbe number (ν_{D}) of 51.

### Example 58

A mixture containing 6.91 g (25.9 mmol) of dimercapto-dodecahydro-dimethano-cyclopenta[b]naphthalene (isomeric mixture) and 3.91 g (17.3 mmol) of diallyl adipate was stirred at 90° C. for 8 hours. Then, 0.06 g (0.35 mmol) of AIBN was added to the mixture, and the mixture was stirred at 90° C. for 2 hours and 110° C. for 2 hours, to thereby obtain a pale yellow viscous liquid.

The obtained viscous liquid had a refractive index (n_{D}) of 1.59 and an Abbe number (ν_{D}) of 49.

### Example 59

A mixture containing 6.92 g (34.6 mmol) of dimerocapto-octahydro-methano-indene (isomeric mixture), 4.41 g (25.9 mmol) of ethylene glycol diacrylate, and 0.05.g (0.5 mmol) of triethylamine was stirred at 70° C. for 8 hours, to thereby obtain a colorless transparent viscous liquid.

The obtained viscous liquid had a refractive index (n_{D}) of 1.57 and an Abbe number (ν_{D}) of 49.

### Example 60

A mixture containing 6.92 g (34.6 mmol) of dimerocapto-octahydro-methano-indene (isomeric mixture) and 2.39 g (25.9 mmol) of a norbornadiene compound was stirred at 70° C. for 9 hours, to thereby obtain a pale yellow viscous liquid.

The obtained viscous liquid had a refractive index (n_{D}) of 1.59 and an Abbe number (ν_{D}) of 46.

### Example 61

A mixture containing 6.92 g (34.6 mmol) of dimerocapto-octahydro-methano-indene (isomeric mixture), 5.14 g (25.9 mmol) of 1,4-butanediol diacrylate, and 0.05 g (0.5 mmol) triethylamine was stirred at 70° C. for 9 hours. Then, 0.10 g (1.0 mmol) of triethylamine was added to the mixture, and the mixture was stirred at 70° C. for 9 hours, to thereby obtain a colorless transparent viscous liquid.

The obtained viscous liquid had a refractive index (n_{D}) of 1.56 and an Abbe number (ν_{D}) of 49.

### Example 62

A mixture containing 6.92 g (34.6 mmol) of dimerocapto-octahydro-methano-indene (isomeric mixture), 5.86 g (25.9 mmol) of 1,6-hexanediol diacrylate, and 0.05 g (0.5 mmol) triethylamine was stirred at 70° C. for 9 hours. Then, 0.10 g (1.0 mmol) of triethylamine was added to the mixture, and the mixture was stirred at 70° C. for 9 hours, to thereby obtain a colorless transparent viscous liquid.

The obtained viscous liquid had a refractive index (n_{D}) of 1.55 and an Abbe number (ν_{D}) of 49.

### Example 63

A mixture containing 6.92 g (34.6 mmol) of dimerocapto-octahydro-methano-indene (isomeric mixture), 5.55 g (25.9 mmol) of diethylene glycol diacrylate, and 0.05 g (0.5 mmol) triethylamine was stirred at 70° C. for 9 hours. Then, 0.10 g (1.0 mmol) of triethylamine was added to the mixture, and the mixture was stirred at 70° C. for 9 hours, to thereby obtain a colorless transparent viscous liquid.

The obtained viscous liquid had a refractive index (n_{D}) of 1.55 and an Abbe number (ν_{D}) of 51.

### Example 64

A mixture containing 5.19 g (25.9 mmol) of dimercapto-octahydro-methano-indene (isomeric mixture), 4.64 g (17.3 mmol) of 1,9-nonanediol diacrylate, and 0.03 g (0.3 mmol) of triethylamine was stirred at 70° C. for 9 hours. Then, 0.10 g (1.0 mmol) of triethylamine was added to the mixture, and the mixture was stirred at 70° C. for 9 hours, to thereby obtain a colorless transparent viscous liquid.

The obtained viscous liquid had a refractive index (n_{D}) of 1.54 and an Abbe number (ν_{D}) of 52.

### Example 65

A mixture containing 5.19 g (25.9 mmol) of dimercapto-octahydro-methano-indene (isomeric mixture), 5.19 g (17.3 mmol) of tripropylene glycol diacrylate, and 0.03 g (0.3 mmol) of triethylamine was stirred at 70° C. for 9 hours. Then, 0.10 g (1.0 mmol) of triethylamine was added to the mixture, and the mixture was stirred at 70° C. for 9 hours, to thereby obtain a colorless transparent viscous liquid.

The obtained viscous liquid had a refractive index (n_{D}) of 1.53 and an Abbe number (ν_{D}) of 52.

### Example 66

A mixture containing 5.19 g (25.9 mmol) of dimercapto-octahydro-methano-indene (isomeric mixture), 5.22 g (17.3 mmol) of tetraethylene glycol diacrylate, and 0.03 g (0.3 mmol) of triethylamine was stirred at 70° C. for 9 hours. Then, 0.10 g (1.0 mmol) of triethylamine was added to the mixture, and the mixture was stirred at 70° C. for 9 hours, to thereby obtain a colorless transparent viscous liquid.

The obtained viscous liquid had a refractive index (n_{D}) of 1.54 and an Abbe number (ν_{D}) of 52.

### Example 67

A mixture containing 6.91 g (25.9 mmol) of dimercapto-dodecahydro-dimethano-cyclopenta[b]naphthalene (isomeric mixture), 3.43 g (17.3 mmol) of 1,4-butanediol diacrylate, and 0.15 g (1.5 mmol) of triethylamine was stirred at 90° C. for 8 hours, to thereby obtain a colorless transparent viscous liquid.

The obtained viscous liquid had a refractive index (n_{D}) of 1.57 and an Abbe number (ν_{D}) of 48.

### Example 68

A mixture containing 6.91 g (25.9 mmol) of dimercapto-dodecahydro-dimethano-cyclopenta[b]naphthalene (isomeric mixture), 3.91 g (17.3 mmol) of 1,6-hexanediol diacrylate, and 0.15 g (1.5 mmol) of triethylamine was stirred at 90° C. for 16 hours, to thereby obtain a colorless transparent viscous liquid.

The obtained viscous liquid had a refractive index (n_{D}) of 1.56 and an Abbe number (ν_{D}) of 50.

### Example 69

A mixture containing 6.91 g (25.9 mmol) of dimercapto-dodecahydro-dimethano-cyclopenta[b]naphthalene (isomeric mixture), 3.70 g (17.3 mmol) of diethylene glycol diacrylate, and 0.15 g (1.5 mmol) of triethylamine was stirred at 90° C. for 8 hours, to thereby obtain a colorless transparent viscous liquid.

The obtained viscous liquid had a refractive index (n_{D}) of 1.57 and an Abbe number (ν_{D}) of 49.

### Example 70

A mixture containing 6.91 g (25.9 mmol) of dimercapto-dodecahydro-dimethano-cyclopenta[b]naphthalene (isomeric mixture), 4.64 g (17.3 mmol) of 1,9-nonanediol diacrylate, and 0.15 g (1.5 mmol) of triethylamine was stirred at 90° C. for 15 hours, to thereby obtain a colorless transparent viscous liquid.

The obtained viscous liquid had a refractive index (n_{D}) of 1.57 and an Abbe number (ν_{D}) of 49.

### Example 71

A mixture containing 6.91 g (25.9 mmol) of dimercapto-dodecahydro-dimethano-cyclopenta[b]naphthalene (isomeric mixture), 5.19 g (17.3 mmol) of tripropylene glycol diacrylate, and 0.15 g (1.5 mmol) of triethylamine was stirred at 90° C. for 15 hours, to thereby obtain a colorless transparent viscous liquid.

The obtained viscous liquid had a refractive index (n_{D}) of 1.55 and an Abbe number (ν_{D}) of 52.

### Example 72

A mixture containing 6.91 g (25.9 mmol) of dimercapto-dodecahydro-dimethano-cyclopenta[b]naphthalene (isomeric mixture), 5.22 g (17.3 mmol) of tetraethylene glycol diacrylate, and 0.15 g (1.5 mmol) of triethylamine was stirred at 90° C. for 15 hours, to thereby obtain a colorless transparent viscous liquid.

The obtained viscous liquid had a refractive index (n_{D}) of 1.56 and an Abbe number (ν_{D}) of 50.

### Example 73

A mixture containing 4.60 g (17.3 mmol) of dimercapto-dodecahydro-dimethano-cyclopenta[b]naphthalene (isomeric mixture), 1.47 g (8.64 mmol) of ethylene glycol diacrylate, and 0.05 g (0.5 mmol) of triethylamine was stirred at 90° C. for 9 hours, to thereby obtain a colorless transparent viscous liquid.

The obtained viscous liquid had a refractive index (n_{D}) of 1.58 and an Abbe number (ν_{D}) of 52.

### Example 74

A mixture containing 3.46 g (17.3 mmol) of dimercapto-octahydro-methano-indene (isomeric mixture), 1.47 g (8.64 mmol) of ethylene glycol diacrylate, and 0.05 g (0.5 mmol) of triethylamine was stirred at 70° C. for 9 hours, to thereby obtain a pale yellow viscous liquid.

The obtained viscous liquid had a refractive index (n_{D}) of 1.57 and an Abbe number (ν_{D}) of 48.

### Example 75

A mixture containing 3.46 g (17.3 mmol) of dimercapto-octahydro-methano-indene (isomeric mixture), 2.63 g (8.64 mmol) of tricyclodecanedimethanol diacrylate (isomeric mixture), and 0.09 g (0.9 mmol) of triethylamine was stirred at 70° C. for 10 hours, to thereby obtain a pale yellow viscous liquid.

The obtained viscous liquid had a refractive index (n_{D}) of 1.57 and an Abbe number (ν_{D}) of 50.

The pale yellow viscous liquid was subjected to analysis by a gas chromatography method (GPC) (Tosoh column: TSK-8+G3000H8+G2000H8, detector: RI detector, temperature: 24° C., mobile phase: tetrahydrofuran, flow rate: 1.4 ml/min, concentration: 2 mg/ml). As a result, the pale yellow viscous liquid had a weight average molecular weight of 1,972 in standard polystyrene equivalents and was an oligomer mixture having a degree of polymerization as described below from an area ratio of a chart:

| | |
|---|---|
| monomer: | 22.2% |
| dimer: | 20.1% |
| trimer: | 16.5% |
| tetramer: | 11.0% |
| pentamer and higher: | 28.3% |

### Example 76

A mixture containing 5.19 g (25.9 mmol) of dimercapto-octahydro-methano-indene (isomeric mixture), 5.26 g (17.3 mmol) of tricyclodecanedimethanol diacrylate (isomeric mixture), and 0.09 g (0.9 mmol) of triethylamine was stirred at 70° C. for 10 hours, to thereby obtain a pale yellow viscous liquid.

The obtained viscous liquid had a refractive index (n_{D}) of 1.57 and an Abbe number (ν_{D}) of 50.

### Example 77

A mixture containing 4.60 g (17.3 mmol) of dimercapto-dodecahydro-dimethano-cyclopenta[b]naphtalene (isomeric mixture), 2.63 g (8.64 mmol) of tricyclodecanedimethanol diacrylate (isomeric mixture), and 0.09 g (0.9 mmol) of triethylamine was stirred at 70° C. for 10 hours, to thereby obtain a pale yellow viscous liquid.

The obtained viscous liquid had a refractive index (n_{D}) of 1.58 and an Abbe number (ν_{D}) of 53.

### Example 78

A mixture containing 6.90 g (25.9 mmol) of dimercapto-dodecahydro-dimethano-cyclopenta[b]naphtalene (isomeric mixture), 5.26 g (17.3 mmol) of tricyclodecanedimethanol diacrylate (isomeric mixture), and 0.09 g (0.9 mmol) of triethylamine was stirred at 70° C. for 10 hours, to thereby obtain a pale yellow viscous liquid.

The obtained viscous liquid had a refractive index (n_{D}) of 1.58 and an Abbe number (ν_{D}) of 50.

The pale yellow viscous liquid was subjected to analysis by a gas chromatography method (GPC) (Tosoh column: TSK-8+G3000H8+G2000H8, detector: RI detector, temperature: 24° C., mobile phase: tetrahydrofuran, flowrate: 1.4 ml/min, concentration: 2 mg/ml). As a result, the pale yellow viscous liquid had a weight average molecular weight of 3,240 in standard polystyrene equivalents and was an oligomer mixture having a degree of polymerization as described below from an area ratio of a chart:

| | |
|---|---|
| monomer: | 10.2% |
| dimer: | 15.6% |
| trimer: | 16.3% |
| tetramer: | 12.0% |
| pentamer and higher: | 43.5% |

### Example 79

A mixture containing 3.46 g (17.3 mmol) of dimercapto-octahydro-methano-indene (isomeric mixture), 1.71 g (8.64 mmol) of ethylene glycol dimethacrylate (isomeric mixture), and 0.09 g (0.9 mmol) of triethylamine was stirred at 70° C. for 3 hours. Then, 0.07 g (0.4 mmol) of AIBN was added to the mixture, and the mixture was stirred at 70° C. for 4 hours, to thereby obtain a pale yellow viscous liquid.

The obtained viscous liquid had a refractive index (n_{D}) of 1.56 and an Abbe number (ν_{D}) of 47.

### Example 80

A mixture containing 4.60 g (17.3 mmol) of dimercapto-dodecahydro-dimethano-cyclopenta[b]naphthalene (isomeric mixture), 1.71 g (8.64 mmol) of ethylene glycol dimethacrylate (isomeric mixture), and 0.09 g (0.9 mmol) of triethylamine was stirred at 90° C. for 3 hours. Then, 0.07 g (0.4 mmol) of AIBN was added to the mixture, and the mixture was stirred at 90° C. for 4 hours, to thereby obtain a pale yellow viscous liquid.

The obtained viscous liquid had a refractive index (n_{D}) of 1.58 and an Abbe number (ν_{D}) of 50.

### Example 81

A mixture containing 5.37 g (20.2 mmol) of dimercapto-dodecahydro-dimethano-cyclopenta[b]naphthalene (isomeric mixture), 1.96 g (11.5 mmol) of ethylene glycol diacrylate, and 0.06 g (0.6 mmol) of triethylamine was stirred at 90° C. for 15 hours, to thereby obtain a colorless transparent viscous liquid.

The obtained viscous liquid had a refractive index (n_{D}) of 1.58 and an Abbe number (ν_{D}) of 51.

### Example 82

A mixture containing 5.99 g (22.5 mmol) of dimercapto-dodecahydro-dimethano-cyclopenta[b]naphthalene (isomeric mixture), 2.35 g (13.8 mmol) of ethylene glycol diacrylate, and 0.14 g (0.14 mmol) of triethylamine was stirred at 90° C. for 20 hours, to thereby obtain a colorless transparent viscous liquid.

The obtained viscous liquid had a refractive index (n_{D}) of 1.58 and an Abbe number (ν_{D}) of 51.

### Example 83

A mixture containing 3.46 g (17.3 mmol) of dimercapto-octahydro-methano-indene (isomeric mixture), 1.83 g (8.64 mmol) of neopenthyl glycol diacrylate (isomeric mixture), and 0.09 g (0.9 mmol) of triethylamine was stirred at 70° C. for 14 hours, to thereby obtain a colorless transparent viscous liquid.

The obtained viscous liquid had a refractive index (n_{D}) of 1.56 and an Abbe number (ν_{D}) of 48.

### Example 84

A mixture containing 6.92 g (34.6 mmol) of dimercapto-octahydro-methano-indene (isomeric mixture), 5.50 g (25.9 mmol) of neopenthyl glycol diacrylate (isomeric mixture), and 0.09 g (0.9 mmol) of triethylamine was stirred at 70° C. for 14 hours, to thereby obtain a colorless transparent viscous liquid.

The obtained viscous liquid had a refractive index (n_{D}) of 1.55 and an Abbe number (ν_{D}) of 50.

### Example 85

A mixture containing 3.46 g (17.3 mmol) of dimercapto-octahydro-methano-indene (isomeric mixture), 2.87 g (8.64 mmol) of tricyclodecanedimethanol dimethacrylate (isomeric mixture), and 0.09 g (0.9 mmol) of triethylamine was stirred at 70° C. for 10 hours, added with 0.03 g (0.2 mmol) of AIBN, and then stirred at 80° C. for 20 hours, to thereby obtain a pale yellow viscous liquid.

The obtained viscous liquid had a refractive index (n_{D}) of 1.56 and an Abbe number (ν_{D}) of 49.

### Example 86

0.06 g (0.2 mmol) of 2,2′-azobis(4-methoxy-2,4-dimethylvaleronitrile) was added to a mixture of 5.19 g (25.9 mmol) of dimercapto-octahydro-methano-indene (isomeric mixture), 5.74 g (17.3 mmol) of tricyclodecane dimethanol dimethacrylate (isomeric mixture) (available from Shin-Nakamura Chemical Co., Ltd.), 0.09 g (0.9 mmol) of triethylamine, and 20 ml of dichloromethane, and the whole was stirred at room temperature for 10 hours. Further, 0.06 g (0.2 mmol) of 2,2′-bis(4-methoxy-2,4-dimethylvaleronitrile) was added thereto, and the whole was stirred at room temperature for 16 hours.

After completion of the reaction, dichloromethane was distilled off under reduced pressure, to thereby obtain an oligomer mixture as a colorless transparent viscous liquid.

The oligomer mixture had a refractive index (n_{D}) of 1.56 and an Abbe number (ν_{D}) of 51.

### Example 87

5.30 g (19.9 mmol) of dimercapto-dodecahydro-dimethano-cyclopenta[b]naphthalene (isomeric mixture), 2.38 g (11.2 mmol) of neopenthyl glycol diacrylate (available from Shin-Nakamura Chemical Co., Ltd.), and 0.11 g (1.1 mmol) of triethylamine were stirred at 90° C. for 10 hours, to thereby obtain an oligomer mixture as a colorless transparent viscous liquid.

The obtained oligomer mixture had a refractive index (n_{D}) of 1.57 and an Abbe number (ν_{D}) of 49.

### Example 88

5.76 g (21.6 mmol) of dimercapto-dodecahydro-dimethano-cyclopenta[b]naphthalene (isomeric mixture), 2.75 g (13.0 mmol) of neopenthyl glycol diacrylate (available from Shin-Nakamura Chemical Co., Ltd.), and 0.13 g (1.3 mmol) of triethylamine were stirred at 90° C. for 10 hours, to thereby obtain an oligomer mixture as a colorless transparent viscous liquid.

The obtained oligomer mixture had a refractive index (n_{D}) of 1.57 and an Abbe number (ν_{D}) of 48.

### Example 89

28.8 g (108.0 mmol) of dimercapto-dodecahydro-dimethano-cyclopenta[b]naphthalene (isomeric mixture), 19.7 g (64.8 mmol) of tricyclodecanedimethanol diacrylate (isomeric mixture) (available from Shin-Nakamura Chemical Co., Ltd.), and 0.66 g (6.48 mmol) of triethylamine were stirred at 90° C. for 15 hours, to thereby obtain an oligomer mixture as a colorless transparent viscous liquid.

The obtained oligomer mixture had a refractive index (n_{D}) of 1.58 and an Abbe number (ν_{D}) of 48.

The colorless transparent viscous liquid was subjected to analysis by a gas chromatography method (GPC) (Tosoh column: TSK-8+G3000H8+G2000H8, detector: RI detector, temperature: 24° C., mobile phase: tetrahydrofuran, flowrate: 1.4 ml/min, concentration: 2 mg/ml). As a result, the colorless transparent viscous liquid had a weight average molecular weight of 2,904 in standard polystyrene equivalents and was an oligomer mixture having a degree of polymerization as described below from an area ratio of a chart:

| | |
|---|---|
| monomer: | 14.9% |
| dimer: | 18.1% |
| trimer: | 16.3% |
| tetramer: | 11.6% |
| pentamer and higher: | 36.8% |

### Example 90

4.60 g (17.3 mmol) of dimercapto-dodecahydro-dimethano-cyclopenta[b]naphthalene (isomeric mixture), 2.37 g (7.78 mmol) of tricyclodecane dimethanol dimethacrylate, 1.38 g (0.86 mmol) of UA-160™ (available from Shin-Nakamura Chemical Co., Ltd.), and 0.09 g (0.86 mmol) of triethylamine were stirred at 90° C. for 15 hours, to thereby obtain an oligomer mixture as a colorless transparent viscous liquid.

The oligomer mixture had a refractive index (n_{D}) of 1.56 and an Abbe number (ν_{D}) of 48.

### Example 91

4.60 g (17.3 mmol) of dimercapto-dodecahydro-dimethano-cyclopenta[b]naphthalene (isomeric mixture), 2.37 g (7.78 mmol) of tricyclodecane dimethanol dimethacrylate, 0.75 g of UA-122P (available from Shin-Nakamura Chemical Co., Ltd.), and 0.09 g (0.86 mmol) of triethylamine were stirred at 90° C. for 9 hours, to thereby obtain an oligomer mixture as a colorless transparent viscous liquid.

The oligomer mixture had a refractive index (n_{D}) of 1.57 and an Abbe number (ν_{D}) of 49.

### Example 92

0.06 g (0.2 mmol) of 2,2′-azobis(4-methoxy-2,4-dimethylvaleronitrile) was added to a mixture of 3.91 g (14.7 mmol) of dimercapto-dodecahydro-dimethano-cyclopenta[b]naphthalene (isomeric mixture), 2.84 g (7.34 mmol) of BY16-152D (available from Dow Corning Toray Silicone Co., Ltd.), and 10 ml of dichloromethane, and the whole was stirred at 40° C. for 5 hours. After completion of the reaction, dichloromethane was distilled off under reduced pressure, to thereby obtain an oligomer mixture as a pale yellow transparent viscous liquid.

The oligomer mixture had a refractive index (n_{D}) of 1.54 and an Abbe number (ν_{D}) of 51.

### Example 93

0.06 g (0.2 mmol) of 2,2′-azobis(4-methoxy-2,4-dimethylvaleronitrile) was added to a mixture of 3.91 g (14.7 mmol) of dimercapto-dodecahydro-dimethano-cyclopenta[b]naphthalene (isomeric mixture), 2.12 g (6.97 mmol) of tricyclodecane dimethanol dimethacrylate, 0.95 g (0.37 mmol) of BY16-152B (available from Dow Corning Toray Silicone Co., Ltd.), and 10 ml of dichloromethane, and the whole was stirred at 40° C. for 5 hours. After completion of the reaction, dichloromethane was distilled off under reduced pressure, to thereby obtain an oligomer mixture as a pale yellow transparent viscous liquid.

The oligomer mixture had a refractive index (n_{D}) of 1.55 and an Abbe number (ν_{D}) of 50.

### Example 94

3.91 g (14.7 mmol) of dimercapto-dodecahydro-dimethano-cyclopenta[b]naphthalene (isomeric mixture), 1.79 g (5.87 mmol) of tricyclodecane dimethanol dimethacrylate, 0.75 g of UA-NDP (available from Shin-Nakamura Chemical Co., Ltd.), and 0.07 g (0.73 mmol) of triethylamine were stirred at 90° C. for 18 hours, to thereby obtain an oligomer mixture as a colorless transparent viscous liquid.

The oligomer mixture had a refractive index (n_{D}) of 1.57 and an Abbe number (ν_{D}) of 48.

### Example 95

0.02 g (0.07 mmol) of 2,2′-azobis(4-methoxy-2,4-dimethylvaleronitrile) (V-70) was added to a mixed solution containing 3.91 g (14.7 mmol) of dimercapto-dodecahydro-dimethano-cyclopenta[b]naphthalene (isomeric mixture) and 0.72 g (7.34 mmol) of diallyl ether in 10 ml or methylene chloride under heat reflux, and the whole was stirred under heat reflux for 7 hours. Then, methylenechloride was distilled off, to thereby obtain an oligomer mixture as a yellow transparent viscous liquid.

The oligomer mixture had a refractive index (n_{D}) of 1.58 and an Abbe number (ν_{D}) of 47.

### Example 96

0.02 g (0.07 mmol) of 2,2′-azobis(4-methoxy-2,4-dimethylvaleronitrile) (V-70) was added to a mixed solution containing 3.91 g (14.7 mmol) of dimercapto-dodecahydro-dimethano-cyclopenta[b]naphthalene (isomeric mixture) and 0.82 g (7.34 mmol) of vinyl methacrylate in 10 ml or methylene chloride under heat reflux, and the whole was stirred under heat reflux for 6 hours. Then, methylene chloride was distilled off, to thereby obtain an oligomer mixture as a colorless transparent viscous liquid.

The oligomer mixture had a refractive index (n_{D}) of 1.59 and an Abbe number (ν_{D}) of 46.

### Example 97

5.27 g of the colorless transparent viscous liquid obtained in Example 49 through a reaction of 4.47 g (17.3 mmol) of mercaptopropoxy-mercapto-octahydro-methano-indene (isomeric mixture) and 0.80 g (8.64 mmol) of a norbornadiene compound, 1.63 g (8.64 mmol) of m-xylylene diisocyanate, 0.05 g of dibutyltin dichloride, and 0.05 g of dioctylphosphoric acid were mixed into a uniform solution. The solution was subjected to degassing under reduced pressure at room temperature, and injected into a mold formed of a glass mold and a gasket subjected to releasing treatment. Then, the resultant was gradually heated from 40° C. to 120° C. for heat curing over 20 hours.

After completion of polymerization, the resultant was gradually cooled and a sulfur-containing polymer was taken out of the mold.

The obtained sulfur-containing polymer had a refractive index (n_{D}) of 1.59 and an Abbe number (ν_{D}) of 42.

### Comparative Example 2

Polymerization through interfacial polycondensation was performed by using 1,4-cyclohexane dithiol and 1,4-cyclohexane diol described in Example 1 of Japanese Patent Application Laid-Open No. 2002-201277 as raw material monomers. As a result, synthesis of a polymer of 1,4-cyclohexane dithiol alone was realized, but copolymerization with 1,4-cyclohexane diol as an alicyclic monomer did not proceed at all.

As described in Example 1 of Japanese Patent Application Laid-Open No. 2002-201277, a polycarbonate resin was synthesized by a solution polymerization method by using 1,4-cyclohexane dithiol and 1,4-cyclohexane diol as raw material monomers.

The obtained polycarbonate resin had a reduced viscosity [ηsp/C] of 0.47 dl/g and a viscosity average molecular weight of 19,200.

Note that the refractive index (n_{D}) was 1.60 and the Abbe number (ν_{D}) was 42.0 as described in Japanese Patent Application Laid-Open No. 2002-201277.

### Comparative Example 3

Polymerization through interfacial polycondensation was performed by using cyclohexane dithiol and hydroquinone described in Comparative Example 4 of Japanese Patent Application Laid-Open No. 2002-201277 as raw material monomers. As a result, synthesis was realized, but the obtained resin had brown-colored appearance. Further, no colorless transparent polymer was obtained through purification thereafter.

The obtained polycarbonate resin had a reduced viscosity [ηsp/C] of 0.43 dl/g and a viscosity average molecular weight of 17,800.

Note that the refractive index (n_{D}) was 1.63 and the Abbe number (ν_{D}) was 35.0 as described in Japanese Patent Application Laid-Open No. 2002-201277.

### INDUSTRIAL APPLICABILITY

The polythiocarbonate resin having a specific structure of the present invention 1 is a polythiocarbonate resin having excellent durability and optical properties. The polythiocarbonate resin is useful for various application and can be used as an optical material for a lens, a prism, a fiber, an optical disc substrate, a filter, an optical waveguide, a light guide plate, or the like.

The sulfur-containing polymer or sulfur-containing polymer composition of the present invention 2 has excellent physical properties such as low dispersibility, high refractive index, and excellent heat resistance, is colorless, transparent, and lightweight, and has excellent features in weatherability, impact resistance, and the like without causing discomfort in handling of a monomer due to sulfurous odor or discomfort in finishing due to sulfurous odor. The sulfur-containing polymer or sulfur-containing polymer composition is suitably used as: an optical device material for a spectacle lens, a camera lens, or the like; a glazing material; or a material for paint or an adhesive. A lens formed of the sulfur-containing polymer or sulfur-containing polymer composition of the present invention as a raw material can be subjected to physical or chemical treatment such as surface polishing, antistatic treatment, hard coat treatment, antireflection coating treatment, coloring treatment, or photochromic treatment as required for making improvements such as preventing reflection, imparting high hardness, improving abrasion resistance, improving chemical resistance, imparting anti-fogging property, and imparting fashion.

1. A polythiocarbonate resin, comprising at least a repeating unit represented by the following general formula (1): 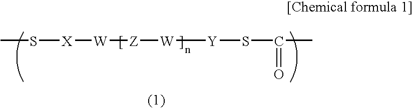
where: X and Y each independently represent —(CH₂)ₘ₁— or —(CH₂)ₘ₂-Q-(CH₂)ₘ₃— (where Q independently represents an oxygen atom or a sulfur atom; and m1 to m3 each independently represent an integer of 0 to 4); n represents a number of 0 to 6; W represents a divalent group represented by the general formula (2a) or (2b): 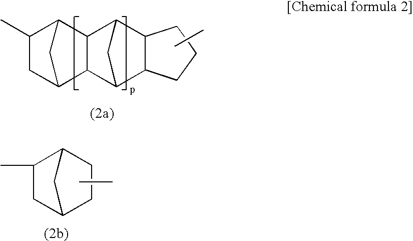
where: p represents an integer of 0 to 4; a bonding position of a five-membered ring in the formula is arbitrary and may arbitrarily have an endo- or exo-configuration; Z represents a single bond, —[(CH₂)ᵣ₁-Q]ᵣ₃-(CH₂)ᵣ₂— (where: Q independently represents an oxygen atom or a sulfur atom; r1 and r2 each independently represent an integer of 0 to 6; and r3 represents a number of 0 to 6), —O—, >C═O, or a divalent group represented by any one of the following general formulae (3) to (6); Z may be bonded to one W at two or more positions and may have a different structure by the repeating unit: 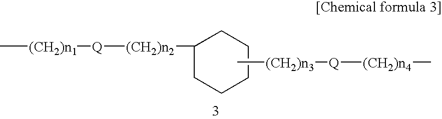
where: Q each independently represents an oxygen atom or a sulfur atom; and n1 to n4 each independently represent an integer of 0 to 4, 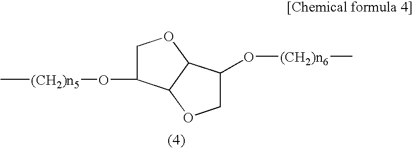
where n5 and n6 each independently represent an integer of 0 to
4, 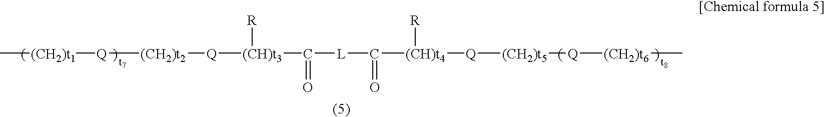
where: Q each independently represents an oxygen atom or a sulfur atom; L represents —O—(CH₂)ᵤ₁—O—, (where u1 represents an integer of 1 to 9), —O—[(CHR)ᵤ₃—O]ᵤ₂—, (where R independently represents a hydrogen atom or a methyl group; u2 represents a number of 0 to 6; u3 represents an integer of 1 to 5), or -Q-(CH₂)ₙ₇—W—(CH₂)ₙ₈-Q-, (where n7 and n8 represent an integer of 0 to 4); t1 to t6 each independently represent an integer of 0 to 4; and t7 and t8 each independently represent an integer of 0 or 1, [Chemical Formula 6] 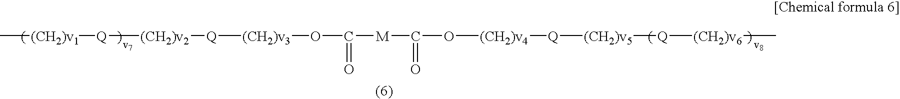
where: Q each independently represents an oxygen atom or a sulfur atom; M represents a single bond, an alkylene group having 1 to 6 carbon atoms, or a cycloalkylene group having 4 to 12 carbon atoms; v1 to v6 each independently represent an integer of 0 to 4; and v7 and v8 each independently represent an integer of 0 or 1.

2. A polythiocarbonate resin according to claim 1, comprising a repeating unit represented by the following general formula (7): 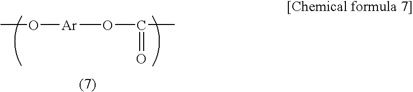
where Ar represents an aromatic bifunctional group.

3. A polythiocarbonate resin according to claim 2, wherein Ar comprises a group represented by the following general formula (8) or (9): 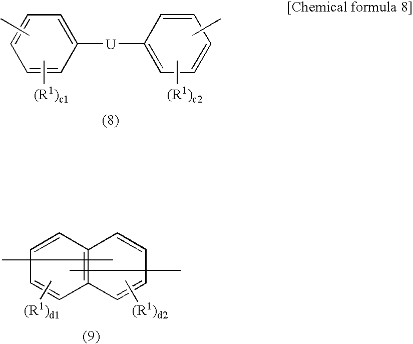
where: R¹ each independently represents a hydrogen atom, a halogen atom, an alkyl group having 1 to 10 carbon atoms which may have a substituent, an aryl group having 6 to 12 carbon atoms which may have a substituent, a cycloalkyl group having 3 to 12 atoms which may have a substituent, an alkyloxy group having 1 to 6 carbon atoms which may have a substituent, or an aryloxy group having 6 to 12 carbon atoms which may have a substituent; c1 and c2 each independently represent an integer of 0 to 4; d1 and d2 each independently represent an integer of 0 to 3; U represents a single bond, —O—, —S—, —SO—, —SO₂—, —CO—, —CR³R⁴— (where, R³ and R⁴ each independently represent a hydrogen atom, an alkyl group having 1 to 10 carbon atoms which may have a substituent, a cycloalkyl group having 3 to 12 carbon atoms which may have a substituent, or an aryl group having 6 to 12 carbon atoms which may have a substituent), an arylene group having 6 to 12 carbon atoms which may have a substituent, an cycloalkylidene group having 5 to 11 carbon atoms which may have a substituent, an α, ω-alkylene group having 2 to 12 carbon atoms which may have a substituent, a 9,9-fluorenylidene group which may have a substituent, a divalent residue of tricyclodecane which may have a substituent, a divalent residue of bicycloheptane which may have a substituent, a divalent group derived from natural terpenes represented by any one of the following general formulae (10) to (12): 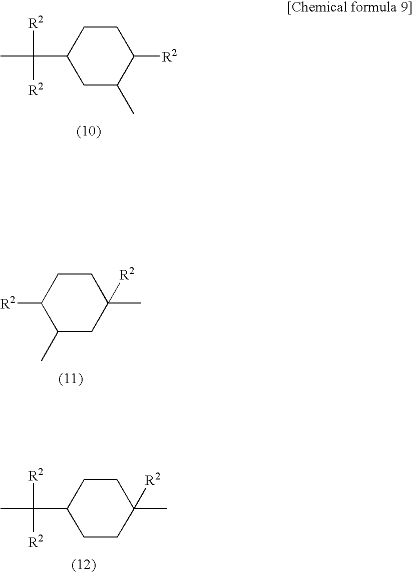
, or an alkylidene arylene alkylidene group having 8 to 16 carbon atoms and represented by the following general formula (13): 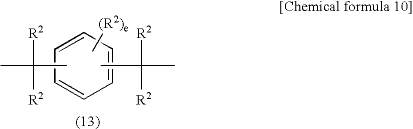
where: R² each independently represents a hydrogen atom, a halogen atom, an alkyl group having 1 to 10 carbon atoms which may have a substituent, an aryl group having 6 to 12 carbon atoms which may have a substituent, a cycloalkyl group having 3 to 12 carbon atoms which may have a substituent, an alkyloxy group having 1 to 6 carbon atoms which may have a substituent, or an aryloxy group having 6 to 12 carbon atoms which may have a substituent; and e represents an integer of 0 to 4.

4. An optical material, comprising the polythiocarbonate resin according to any one of claims 1 to 3.

5. A sulfur-containing compound as a reaction product of a dithiol compound represented by the following general formula (II) and a diene compound represented by the following general formula (III), comprising a repeating unit formed of a structural unit derived from a residue of the dithiol compound and a structural unit derived from a residue of the diene compound, which has an Abbe number (ν_{D}) of 40 or more:
HS-G¹-SH (II)
G^{2″} (III)
where: G¹ represents an aliphatic or alicyclic hydrocarbon group which may contain a sulfur and/or oxygen atom, or an aromatic group or condensed polycyclic aromatic group which may be substituted; and G^{2″} represents an aliphatic or alicyclic hydrocarbon compound having two or more carbon-carbon double bonds which may contain at least one atom selected from the group consisting of oxygen, nitrogen, sulfur, and silicon, or an aromatic group or condensed polycyclic aromatic hydrocarbon compound which may be substituted.

6. A sulfur-containing compound according to claim 5, wherein the dithiol compound represented by the general formula (II) comprises an alicyclic hydrocarbon group G¹ which may contain a sulfur and/or oxygen atom.

7. A sulfur-containing compound according to claim 5, wherein the dithiol compound represented by the general formula (II) comprises an alicyclic hydrocarbon group G¹ having 6 to 35 carbon atoms and a cyclohexane group which may contain a sulfur and/or oxygen atom.

8. A sulfur-containing compound according to claim 5, wherein the dithiol compound represented by the general formula (II) comprises an alicyclic hydrocarbon group G¹ having 7 to 35 carbon atoms and a norbornane group which may contain a sulfur and/or oxygen atom.

9. A sulfur-containing compound according to claim 5, wherein the dithiol compound represented by the general formula (II) comprises an alicyclic hydrocarbon group G¹ having 10 to 35 carbon atoms and an adamantane group.

10. A sulfur-containing compound according to claim 5, wherein the dithiol compound represented by the general formula (II) comprises at least one compound selected from the group consisting of HSCH₂CH₂SH, HSCH₂CH₂CH₂SH, HSCH₂CH₂CH₂CH₂SH, HSCH₂CH₂CH₂CH₂CH₂SH, HSCH₂CH₂CH₂CH₂CH₂CH₂SH, HSCH₂CH₂OCH₂CH₂SH, and HSCH₂CH₂SCH₂CH₂SH.

11. A sulfur-containing compound according to claim 5, wherein the dithiol compound represented by the general formula (II) comprises at least one compound selected from the following dithiol compounds.

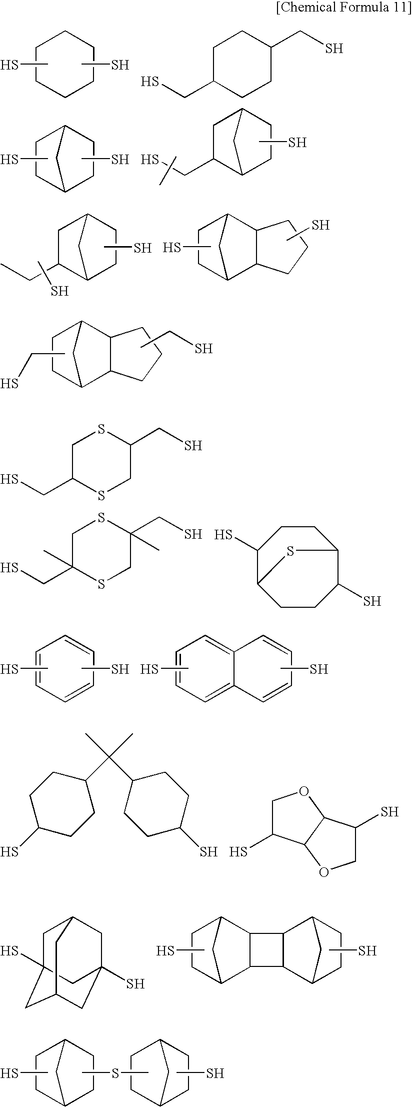

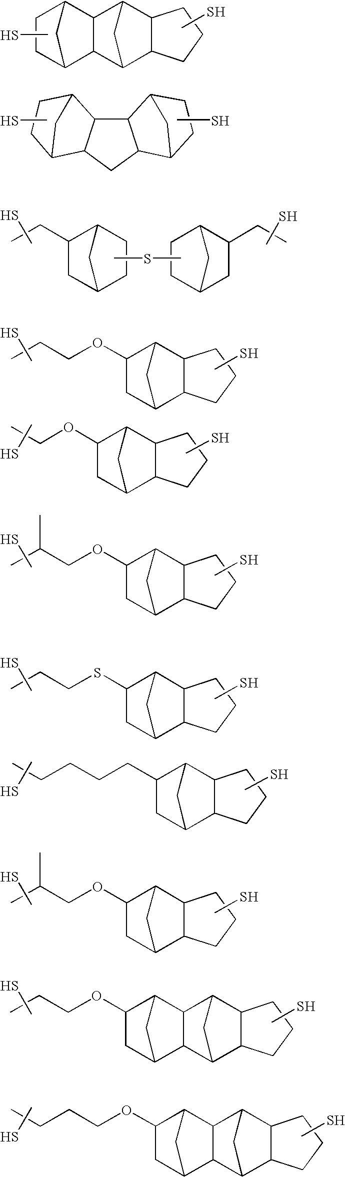

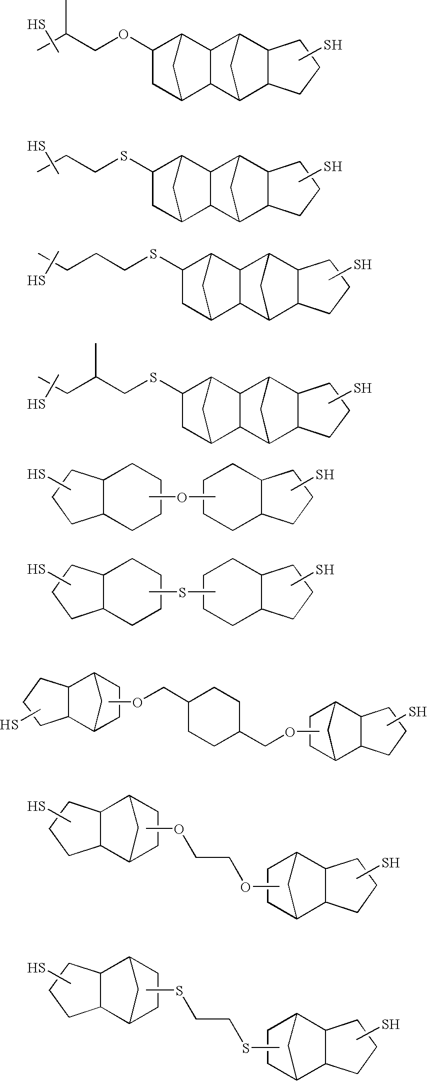

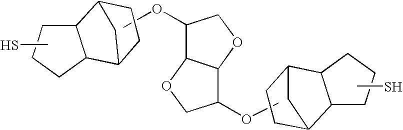

12. A sulfur-containing compound according to claim 5, wherein a molar ratio of the structural unit derived from a residue of the dithiol compound to the structural unit derived from a residue of the diene compound in the repeating unit is 1:0.5 to 0.5:1.

13. A sulfur-containing compound according to claim 5, wherein G^{2″} comprises at least one compound selected from the group consisting of: an aliphatic or alicyclic hydrocarbon compound having two or more carbon-carbon double bonds and an acrylate group which may contain at least one atom selected from the group consisting of oxygen, nitrogen, sulfur, and silicon; an aliphatic or alicyclic hydrocarbon compound having a methacrylate group which may contain at least one atom selected from the group consisting of oxygen, nitrogen, sulfur, and silicon; an aliphatic or alicyclic hydrocarbon compound having an allyl group which may contain at least one atom selected from the group consisting of oxygen, nitrogen, sulfur, and silicon; and an aliphatic or alicyclic hydrocarbon compound having a vinyl group which may contain at least one atom selected from the group consisting of oxygen, nitrogen, sulfur, and silicon.

14. A sulfur-containing compound according to claim 5, wherein G^{2″} comprises at least one compound selected from the group consisting of a norbornadiene compound, ethylidene norbornene, vinyl norbornene, a dicyclopentadiene compound, and a tricyclopentadiene compound.

15. A sulfur-containing compound according to claim 5, wherein G^{2″} comprises at least one compound selected from the following diene compounds.

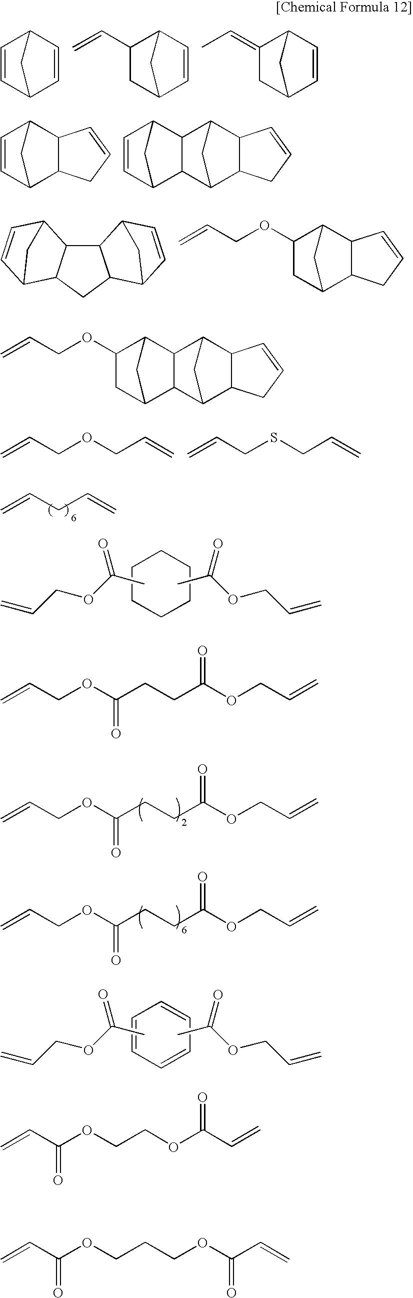

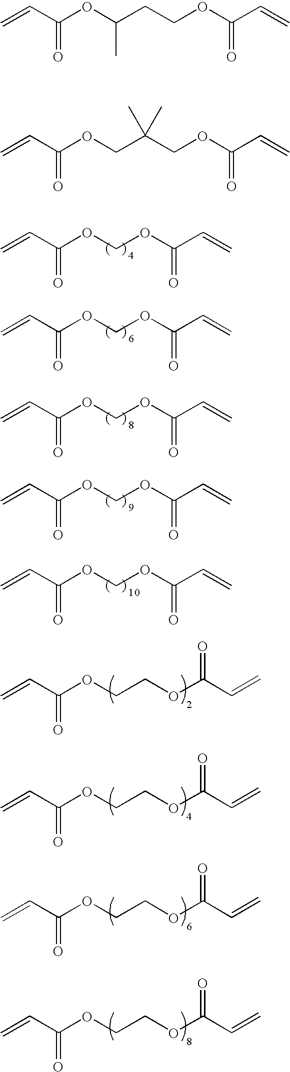

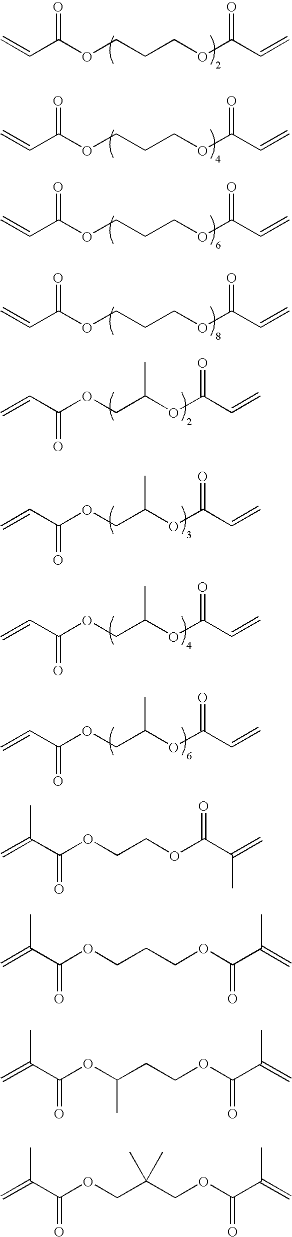

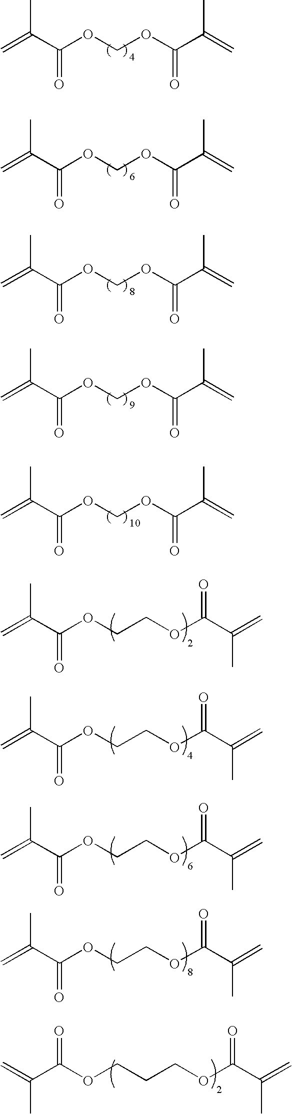

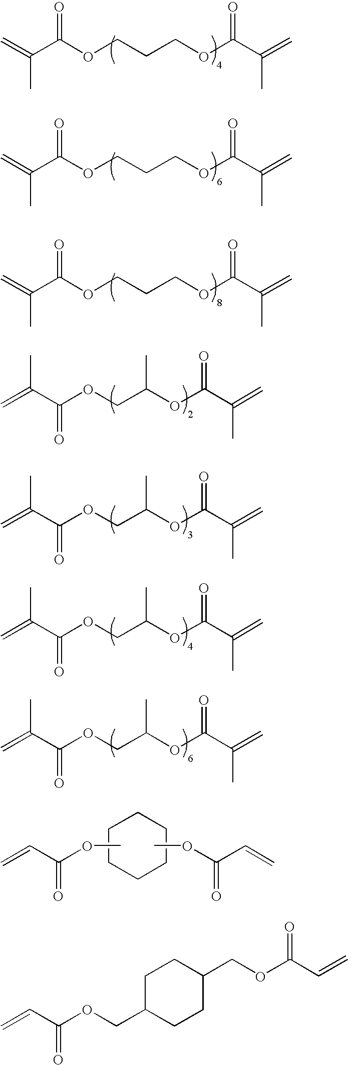

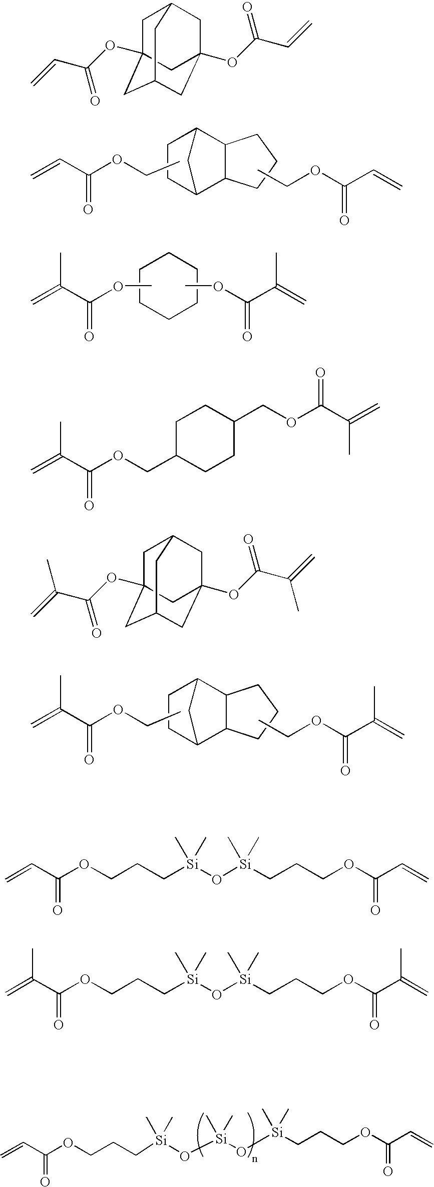

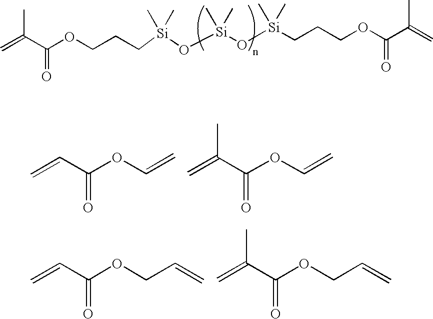

16. A sulfur-containing compound according to claim 5, wherein the reaction product of the dithiol compound represented by the general formula (II) and the diene compound represented by the general formula (III) comprises a thiocooligomer having a structure represented by the following general formula (I):
X—(S-G¹-S-G²)ₙ-S-G¹-S-X′ (I)
where: X and X′ each independently represent —H or -G^{2′}; G¹ represents an aliphatic or alicyclic hydrocarbon group which may contain a sulfur and/or oxygen atom, or an aromatic group or condensed polycyclic aromatic group which may be substituted; G² and G^{2′} each represent a reactive group derived from G^{2″}; G² represents a group in which two carbon-carbon double bonds of G^{2″} reacted; G^{2′} represents a group in which one carbon-carbon double bond of G^{2″} reacted; G^{2″} represents an aliphatic or alicyclic hydrocarbon compound having two or more carbon-carbon double bonds which may contain at least one atom selected from the group consisting of oxygen, nitrogen, sulfur, and silicon, or an aromatic or condensed polycyclic aromatic compound which may be substituted; and n represents an integer of 1 to 200.

17. A sulfur-containing compound according to claim 16, wherein n represents an integer of 1 to 20.

18. A sulfur-containing compound according to claim 5, comprising the dithiol compound represented by the general formula (II).

19. A method of producing the sulfur-containing compound according to claim 5, characterized by comprising reacting the dithiol compound represented by the general formula (II) and the diene compound represented by the general formula (III).

20. A method of producing the sulfur-containing compound according to claim 19, wherein a molar ratio of the dithiol compound to the diene compound is 1:0.5 to 0.5:1.

21. A sulfur-containing polymer, comprising as a constitutional component at least one compound selected from the sulfur-containing compounds according to claim 5.

22. A sulfur-containing polymer according to claim 21, which is a polymer product of at least one compound selected from the sulfur-containing compounds according to claim 5, and at least one compound selected from the group consisting of a polyisocyanate compound, a polyisothiocyanate compound, and an isothiocyanate compound having an isocyanate group.

23. A sulfur-containing polymer according to claim 21, which is a polythiocarbonate obtained by reacting at least one compound selected from the sulfur-containing compounds according to claim 5, and a polycarbonate oligomer having a dihydric phenol or a functional group capable of reacting with the sulfur-containing compound on its terminal.

24. An optical material, comprising the sulfur-containing polymer according to any one of claims 21 to 23.
